(19) United States
(12) Patent Application Publication
(10) Pub. No.: US 2026/0317360 A1
(43) Pub. Date: Oct. 15, 2026

(54) Non-Coordinated Alkylaluminum Free Cation Modified Alumoxanes and Methods Thereof

(71) Applicant: ExxonMobil Technology and Engineering Company, Spring, TX (US)

(72) Inventors: Lubin Luo, Houston, TX (US); Jo Ann M. Canich, Houston, TX (US); Alexander V. Zabula, Seabrook, TX (US); Ky Le, Pearland, TX (US)

(21) Appl. No.: 19/490,197

(22) PCT Filed: May 20, 2024
(86) PCT No.: PCT/US2024/030222

§ 371 Date: Dec. 4, 2025

Related U.S. Application Data
(60) Provisional application No. 63/506,541, filed on Jun. 6, 2023.

(51) Int. Cl. C07F 17/00; C07F 5/00; C07F 5/06; C07F 7/00

(52) U.S. Cl. CPC C07F 17/00; C07F 5/00; C07F 5/068; C07F 7/00

(57) ABSTRACT

The present disclosure relates to alumoxane compositions substantially or completely free of non-coordinated hydrocarbyl aluminum content, methods of forming such alumoxane compositions, catalyst systems having the alumoxane compositions, and methods of polymerizing olefins using catalyst systems having the alumoxane compositions. In some embodiments, a catalyst system includes at least one pre-catalyst compound. The catalyst system includes an unsupported or supported alumoxane. The alumoxane includes a monodentate siloxy ligand. In some embodiments, a method of making an alumoxane includes forming an ionic alkylalumoxane by reacting a supported or unsupported alkylalumoxane with a polydentate chelating agent to form a silane alkylaluminum complex. The method includes heating or aging the silane alkylaluminum complex to form a supported or unsupported alkylalumoxane comprising a monodentate ligand.

### CROSS REFERENCE TO RELATED APPLICATIONS

This application claims the benefit of and priority to U.S. Provisional Application No. 63/506,541 filed Jun. 6, 2023, the disclosure of which is incorporated herein by reference.

### FIELD

The present disclosure relates to alumoxane compositions substantially or completely free of hydrocarbyl aluminum content, methods of forming such alumoxane compositions, catalyst systems having the alumoxane compositions, and methods of polymerizing olefins using catalyst systems having the alumoxane compositions.

### BACKGROUND

Olefin polymerization catalysts are of great use in industry. Hence, there is interest in finding new catalyst systems that increase the commercial usefulness of the catalyst and allow the production of polymers having improved properties. In order to polymerize monomers to form polyolefins, catalysts are activated to provide an active site on the catalyst and promote polymerization of the monomers. Active methylalumoxane (MAO) from partially hydrolyzed trimethylaluminum (TMA) is effective in activating a type of catalyst known as metallocenes for polymerization of olefins. MAO has become the aluminum co-catalyst (also called an activator) of choice in the industry. It is available commercially in the form of 10 wt % to 30 wt % solutions in an aromatic diluent, typically toluene.

Considerable effort has been devoted to improving the effectiveness of catalyst systems for polymerization of olefins based on use of methylalumoxanes or modified methylalumoxanes. For example, WO 2009/029857 shows dimethylaluminum cation (AlMe₂⁺) formation from MAO upon treatment of MAO with a Lewis base, e.g., tetrahydrofuran, in a toluene solution. Lewis base stabilized dialkylaluminum cation such as AlMe₂⁺ can also be derived from non-MAO sources and used as metallocene catalyst activators; see for example Klosin et al., WO 2000/011006, and “Ligand Exchange and Alkyl Abstraction Involving (Perfluoroaryl)boranes and -alanes with Aluminum and Gallium Alkyls,” Organometallics, 2000, v.19(23), pp. 4684-4686: U.S. Pat. No. 9,090,720 shows a metallocene with dimethoxy leaving groups ethylenebisindenylzirconium dimethoxide (EtInd₂Zr(OMe)₂) extracts AlMe₂′ from MAO to form a [EtInd₂Zr(μ-OMe)₂AlMe₂]⁺ species, which are slowly alkylated to form fully activated species [EtInd₂Zr(μ-Me)₂AlMe₂]⁺, as a strong evidence of AlMe₂⁺ activation from MAO. The fully activated [EtInd₂Zr(μ-Me)₂AlMe₂]⁺ species is similar to other MAO activated metallocenes that also form the metallocene-dialkylaluminum cation species, for example, [Cp₂Zr(μ-Me)₂AlMe₂]⁺ or [Cp₂Ti(μ-Me)₂AlMe₂]⁺, such as examples in Babushkin, D. E. et al. (2002) “Activation of Dimethyl Zirconocene by Methylaluminoxane (MAO)-Size Estimate for Me-MAO⁻, Anions by Pulsed Field-Gradient NMR” J. Am. Chem. Soc., v.124, pp. 12869-12873, and Sarzotti, D. M. et al. (2006) “A Kinetic Study of Metallocene-Catalyzed Ethylene Polymerization Using Different Aluminoxane Cocatalysts,” J. Polymer Sci. A, v.45, pp. 1677-1690, which describe the activation of a zirconocene catalyst precursor by MAO; also see Bryliakov, K. P. et al. (2004) “¹H and ¹³C NMR Spectroscopic Study of Titanium(IV) Species Formed by Activation of Cp₂TiCl₂ and [(Me₄C₅)SiMe₂N^{t}Bu]TiCl₂ with Methylaluminoxane (MAO),” Organometallics, v.23, pp. 149-152, which describes activation of a titanocene catalyst precursor by MAO. Although the MAO structure still remains unclear, freshly made active MAO has shown the evidence of coordinated TMA in MAO in agreement with the experimental formula (Al₄O₃Me₆)₄(TMA)₁₋₂ described by Sinn and Kaminsky (Sinn, et al., “Formation, Structure, and Mechanism of Oligomeric Methylalumoxane”, in Kaminsky (ed.), Metalorg. Cat. for Synth. & Polym., Springer-Verlag, 1999, p. 105). The coordinated TMA is in equilibrium with free TMA and the attempt to physically remove all free TMA results in formation of more stable MAO gel with less active sites due to the loss of coordinated TMA (Equation (1), which is difficult to find a suitable solvent for solution polymerization or to put on a support (i.e., entering the pores of support) for gas- or slurry-phase polymerization.

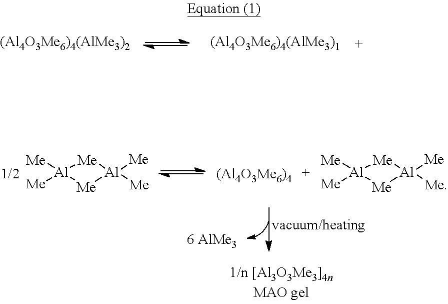

Studies have shown that the coordinated TMA in MAO actually serves as the AlMe₂⁺ source for the pre-catalyst ionization while the free TMA in MAO in equilibrium with the coordinated TMA serves as the alkylation agent as shown in Equation (2) with the use of a circle to represent MAO main structure, e.g., (Al₄O₃Me₆)₄ unit for clearness (Luo, Jain, and Harlan, INOR 1169, American Chemical Society Priestley Medalist Symposium in Honor of Tobin J. Marks, San Francisco, CA, Apr. 5, 2017; Luo, et al, U.S. Pat. No. 8,575,284 (2013) and U.S. Pat. No. 9,090,720 (2015)):

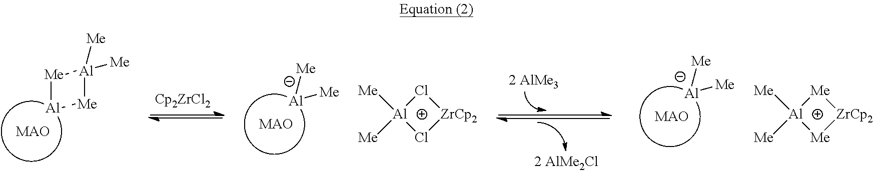

Maintaining a significant amount of free TMA in an active MAO solution is therefore necessary in order to stabilize the active MAO compositions, e.g., to stabilize the coordinated TMA capped MAO molecule structure to reduce chances of dimerization/oligomerization that eventually forms the MAO gel as shown in Scheme or Equation (1). Therefore, the physical removal of free TMA can cause not only the MAO gelation but also the loss of coordinated TMA and result in a lower activation efficiency.

Nonetheless, post-metallocene catalysts and constrained-geometry-complex (CGC) catalysts (also referred to as mono-cyclopentadienyl (mono-Cp) catalysts) containing polar ligands such as oxygen and/or nitrogen donors have displayed challenges to activate with regular MAO, e.g., some showing low catalyst activity and some showing short catalyst lifetimes or both. Without being bound by theory, it is believed that the poor activity and short catalyst lifetime are due to the presence of free TMA in MAO that are capable of alkylating the pre-catalyst metal center bonded to hetero-atoms (Scheme 3 or Equation (3) with Zr center as example), similar to the alkylation of a metallocene with dichloride leaving groups in Equation (3):

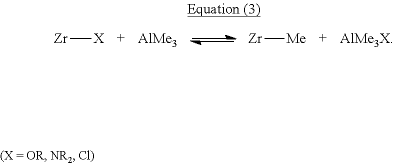

Previous research reveals that MAO can be precipitates as a clathrate by a chelating agent octamethyltrisiloxane (OMTS) (Sangokoya, et al, WO 2003/082879 (2003)). The free TMA can be separated from the clathrate where the majority of coordinated TMA in MAO is converted to [AlMe₂(OMTS)]⁺ to destroy the free and coordinated TMA equilibrium- and led to precipitation of the clathrate phase in the original MAO solution so free TMA may be removed from the solution. Unfortunately, the strong chelating effect of the OMTS group prevented the AlMe₂⁺ from being released to efficiently serve as an activator for pre-catalysts due to a significant positive activation enthalpy.

As such, there is a need for improved MAO and methods of forming MAO that provide high activity and long catalyst lifetime to post-metallocene catalysts and/or CGCs. For example, a solution or supported MAO with sufficient coordinated TMA drove AlMe₂⁺ but free of or low in free TMA content that is able to maintain efficiency as an activator.

References for citing in an Information Disclosure Statement (37 C.F.R. 1.97(h)): WO 2003/082879; US 2019/0127499; US 2009/0124486; U.S. Pat. No. 6,667,272; US 2019/0153135; US 2013/0253155; US 2018/0142046; U.S. Pat. No. 7,193,100.

### SUMMARY

The present disclosure relates to active cation modified alumoxane compositions substantially or completely free of free (non-coordinated) hydrocarbyl aluminum content, methods of forming such alumoxane compositions, catalyst systems having the alumoxane compositions, and methods of polymerizing olefins using catalyst systems having the alumoxane compositions.

In some embodiments, a catalyst system includes at least one pre-catalyst compound and an unsupported or supported alumoxane comprising a monodentate siloxy ligand.

In some embodiments, a method of making an alumoxane includes forming an ionic alkylalumoxane by (1) reacting a supported or unsupported alkylalumoxane with a polydentate chelating agent to form an ionic aluminoxane composition comprising siloxane chelating alkylaluminum cation and (2) heating or aging the ionic aluminoxane composition comprising siloxane chelating alkylaluminum cation to form the ionic alkylalumoxane comprising a supported or unsupported alkylalumoxane comprising at least one decomposed product of the siloxane chelating cation in the siloxane modified ionic aluminoxane composition.

In some embodiments, a method of making an alumoxane composition includes forming non-coordinated alkylaluminum free alkylalumoxane composition by reacting a supported or unsupported alkylalumoxane with a silanol to form the alkylalumoxane composition comprising a supported or unsupported alkylalumoxane comprising the monodentate siloxy ligand, provided that the non-coordinated alkylaluminum content is not more than 2 wt % Al based on total Al.

In some embodiments, a compound is represented by Formula (I):

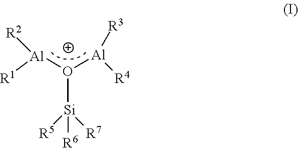

wherein:
each of R¹, R², R³, R⁴, R⁵, R⁶, and R⁷ is independently a hydrogen, a hydrocarbyl, a silyl group, or a heteroatom containing group.

In some embodiments, a method of making an alumoxane composition includes forming an alkylaluminum alkylalumoxane composition by reacting a supported or solid alkylalumoxane with a dialkylaluminum siloxide to form the alkylaluminum alkylalumoxane composition by:
a) bringing into contact the supported or solid alkylalumoxane with the dialkylaluminum siloxide represented by the Formula (II):

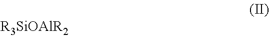

wherein R is independently a hydrogen, a hydrocarbyl, or a non- or weak-coordinative heteroatom containing group; and
b) separating the non-coordinative alkylaluminum from the siloxylated aluminoxane composition.

In some embodiments, an anion and cation modified supported or unsupported alkylaluminoxane composition is provided. The anion modification is achieved by treatment of a supported or unsupported alkylaluminoxane with a compound containing at least one electron-withdrawing compound. The cation modification is achieved by treatment of the supported or unsupported alkylaluminoxane with a chelating or monodentate siloxane compound, with any order, followed by an optional heating of the anion and cation modified supported or unsupported alkylaluminoxane.

### BRIEF DESCRIPTION OF THE DRAWINGS

FIG. 1 illustrates a synthetic process of forming a monodentate ligand, according to some embodiments.

FIG. 2 illustrates a synthetic process of forming a monodentate ligand coordinated AlMe₂ composition, according to some embodiments.

FIG. 3 is a graph depicting activity of a gas-phase polyethylene polymerization of silica-MAO compared to silica supported ionic MAO, according to some embodiments.

FIG. 4 is a graph depicting productivity of TMA free F-MAO compared to TMA free ionic-MAO, according to some embodiments.

FIG. 5 is a graph depicting catalyst productivity, according to some embodiments.

FIG. 6 is a ¹H NMR spectrum having ionic MAO with one of the decomposed products of [(OMTS)AlMe₂]ⁱ showing peaks matching the proposed structure with a Me-Al:SiMe ratio at 4:3, according to some embodiments.

### DEFINITIONS

The new numbering scheme for the Periodic Table Groups is used as described in Chemical and Engineering News, v.63(5), pg. 27 (1985). Therefore, a “group 4 metal” is an element from group 4 of the Periodic Table, e.g., Hf, Ti, or Zr, a “group 3 metal” is an element from group 3 of Periodic Table, e.g., Sc, Y, or Nd.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

### Ethylene Shall be Considered an α-Olefin.

The term “metallocene” refers to a catalyst compound containing two substituted or unsubstituted cyclopentadienyl moieties, bridging or non-bridging together, where the two cyclopentadienyl moieties bind directly to the metal center having at least two leaving groups when the metal center is charge neutral or having at least one leaving group and an optional weak donor when it bears a positive charge; the term “half-metallocene” refers to a catalyst compound containing one substituted or unsubstituted cyclopentadienyl moiety and a heteroatom containing ligand, bridging or non-bridging together, where the cyclopentadienyl moiety and at least one of the heteroatom on the heteroatom containing ligand bind directly to the metal center having at least two leaving groups when the metal center is charge neutral or having at least one leaving group and an optional weak donor when the metal center bears a positive charge, including so-called “constrained geometry catalyst” (CGC) compounds. The term “post-metallocene” refers to a catalyst compound containing no cyclopentadienyl moiety but ligands with hetero-atoms, e.g., N, O, P, B, S, and the like, directly binding to the catalyst metal center having at least two leaving groups when it is charge neutral or having at least one leaving group and an optional weak donor when it bears a positive charge.

The term “MAO” can refer to the MAO composition that includes MAO, coordinated TMA, free TMA, and gel, e.g., species in Scheme 1, but can sometimes refer to just the MAO main molecule only, e.g., (Al₄O₃Me₆)₄, without the coordinated TMA and free TMA.

“Aluminumalkyl or alkylaluminum” means compounds containing at least one Al-alkyl (Al—R, where R is a C₁ to C₁₂ hydrocarbyl group) unit and may be coordinated to or not coordinated to the main aluminoxane structure. Such a compound if not coordinated to the main aluminoxane structure is also called a non-coordinated aluminumalkyl or a free aluminumalkyl, which may coordinate to each other to form a dimer, for example, the AlMe₃ dimer in Scheme (1).

“Non-coordinated alkylaluminum” or “free alkylaluminum” has the same meaning to represent an aluminum compound having at least one alkyl group, e.g., Me, Et, iBu, Oct, in the form of either monomer or dimer that is not chemically bound to the aluminoxane structure. Although the free alkylaluminum can exchange with the coordinated alkylaluminum on the aluminoxane structure to become coordinated, the regeneration of the free alkylaluminum from the originally coordinated alkylaluminum maintains the free alkylaluminum concentration under the same conditions.

The terms aluminoxane, alumoxane, alkylaluminoxane, and alkylalumoxane are used interchangeably.

Sometimes only alkylaluminum is used to represent free alkylaluminum, e.g., TMA means free TMA.

“Free” or “free of” means undetectable with the current analytical methods, such as NMR spectroscopy or a conventional wet titration method. “Low in” means 2 wt % or 2 mol % or less based on total same element in the system, e.g., low in free TMA means the Al weight (or mol) of the free TMA content is 2 wt % (or mol %) or less based on the total Al weight (or mol) in the MAO composition. In some embodiments, “free” or “free of” includes the “low in” description, e.g., TMA free MAO may indicate the Al weight or molar number of the free TMA content is 2 wt % or 2 mol % or less based on the total Al content in MAO.

There are two types of TMA free MAO compositions: 1) a cation modified MAO, can be an MAO composition modified with a chelating agent to form an ionic MAO composition containing the chelating agent or ligand stabilized dimethylaluminum cation, which can then be heated to decompose to a monodentate ligand stabilized cation of embodiments of the present disclosure; the cation modified MAO can also be called an ionic MAO; and 2) an anion modified MAO, i.e., an MAO composition modified with a compound AlMe₂X, where X is an electron withdrawing group (e.g., AlMe₂F or AlMe₂(OC₆F₅), pre-formed or formed in-situ, that is capable of replacing the coordinated TMA to form the coordinated AlMe₂X. When the pre-catalyst is activated with this MAO composition by complexing with the AlMe₂⁺ of the coordinated AlMe₂X, the MAO becomes (XMAO)⁻ anion, which is described in another application filled separately. The non-coordinated alkylaluminum free system can also be obtained by both cation and anion modified MAO.

“Chelating agent or compound” means a compound with multiple donor groups to form a chelating structure with a dialkylaluminum cation in an alkylaluminoxane system. The preferred chelating agent or compound contains multiple siloxy donor groups, e.g., octamethyltrisiloxane (OMTS). Examples of chelating agents include but are not limited to linear or cyclic polysiloxanes, such as octamethyltrisiloxane (OMTS), octamethylcyclotetrasiloxane, decamethyltetrasiloxane, hexamethylcyclotrisiloxane, hexaphenylcyclotrisiloxane, and the like.

“Monodentate agent or compound” means a compound with a single donor group to form a non-chelating structure with a dialkylaluminum cation, in an alkylaluminoxane system. Examples of monodentate agent include but are not limited to compounds having a siloxy donor group containing a single oxygen such as hexamethyl disiloxane, hexaphenyldisiloxane, hexaethyldisiloxane, dimethylaluminum trimethylsiloxide, diethylaluminum triethylsiloxide, and the like; more preferred monodentate agents are siloxy donor group modified alkylaluminums, such as dimethylaluminum trimethylsiloxide, diethylaluminum trimethylsiloxide, diisobutylaluminum tnmethylsiloxide, dimethylaluminum triethylsiloxide, diethylaluminum triethylsiloxide, diisobutylaluminum triethylsiloxide, dimethylaluminum tripropylsiloxide, diethylaluminum tripropylsiloxide, diisobutylaluminum tripropylsiloxide, dimethylaluminum triphenylsiloxide, diethylaluminum triphenylsiloxide, diisobutylaluminum triphenylylsiloxide, and the like; the most preferred monodentate agents are those from the in-situ generation through the decomposition of chelating agent treated MAO compositions, such as an OMTS treated MAO is heated to produce dimethylaluminum trimethylsiloxide as shown in Scheme 4 from I-b to I-a.

Ionic aluminoxane or ionic MAO herein means a charge neutral aluminoxane or MAO composition containing coordinated aluminumalkyl or TMA after an electron donor ligand or compound treatment forming an ionic composition containing aluminoxane anion or MAO anion and the electron donor ligand or compound stabilized dialkylaluminum cation or dimethylaluminum cation. Depending on the solubility of the ionic composition, the phase separation of the ionic composition from the mother solution may or may not occur. For example, ionic higher alkyl (e.g., C₄-C₈) modified MAO products (such as MMAO from Nouryon after ionization) may have better solubility in a common concentration range such as 10-30 wt %; on the other hand, ionic MAO in a common concentration may precipitate as a heavier liquid phase (or call a clathrate phase) to separate from the mother solution. Depending on the age of the MAO, ionic MAO from a fresher MAO product may be more soluble than the longer aging one. Very diluted solution may have all ionic MAO to dissolve.

Unless otherwise specified, the term “Cₙ” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical.” “hydrocarbyl group,” or “hydrocarbyl” may be used interchangeably and are defined to mean a group consisting of hydrogen and carbon atoms only. Hydrocarbyls may be C₁-C₁₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like, aryl groups, such as phenyl, benzyl, naphthalenyl, and the like.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

The term “substituted aromatic,” means an aromatic group having 1 or more hydrogen groups replaced by a hydrocarbyl, substituted hydrocarbyl, heteroatom or heteroatom containing group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group). For example, a “substituted phenolate” group in the catalyst compounds described herein is represented by the formula:

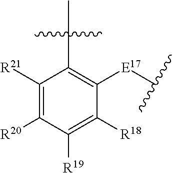

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R¹⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R¹⁸, R¹⁹, R²⁰, and R²¹ are joined together to form a C₄-C₆₂ cyclic or polycyclic ring structure, or a combination thereof, and the wavy line shows where the substituted phenolate group forms bonds to the rest of the catalyst compound.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a C₁ to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalenyl, and the like including their substituted analogues.

The term “ring atom” means an atom that is part of a cyclic ring structure. By this definition, a benzyl group has six ring atoms and tetrahydrofuran has 5 ring atoms.

A heterocyclic ring, also referred to as a heterocycle, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

For purposes of the present disclosure, in relation to catalyst compounds (e.g., substituted bis(phenolate) catalyst compounds), the term “substituted” means that a hydrogen group has been replaced with a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantyl, bicyclo[2.2.1]heptan-1-yl and the like. Tertiary hydrocarbyl groups can be illustrated by the formula:

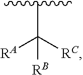

wherein R^{A}, R^{B} and R^{C} are independently hydrocarbyl groups or substituted hydrocarbyl groups that may optionally be bonded to one another, and the wavy line shows where the tertiary hydrocarbyl group forms bonds to other groups.

A cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantyl, 1-methylcyclohexyl, 1-methylcyclopentyl, 1-methylcyclooctyl, 1-methylcyclodecyl, 1-methylcyclododecyl, bicycle[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by formula B:

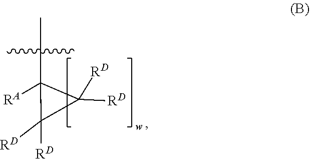

wherein R^{A} is a hydrocarbyl group or substituted hydrocarbyl group, each R^{D} is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The terms “alkyl radical” and “alkyl” are used interchangeably throughout this disclosure. For purposes of this disclosure, “alkyl radical” is defined to be C₁-C₁₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol-).

The following abbreviations may be used herein: Me is methyl, MAO is methylaluminoxane (or called methylalumoxane), OMTS is octamethyltrisiloxane, TMS is either trimethylsilyl or tetramethylsilane depending on as a group (former) or as a compound (latter), Bn is benzyl (i.e., CH₂Ph), THF (also referred to as thf) is tetrahydrofuran, RT is room temperature (and is 23° C. unless otherwise indicated), tol is toluene. Cp is cyclopentadienyl, NMR is nuclear magnetic resonance, and TMA is trimethylaluminum.

A “catalyst system” is a combination of at least one pre-catalyst compound, an activator, an optional coactivator, and an optional support material. When “catalyst system” is used to describe such a pair before activation, it means the unactivated catalyst complex (pre-catalyst) together with an activator and, optionally, a coactivator. When it is used to describe such a pair after activation, it means the activated complex and the activator or other charge-balancing moiety. The catalyst compound may be neutral as in a pre-catalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators (including support-bound activators) represented by formulae herein embrace both neutral and ionic forms of the catalyst compounds and activators.

In the description herein, the catalyst may be described as a catalyst, a catalyst precursor, a pre-catalyst compound, catalyst compound or a metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors may include, but are not limited to, methyl, chloride, fluoride, alkoxide, aryloxide, alkyl, alkenyl, thiolate, carboxylate, amido, benzyl, hydrido, amidinate, amidate, and phenyl. Two anionic donors may be joined to form a dianionic group.

A “neutral Lewis base” or “neutral donor group” is an uncharged (neutral) group which donates one or more pairs of electrons to a metal ion. Non-limiting examples of neutral Lewis bases include ethers, thioethers, amines, phosphines, ethyl ether, tetrahydrofuran, dimethylsulfide, triethylamine, pyridine, alkenes, alkynes, alenes, and carbenes. Lewis bases may be joined together to form bidentate or tridentate Lewis bases.

For purposes of the present disclosure and the claims thereto, phenolate donors can include Ph-O—, Ph-S—, and Ph-N(R\hat{ })— groups, where R\hat{ } is hydrogen. C₁-C₄₀ hydrocarbyl, C₁-C₄₀ substituted hydrocarbyl, a heteroatom or a heteroatom-containing group, and Ph is optionally substituted phenyl.

Lanthanide metals (La—Lu), include La, Ce, Pr, Nd, Pm, Sm, Eu, Gd, Tb, Dy, Ho, Er, Tm, Yb, and Lu.

### DETAILED DESCRIPTION

The present disclosure relates to active ionic alumoxanes free of or low in non-coordinated aluminumalkyl, methods of forming active ionic alumoxanes free of or low in non-coordinated aluminumalkyl, catalyst systems having the said active ionic alumoxanes, and methods of polymerizing olefins using catalyst systems derived from the active ionic alumoxanes.

In some embodiments, a method of making an ionic alumoxane free of or low in non-coordinated aluminumalkyl includes introducing an alumoxane with a chelating agent compound to form an ionic alumoxane following steps comprising separating non-coordinated aluminumalkyl and heating the ionic aluminoxane.

In some embodiments, a method of making an ionic alumoxane free of or low in non-coordinated aluminumalkyl includes introducing an alumoxane with a chelating agent to form an ionic alumoxane following steps comprising separating non-coordinated aluminumalkyl and heating the ionic aluminoxane. The method includes introducing a hydrocarbyl aluminum compound with an oxygen source at a temperature of about −60° C. to about 100° C. to form the alumoxane.

In some embodiments, a catalyst system comprises a pre-catalyst compound and an ionic alumoxane or the heated ionic aluminoxane derivative free of or low in non-coordinated aluminumalkyl.

In some embodiments, methods of polymerizing olefins include using catalyst systems having a pre-catalyst compound an ionic alumoxane or the heated ionic aluminoxane derivative free of or low in non-coordinated aluminumalkyl.

Methods can further include forming the alkylalumoxane for subsequent treatment with silanol or polydentate silane. For example, methods can include introducing trimethylaluminum with an oxygen source optionally in a support at a temperature of about −60° C. to about 100° C. to form a regular MAO composition before the ionic treatment.

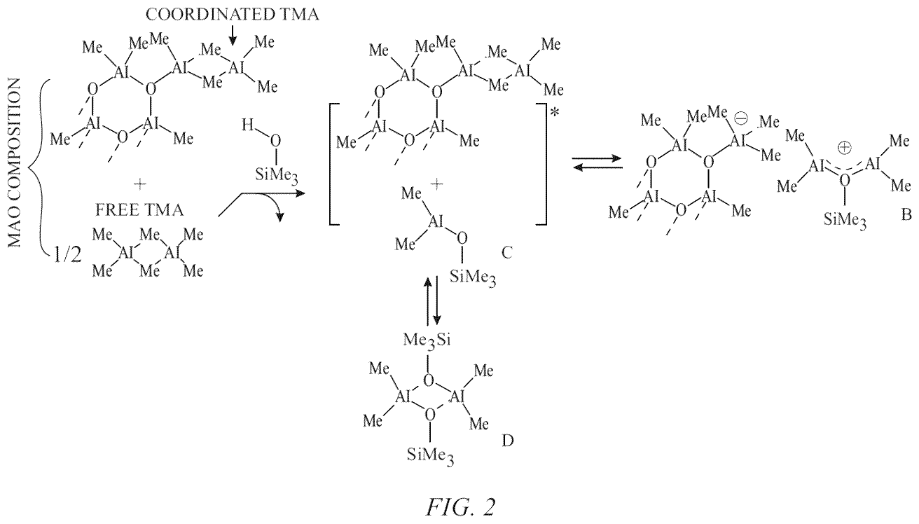

In some embodiments, a method of making an alkylaluminum free alkylalumoxane (e.g., TMA free MAO) that is an “ionic alkylalumoxane” includes the treatment of an alkyalumoxane, in a non-supported or a supported form, with a monodentate compound (e.g., Me₃SiOH) capable of converting the total alkylaluminum (e.g., free and coordinated TMA) to a composition with at least a portion containing the monodentate ligand stabilized dialkylaluminum cation (e.g., [AlMe₂(μ-O(SiMe₃))AlMe₂]⁺). The monodentate ligand stabilized dialkylaluminum cation can be formed by treating an alumoxane (e.g., MAO) with a silanol (e.g., as shown in FIG. 2) which reacts with free alkylaluminum (e.g., TMA) to form the ionic alumoxane (e.g., B of FIG. 2). Without being bound by theory, the silanol and free alkylaluminum derived compound is believed to extract the dialkylaluminum cation from the coordinated alkylaluminum on the aluminoxane to form the monodentate ligand stabilized dialkylaluminum cation, while the MAO main structure becomes the counter anion. Upon treatment of the monodentate compound derived ionic aluminoxane composition free of or low in non-coordinated alkylaluminum with a polymerization pre-catalyst including a pre-catalyst containing at least one non-leaving polar group (e.g., a metallocene, a half-metallocene, or a post-metallocene pre-catalyst), the pre-catalyst can be activated.

Alternatively, the ionic aluminoxane composition comprising a monodentate ligand can be formed by treating an alkylalumoxane having free alkylaluminum with a polydentate (e.g., bidentate) siloxane to form a chelating siloxane stabilized dialkylaluminum cation with the aluminoxane counter anion or called the chelating ionic aluminoxane composition. The chelating ionic aluminoxane composition can be heated for an amount of time to form a composition comprising the decomposed chelating ligand derived monodentate ligand. Upon treatment of the monodentate ligand containing ionic aluminoxane composition with a polymerization pre-catalyst (e.g., metallocene catalyst), the catalyst can be activated.

Alternatively, ionic aluminoxane compositions comprising a monodentate ligand can be formed by treating an alkylalumoxane (e.g., MAO) having free alkylaluminum (e.g., TMA) with a polydentate (e.g., bidentate) siloxane to form a chelating siloxane stabilized dialkylaluminum cation with the aluminoxane counter anion, or called the chelating ionic aluminoxane composition, that can precipitate as a clathrate phase. A separation process can then be performed to isolate the free aluminumalkyl from the ionic aluminoxane composition. The chelating ionic aluminoxane composition can be heated for an amount of time to form a composition comprising the decomposed chelating ligand derived monodentate ligand. Upon treatment of the monodentate ligand containing ionic aluminoxane composition with a polymerization pre-catalyst (e.g., a half-metallocene or a post-metallocene pre-catalyst), the catalyst can be more efficiently activated.

It has been discovered that an MAO can be treated with a polydentate siloxane to form a ionic complex containing the chelating siloxane stabilized dimethyl cation and the aluminoxane counter anion, e.g., [AlMe₂(OMTS)]⁺ (MeMAO)⁻, which is usually less active than the non-treated aluminoxane or MAO but becomes more active after heating, presumably due to the decomposition of the chelating ligand to form a less stable monodentate ligand derived ionic alkylaluminoxane or MAO readily to release the dialkylaluminum cation or dimethylaluminum cation, such as [AlMe₂(μ-O(SiMe₃))AlMe₂]⁺(MeMAO)⁻, for more efficient pre-catalyst activation. Without being bound to theory, the ionic aluminoxane composition containing the chelating siloxane stabilized dialkylaluminum cation without heat treatment is less active than the heated one for pre-catalyst activation is due to the energetic differences between the bond breaking and bond forming reactions below, with Scheme (1) for chelating ligand vs. Scheme (2) for monodentate ligand:

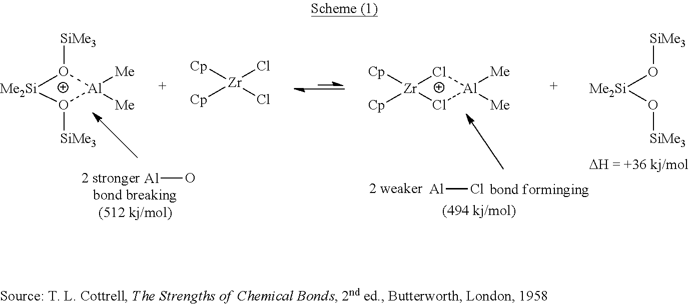

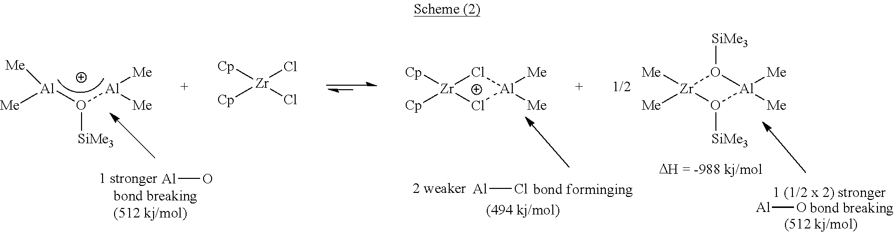

It has also been discovered that forming the monodentate ligand stabilized dialkylaluminum cation directly by using silanols to react with free TMA in MAO may eliminate the needs of phase separation to remove free TMA and heating, however, the resulting composition is not as active as the monodentate complex derived from the chelating complex, such as from [AlMe₂(OMTS)]⁺ (MeMAO)⁻ to [AlMe₂(μ-O(SiMe₃))AlMe₂](MeMAO)⁻ by heating, presumably because the active OH group reacts not only with free TMA but also with coordinated TMA (the active site) to form a strong bridging O (structure a) that blocks the leaving of AlMe₂⁺ (Scheme (3), with trimethylsilanol as an example).

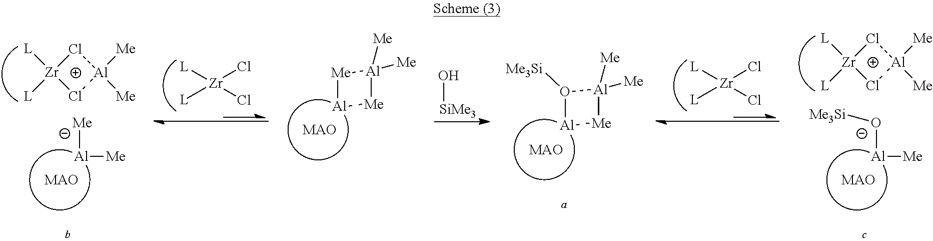

A slightly better way to overcome the silanol poisoning of the MAO active site is the use of a pre-formed product from the reaction of free alkylaluminum with a silanol, such as free TMA with trimethylsilanol: Me₃SiOH+AlMe₃=Me₃SiOAlMe₂+CH₄. However, this route is only applicable on supported or solid aluminoxanes in order to obtain a coordinated alkylaluminum free system because the coordinated alkylaluminum is converted to free alkylaluminum and the separation from a solution system and becomes challenging. With a supported or solid alkylaluminoxane system, such as silica supported MAO or solid MAO, a more practical separation process can be applied, e.g., a filtration or decantation process, or a vacuum drying (may plus heating) process for lower boiling free alkylaluminum such as free TMA.

The most efficient route is the chelating agent treatment route can be OMTS treatment of supported or unsupported MAO followed by a phase separation process for a solution aluminoxane system or a filtration/decantation process for a supported or solid aluminoxane system (or a vacuum/heating process for low boiling point alkylaluminum removal).

The TMA free ionic alumoxane composition likewise reduces or eliminates side reactions of non-leaving hetero-atom coordinative pre-catalyst compounds such as oxygen and nitrogen donors in half-metallocenes (e.g., constrain geometry catalyst (CGC)) and post-metallocenes, promoting improved catalyst activity and lifetime.

In addition, the alumoxane may be formed such that free TMA in the solution remains in the upper solution phase and can be removed from the ionic MAO by doing a phase cut of clathrate and solution phases. In some embodiments, the free TMA may remain in the supernate phase of a supported ionic MAO composition and can be removed by doing a filtration or decantation with wash. After removal, the resulting solution or supported ionic activator can thus be used for the activation of single-site catalyst precursors containing TMA reactive groups, e.g., O and/or N donors on post-metallocene catalysts and CGC half-metallocene families.

The monodentate ligand stabilized dimethylaluminum cation derived from a chelating ligand treated MAO after a heating treatment providing more dimethylaluminum cations for pre-catalyst activation can be detected by the NMR spectroscopy. In addition, by using a silanol compound, if the ratio of siloxy group to hydrocarbyl aluminum compounds is about 1:1, the amount of free trihydrocarbyl aluminum compound (such as trimethylaluminum) present in a catalyst system can be reduced or eliminated, which therefore reduces the decomposition reactions of oxygen-containing catalyst compounds and/or nitrogen-containing catalyst compounds with the oxygen or nitrogen reactive trihydrocarbyl aluminum in the catalyst system. For example, the presence of the monodentate ligand may convert the most reactive primary trihydrocarbyl aluminum (e.g., dimeric form of AlMe₃ or TMA) to a less active secondary dihydrocarbyl aluminum (e.g., as [Al₂Me₄(OSiMe₃)]⁺ or SiMe₃(OAlMe₂)₂.

In addition, without being bound by theory, the presence of monodentate ligands in the treated MAO likewise reduces or eliminates the chance of forming free TMA as shown in the regular MAO free TMA and coordinated TMA equilibrium Scheme (4) and thus reduces or eliminates the free TMA related side reactions of oxygen-containing catalyst compounds and/or nitrogen-containing catalyst compounds, promoting improved catalyst activity and lifetime.

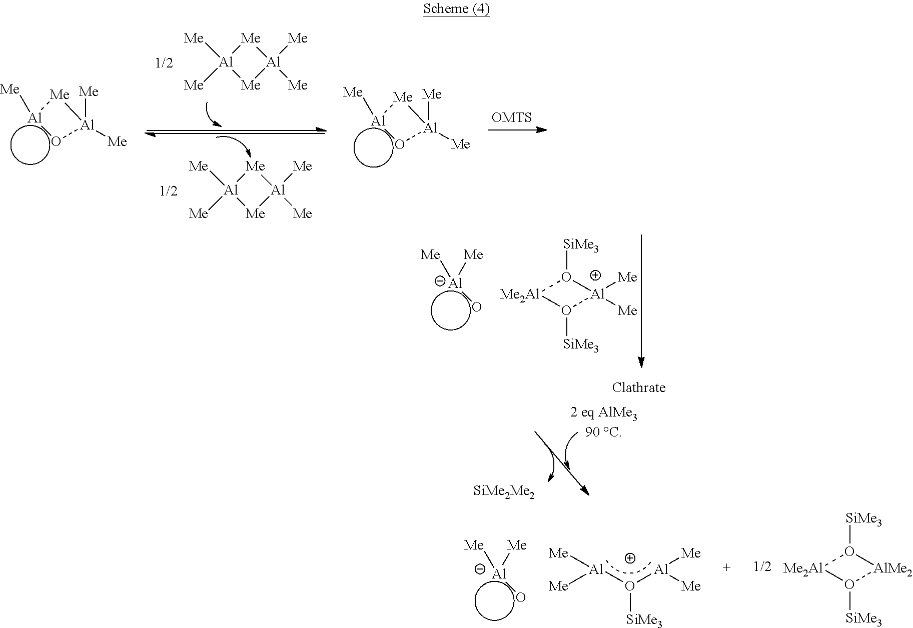

In some embodiments, the non-coordinated TMA free ionic MAO may be formed as a reaction of heating the chelating agent stabilized ionic MAO composition to produce the decomposed chelating agent derived compounds comprising at least one monodentate ligand species. The non-coordinated TMA free ionic MAO may outperform regular MAO activators or N,N-dimethylanilinium tetrakis(pentafluorophenyl)borate (D4)/diisobutylaluminum hydride (DIBAH) activators for bis(phenolate)-containing Group 3 and Lanthanide metal catalyst precursors. Additionally, the TMA free ionic MAO may be more efficient at activating some of the post-metallocene catalyst precursors that the TMA free anion modified activator such as MAO modified with an electron withdrawing group (e.g., TMA free fluorinated MAO or F-MAO) have shown a lower efficiency to activate. In general, non-coordinated TMA free ionic MAO (or called cation modified MAO) may extend the activation range of O and/or N containing post-metallocene pre-catalysts and CGC half-metallocene pre-catalysts where the non-coordinated TMA free anion modified MAO has shown limited activation. More polyolefin products with desired plastic properties based on half-metallocene or post-metallocene pre-catalysts can therefore be produced with desired production rates with lower cost in use.

### Unsupported Alumoxanes and Supported Alumoxanes

Alumoxanes are oligomeric compounds containing —Al(R)—O— or —Al(R)₂—O— subunits, where R is an alkyl group, typically a C₁ to C₁₂ alkyl group, such as the inactive MAO gel shown in Scheme (1). Examples of useful alumoxanes include soluble active methylalumoxane (MAO) with Me:Al ratio in the range of 1.4 to 1.5, corresponding to the O:Al ratio in the range of 0.8 to 0.75 based on element valence balance, according to Imhoff, D. W. et al. (1998) “Characterization of Methylaluminoxanes and Determination of Trimethylaluminum Using Proton NMR,” Organometallics, v.17(10), p. 1941-1945, such as the Sinn/Kaminsky fresh MAO formula (Al₄O₃Me₆)₄(TMA)ₜ₋₂ where O:Al=0.75 excluding coordinated TMA as the Organometallics method shows, as well as other modified MAOs, e.g., MAO modified with a high alkylaluminum containing C₁ to C₁₀ alkyl, a carbocation agent, a dialkylaluminum cation precursor agent, or the like that contains elements/groups other than Al, Me, and O, e.g., F, Cl, bulky aryoxy, purfluorinated aryloxy (e.g., —OC₆F₅), etc. Fresh soluble active MAO from the reaction of largely excess TMA with water at a low enough temperature may therefore have an Al:O ratio 1:0.75 and the oxygen may increase during the preparation where the oxygen source has a higher concentration or the reaction is carried at a higher temperature (e.g., −10° C. instead of −20° C.), or after MAO formation where MAO has a longer storage time (aging time), the storage temperature is higher (e.g., −5° C. instead of −20° C.) or physical removal of free TMA that is in equilibrium with the coordinated TMA Scheme (1), e.g., about 1:0.78 in a Grace 30% MAO solution after the removal of largely excess TMA to form a product containing about 85 mol % MAO and about 15 mol % total TMA (Imhoff, et al., Organometallics, 1998, v.17 (10), p. 1941). The gelation process may start after the solution MAO is made even under cooling. The solution MAO composition can therefore change with time, e.g., by the observation of increasing oxygen content in the main MAO structures with the increase of free TMA and decrease of coordinated TMA. In some embodiments, a solution MAO with a similar age under similar storage conditions can be used. In some embodiments, a solution MAO with an age younger than 6 months under a low temperature storage, e.g., lower than −10° C., more preferably lower than −20° C., most preferably lower than −30° C., can be used. In some embodiments, the solution MAO with an age less than a week under cooling, e.g., lower than −10° C., more preferably lower than −20° C., most preferably lower than −30° C., can be used.

There are a variety of methods for preparing MAO and modified MAO, such as the methods described in U.S. Pat. No. 4,542,199 and Chen, E. et al. (2000) “Cocatalysts for Metal-Catalyzed Olefin Polymerization: Activators, Activation Processes, and Structure-Activity Relationships,” Chem. Rev., v100(4), pp. 1391-1434. For example, MAO can be modified for different purposes, e.g., increasing activity, solubility. Examples of useful MAO include MAO from TMA with an oxygenate (e.g., W. R. Grace MAO from TMA with water, or Nouryon PMAO from TMA with an organic oxygen source, or Tosoh solid MAO), higher alkyl modified MAO (e.g., Nouryon MMAO), carbocation agent modified MAO (U.S. Pat. No. 9,090,720), dialkylaluminum cation precursor agent modified MAO (U.S. Pat. No. 8,575,284), halogen modified MAO (U.S. Pat. No. 7,355,058), etc.

Active MAO may be formed from the contact of largely excess TMA with an oxygen source (such as water, metal salt coordinated water, CO₂, methylacrylic acid, benzoic acid, or other reactive oxygen containing organics) under suitable reaction conditions.

Active unsupported MAO of the present disclosure can be obtained commercially or synthesized. Unsupported active MAO includes solution MAO (e.g., W. R. Grace, Lanxess, or Nouryon 30% MAO solution in toluene) and solid MAO (a solid MAO product from a solution MAO after solvent removal, such as the solid MAO sold by Tosoh FineChem Corporation). Active solution or solid MAO of the present disclosure can be prepared in situ by contacting the hydrocarbyl aluminum compound with an oxygen source, e.g., TMA with water in an aliphatic or aromatic diluent, at a temperature of less than 0° C. to −60° C., such as −10° C. to −50° C., such as −15° C. to −30° C.

Supported MAO of the present disclosure can be prepared by conventional methods such as bringing into contact of a pre-formed MAO solution with a support (e.g., silica). For example, the solution MAO can be added to a solid support or a support slurry or a reverse addition followed by optional heating to form the supported MAO. Supported MAO of the present disclosure can also be prepared in-situ by contacting the hydrocarbyl aluminum compound with an oxygen source loaded in a support. The operations are typically conducted in a suitable inert liquid phase such as in a liquid hydrocarbon diluent such as a liquid aromatic hydrocarbon or an aliphatic hydrocarbon. For example, water pre-loaded in a support material (e.g., silica) in slurry form in an aliphatic or aromatic diluent or in solid form with optional cooling can be added to a TMA solution cooled to a temperature of less than 0° C. to −60° C., such as −10° C. to −50° C., such as −15° C. to −30° C. following a heating process as described in U.S. Pat. No. 11,161,922 and WO 2022/108974A1; or a non-hydrolytic organic oxygenate can be mixed with TMA under cooling, e.g., at a temperature of less than 0° C. to −60° C., such as −10° C. to −50° C., such as −15° C. to −30° C. to form a pre-MAO composition and then mix a support (e.g., silica) followed by a heating process to obtain the supported MAO as described in U.S. Pat. No. 11,021,552.

For solution MAO supportation, suitable diluents for forming a support slurry, e.g., silica slurry, are capable of dissolving MAO to ensure a good MAO distribution inside the pores of the support, such as diluents such as toluene, benzene, or xylenes. In some embodiments, the supported catalyst can be made for example by contacting or mixing the supported ionic aluminoxanate with the metal catalyst compound or complex. For in-situ supported MAO, suitable diluents are materials in which the reactants, e.g., the hydrocarbyl aluminum such as TMA, the non-hydrolytic organic oxygenate, and the derivatives of the two reagents, are at least partially soluble and which are liquid at reaction temperatures. Non-limiting example diluents are non-cyclic alkanes with formula CₙH₍₂ₙ₊₂₎ where n=4 to 30, such as isobutene, butane, isopentane, hexane, n-heptane, octane, nonane, decane and the like, cycloalkanes with formula CₙH₂ₙ₋₂ where n=5 to 30, such as cyclopentane, methylcyclopentane, cyclohexane, methylcyclohexane and the like, and mixtures thereof. Suitable aromatic diluents can include toluene, benzene, or xylenes.

Various ratios of supported ionic alumoxanes to the metal catalyst compound can be used. For example, ratios such that the mole ratio of aluminum to catalyst metal is in the range of about 1:1 to about 2000:1 may be used, e.g., about 10:1 to about 300:1, such as about 100:1 to about 150:1. Temperatures in the range of about 0° C. to about 80° C. may be used when bringing the supported aluminoxane and the pre-catalyst into contact.

### Hydrocarbyl Aluminum Compounds for Alkylalumoxanes and Modified Alkylalumoxanes

The active alumoxane composition (such as MAO) can be exclusively formed with trimethylaluminum (TMA), but other aluminumalkyl compounds (also referred to as alkyl aluminum compounds) can be used to modify the MAO. The hydrocarbyl aluminum compounds used for alumoxane modification can be alkylaluminum compounds such as a trialkylaluminum compound. For example, the alkyl substituents can be alkyl groups of up to 10 carbon atoms, such as octyl, isobutyl, ethyl or methyl. Thus, suitable hydrocarbyl aluminum compounds may include trimethylaluminum, triethylaluminum, tripropylaluminum, tri-n-butylaluminum, tri-isobutyl-aluminum, tri(2-methylpentyl)aluminum, trihexylaluminum, tri-n-octylaluminum, and tri-n-decylaluminum. In some embodiments, hydrocarbyl aluminum compounds are trimethylaluminum and tri-n-octylaluminum. In some embodiments, hydrocarbyl aluminum compounds are represented by the formula R₃Al where each R is independently a hydrocarbon containing between 1 and 30 carbon atoms.

In some embodiments, the hydrocarbyl aluminum compound is one or more of trialkylaluminum mixtures, e.g., dimethylethylaluminum or methyldiethylaluminum from AlMe₃ and AlEt₃ mixture, diethylisobutylaluminum or ethyldiisobutylaluminum from AlEt₃ and AliBu₃ mixture, and the like.

### Oxygen Sources for Forming Alkylalumoxanes

Methods can further include forming the alkylalumoxane for subsequent treatment with silanol or polydentate silane. For example, methods can include introducing a hydrocarbyl aluminum compound (such as trimethyl aluminum) with an oxygen source optionally in a support at a temperature of about −60° C. to about 100° C. to form a regular MAO composition before the ionic treatment.

The preferred oxygen source is water including ice or water absorbed or distributed on an inorganic or organic substance. However, suitable oxygen sources may also include any oxygen sources in which one or more oxygen atoms is able to react with the hydrocarbyl aluminum compound to form a new Al—O bond. In at least one embodiment, the oxygen source may be or include water, such as pure water or water in a metal salt hydrate. In some embodiments, the oxygen source can be one or more hydroxy or carbonyl containing compounds for example an alcohol, CO or CO₂, an acetone, or a carboxylic acid. In at least one embodiment of the present disclosure, the oxygen source is one or more of carbon dioxide, a carboxylic acid, a ketone, an aldehyde, an ester, an anhydride, an alcohol, or combination thereof.

In at least one embodiment of the present disclosure, the oxygen source is represented by the formula R¹R²C═CR³CO₂H wherein each of R¹ and R² is independently hydrogen, alkyl, alkenyl, aryl or heteroatom containing group and R³ is alkyl, alkenyl, aryl or heteroatom containing group.

In at least one embodiment of the present disclosure, the oxygen source includes in the hydrocarbyl aluminum compound, e.g., the reaction product of TMA with an alcohol, a ketone, an ester, or an organic acid. Examples of hydrocarbyl aluminum compounds which include an oxygen source include dimethyl aluminum methoxide, dimethyl aluminum ethoxide, dimethyl aluminum isopropoxide, dimethyl aluminum n-butoxide, dimethyl aluminum isobutoxide, pentamethyldialuminum-t-butoxide, tetramethyldialuminumdi-t-butoxide, pentamethyldialuminum-1-propoxide, tetramethyldialuminumdi-1-propoxide, or the mixture of the listed compounds and the like.

The starting charging molar ratio of Al:O, where O is the active oxygen in the active oxygen containing compound, can be 100:1, 60:1, 30:1, 10:1, 1:1, or 0.9:1 to form the desired MAO compositions with or without excess free hydrocarbyl aluminum compounds. In some embodiments, the molar ratio of Al:O can be about 0.9:1 to about 100:1, such as about 1:1 to about 10:1, alternatively about 10:1 to about 60:1, such as about 30:1 to about 60:1. If undesired excess hydrocarbyl aluminum compound(s) is (are) present, it (they) can be removed, for example, by filtration and then washed with an aliphatic diluent and/or treated with chelating agents of the present disclosure. It should be understood that the above Al:O ratios are the starting material (or end of preparation) ratio. Since the reaction of TMA with some oxygen source is extremely rapid and exothermic, e.g., with water, the addition sequence may change the real reagent ratio very significantly with the “end of preparation ratio”. For example, when water is added slowly as required to avoid an overheated or explosive reaction, the TMA to the initial water (e.g., the 1^{st} drop) ratio in the reactor is approaching indefinite when the reaction is completed. And in a continuing process, more than 1000:1 Al:O may be used since the unreacted TMA can be recycled to reuse for the reaction. Therefore, >1000:1 Al:O ratio may still be practical.

In some embodiments, the oxygen source is water in any form including as an adduct.

In some embodiments, the oxygen source is one or more of carbon dioxide, a carboxylic acid, an ester, an anhydride, an alcohol or combination thereof.

In some embodiments, the oxygen source is one or more of carbon dioxide, a carboxylic acid, an ester, an anhydride and an alcohol or combination thereof, optionally containing water.

In some embodiments, the oxygen source is R¹R²C═CR³CO₂H wherein each of R¹ and R² is independently hydrogen, alkyl, alkenyl, aryl or heteroatom containing group and R³ is alkyl, alkenyl, aryl or heteroatom containing group.

In some embodiments, the oxygen source is methacrylic acid.

In at least one embodiment of the present disclosure, the oxygen source is a hydrocarbylboroxine as described in Welbom, U.S. Pat. No. 5,001,244, incorporated by reference herein.

### Cation Modified (or Ionic) Alumoxanes

Stable chelating or monodenate agents (such as silanols as well as the derived dialkylaluminum siloxides or polydentate siloxanes) may be used as starting materials in the production of the ionic alumoxanes. A wide variety of organic, inorganic, or organometallic compounds may be suitable for use in forming an ionic alumoxane. In some embodiments, a variety of alumoxanes can be used in forming stable alkylalumoxanes, such as methylalumoxane. In forming the stable ionic alumoxane, the denser lower liquid phase (or the clathrate phase) may be readily separated from the upper solution phase by conventional separation techniques such as by phase cut, decantation, or draining.

Chelating agent derived ionic MAO: in some embodiments, a starting material may be a chelating agent dissolved in a hydrocarbon solvent such as an aromatic solvent. For example, starting materials may include a hydrocarbylalumoxane, e.g., an alkylalumoxane, and a chelating agent that is a hydrocarbylpolysiloxane, such as a hydrocarbyltrisiloxane. In some embodiments, a chelating hydrocarbylpolysilyloxane compound can have at least three silicon atoms in the molecule, which are separated from each other by an oxygen atom such that there is a linear, branched, or cyclic backbone of alternating Si and oxygen atoms, with the remainder of the four valence bonds of each of the silicon atoms individually satisfied by a univalent hydrocarbyl group. The hydrocarbylpolysiloxane may have as many as 18 or more silicon atoms in the molecule. The univalent hydrocarbyl groups of the polysiloxane may each contain, independently, up to about 18 carbon atoms, and can be such groups as alkyl, cycloalkyl, aryl, aralkyl, etc.

In some embodiments, a chelating agent may include a polydentate siloxane having the formula R(SiR₂O)ₙSiR₃ where each R is independently hydrogen, alkyl (e.g., methyl, ethyl, propyl, butyl, pentyl, hexyl, heptyl, octyl, nonyl, or decyl), alkenyl, aryl, or a heteroatom substituted hydrocarbyl group and n=2-8. In some embodiments, each R is methyl. In some embodiments, the chelating agent may include a cyclic polydentate siloxane having the formula (SiR₂O)ₙ, where R is independently hydrogen, alkyl (e.g., methyl, ethyl, propyl, butyl, pentyl, hexyl, heptyl, octyl, nonyl, or decyl), alkenyl, aryl, or a heteroatom substituted hydrocarbyl group and n=3-6.

Non-limiting examples of such polysiloxanes include hexamethylcyclotrisiloxane, octamethylcyclotetrasiloxane, octaphenylcyclotetrasiloxane, octamethyltrisiloxane (OMTS), decamethyltetrasiloxane, dodecamethylpentasiloxane, tetradecamethylhexasiloxane, 2,4,6,8-Tetramethyl-2,4,6,8-tetravinylcyclotetrasiloxane (as an example of alkenyl substituent on the polydentate compound), and 1,3,5,7-tetrakis(3,3,3-trifluoropropyl)1,3,5,7-tetramethylcyclosiloxanes (as an example of hetero-atom containing substituent on the polydentate compound).

In some embodiments, the ionic alkylaluminoxane, e.g., ionic MAO, containing the chelating ligand stabilized dialkylaluminum cation, e.g., [AlMe₂(OMTS)]⁺, can be heated to become more active, presumably by forming the less stable monodentate complex after heating readily to release dialkylaluminum cation, e.g., AlMe₂⁺, as the structure I-a indicated by ¹H-NMR:

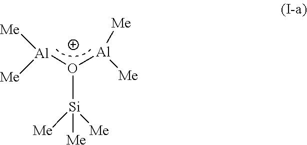

Monodentate agent derived ionic MAO: Alternatively, the ionic alumoxane may be formed by using a silanol SiR₃OH to convert free alkylaluminum, such as TMA, in an aluminoxane composition, e.g., an MAO composition, to form a monodentate coordination compound AlR₂OSiR₃ in-situ (e.g., as shown in FIG. 2 with R=Me) to serve as a dialkylaluminum cation stabilization agent as well as to eliminate or reduce the free alkylaluminum, which is desired for a solution aluminoxane system due to challenging process to remove free alkylaluminum in a solution system. The R group of silanols having formula HO—SiR₃ where each R is independently hydrogen, alkyl (e.g., methyl, ethyl, propyl, butyl, pentyl, hexyl, heptyl, octyl, nonyl, or decyl), alkenyl, aryl, or a heteroatom containing group. In some embodiments, each R is methyl.

In some embodiments, the monodentate coordination compound AlR²OSiR₃ (Formula 11) can pre-form and applied to a solid or supported aluminoxane system following a free alkylaluminum separation process, e.g., a filtration or decantation process, to reduce or eliminate the free alkylaluminum in the system. Optionally, a heating process with optional vacuum drying process can be applied to a supported or solid aluminoxane system if a low boiling point free alkylaluminum is to be removed, such as free TMA.

In some embodiments, non-coordinated alkylaluminum free ionic alumoxanes are those formed in an aromatic hydrocarbon, such as benzene, toluene, xylene(s), ethylbenzene, cumene, etc., in which the reactants are an alkylalumoxane and at least one chelating or monodentate agent, most preferably methylalumoxane, and octamethyltrisiloxane.

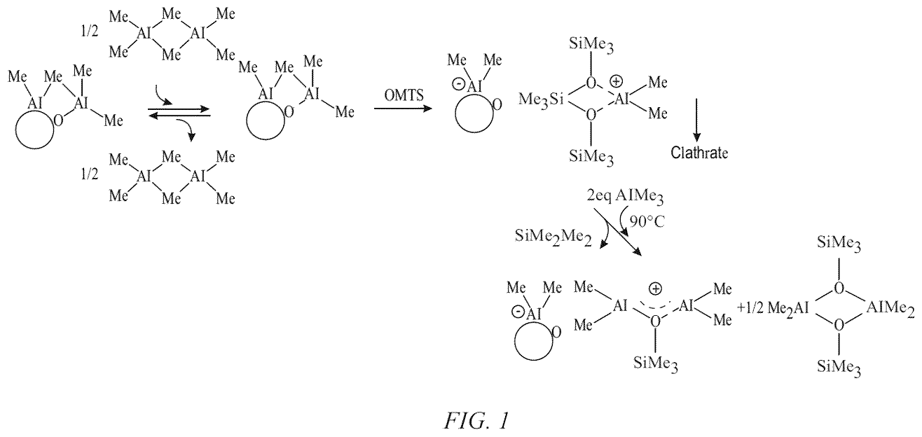

In some embodiments where a polydentate siloxane is used, the alumoxane having a siloxane alkylaluminum complex (e.g., A of FIG. 1) may be thoroughly washed (before heating) with an aromatic or aliphatic solvent such as benzene, toluene, xylene, ethylbenzene, or other aromatic solvent such as a mixture of two or more liquid aromatic hydrocarbons, or a C₃-C₁₂ saturated hydrocarbon solvent, such as isobutene, isohexane, isopentane, isohexane, heptane, octane, and the like, and when a low boiling point solvent is in use, e.g., isobutene, a cooling and/or closed environment may be required to limit the escaping of solvent. Additionally or alternatively, the ionic alumoxane formed (e.g., B of FIG. 1 or B of FIG. 2) may be thoroughly washed with an aromatic or aliphatic solvent such as benzene, toluene, xylene, ethylbenzene, or other aromatic solvent such as a mixture of two or more liquid aromatic hydrocarbons, or a C₃-C₁₂ saturated hydrocarbon solvent, such as isobutene, isohexane, isopentane, isohexane, heptane, octane, and the like, or a solvent mixture of aromatic and aliphatic solvents or two or more aliphatic solvents. The volume of solvent used relative to the initial alumoxane may vary so long as a stirrable solution is produced. After each washing a two-phase liquid system may be formed and the less dense upper layer may be separated from denser lower liquid phase, e.g., by decantation (which removes residual free alkylaluminum). Such washing can be conducted at ambient temperatures or at suitably reduced or elevated temperatures. e.g., in the range of about 10° C. to about 100° C. although still higher or lower temperatures may be used. In some embodiments, the washing is conducted at one or more temperatures in the range of about 20° C. to about 80° C. In some embodiments, washing at room temperature is performed. In some embodiments, stirring may be used to agitate the mixture formed after the washing. The washing may result in the formation of a relatively dense or oily washed liquid alumoxane composition. An inert liquid non-solvent may then be added to the alumoxane in order to form precipitated solids which may have a reduced content of neutral alumoxane.

In some embodiments, the non-solvent may force solvent included in the alumoxane out of the alumoxane to yield a new composition as solids, causing precipitation. Various inert non-solvents can be used, e.g., C₃-C₁₂ aliphatic hydrocarbon solvents, such as one or more isobutene, isopentane, isohexane, heptane, octane, nonane, or decane isomers, cyclopentane, one or more liquid alkylcyclopentanes, cyclohexane, one or more liquid alkylcyclohexanes, and any mixture of any two or more of such hydrocarbons. The non-solvent may be added at ambient room temperature or at suitably reduced or elevated temperature. e.g., about 20° C. to about 100° C.

The precipitated solids resulting from the washing of the ionic alumoxane having the chelating polysiloxane stabilized dialkylaluminum cation (e.g., A of FIG. 1) or the monodentat dialylaluminum siloxide stabilized dialkylaluminum cation (e.g., B of FIG. 1 or B of FIG. 2), which may be recovered, e.g., by filtration, centrifugation, decantation, or like techniques in a solid form. In some embodiments, the recovered solids are washed with fresh non-solvent.

In some embodiments where a polydentate siloxane is used as a chelating agent, the solids are then dissolved in any suitable liquid such that dissolution occurs and heated at elevated temperatures to convert the polysiloxane alkylaluminum complex in the ionic aluminoxane composition into at least one decomposed chelating ligand fragments to form a more active ionic MAO composition, presumably having monodentate ligand stabilized dialkylaluminum cation (e.g., B of FIG. 1), which become less stable to readily release the cation once a pre-catalyst is present. The heating process can be carried in certain temperature range, e.g., in the range of about 70° C. to about 110° C., such as about 85° C. to about 95° C., for a period of time, e.g., about 0.1 to about 5 hours, such as about 1 hour.

Alternatively, the solids may be aged at room temperature to convert the alumoxane having a polydentate agent into an alumoxane having a monodentate ligand (to form the less stable cation) for a period of time, e.g. about 1 to about 12 months, such as about 5 months. The clathrates having monodentate or chelating ligands formed may have a higher electrical conductivity than the mother solution non-ionic aluminoxane, demonstrating a stronger ionic character.

The monodentate or chelating ligands formed by methods of the present disclosure may be a hydrocarbylmonosiloxy group having at least one oxygen atom in the molecule, with the remainder of the three valence bonds of the silicon atom individually satisfied by a univalent hydrocarbyl group. The univalent hydrocarbyl groups of the hydrocarbylmonosiloxy group may each contain, independently, up to about 18 carbon atoms, and can be such groups as alkyl, cycloalkyl, aryl, or heteroatom containing group. Non-limiting examples of such monodentate ligands include [Me₂Al(μ-OSiMe₃)SiMe₂]⁺ (e.g., A of FIG. 1) or [Me₂Al(μ-OSiMe₃)AlMe₂]⁺ (e.g., B of FIG. 1).

In some embodiments, a monodentate ligand is represented by Formula (I):

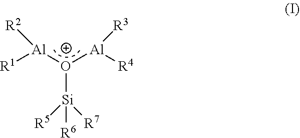

wherein each of R¹, R², R³, R⁴, R⁵, R⁶, and R⁷ is independently a hydrogen, a hydrocarbyl, a silyl group, or a heteroatom-containing group.

In some embodiments, each of R¹, R², R³, R⁴, R⁵, R⁶, and R⁷ is independently alkyl (e.g., methyl, ethyl, propyl, butyl, pentyl, hexyl, heptyl, octyl, nonyl, or decyl), alkenyl, or aryl. In some embodiments, each of R¹, R², R³, R⁴, R⁵, R⁶, and R⁷ is methyl.

As discussed above, there are at least 3 major methods to obtain a non-coordinated alkylaluminum free unsupported or supported aluminoxane system:

1) Free or non-coordinated hydrocarbyl aluminum compound (or dimer thereof) as a required component in a regular unsupported or supported alkylaluminoxane composition, e.g., a commercial MAO toluene solution, a solid MAO, a supported regular MAO, or an in-situ supported MAO, can be removed after the unsupported or supported aluminoxane composition is treated with a chelating agent to form an ionic alkylaluminoxane composition to allow the separation from the unsupported or supported aluminoxane, either as a lighter phase in the solution MAO case or in the supernate phase in the solid MAO or supported MAO case to enable a coordinated alkylalumoxane-free unsupported or supported alumoxane system.

2) Non-coordinated alkylaluminum free aluminoxane system can be obtained by a silanol treatment, where the non-coordinated alkylaluminum can be pre-quantified for the matching of the silanol in use. The major benefit of this method includes that the free alkylaluminum separation process may not be needed. The disadvantage is that the activation of the derived system is not as efficient as the method in 1), presumably because the silanol reacts not only with the free alkylaluminum, but also the coordinated alkylaluminum, e.g., free TMA as well as coordinated TMA to block the release of AlMe₂′ from the coordinated TMA (the active site) as Scheme (4) shows.

3) Non-coordinated alkylaluminum free aluminoxane system can also be obtained through the treatment with a pre-formed silanol derived compound R³SiOAlR₂ (Formula (II), R is independently hydrogen, hydrocarbyl, non- or weak-coordinative heteroatom containing group) to avoid the silanol poisoning of the coordinated alkylaluminum as shown in 2). But the method may be more suitable for solid or supported MAO due to the resulting ionic MAO's higher solubility that makes a poor phase separation in solution to make the removal of free alkylaluminum more challenging. The method is with better activation efficiency but not as good as the method in 1), without being bound with theory, due to deactivated species such as the species from the coordinated alkylaluminum replaced with R³SiOAlR₂, which makes AlR₂⁻ leaving from the coordinated R³SiOAlR₂ more difficult.

In some embodiments, for a solution, solid, or supported alumoxane (e.g., MAO) composition, the monodentate ligand, which is formed in-situ by the treatment of the MAO composition with a chelating or monodentate agent (that is a polydentate siloxane or a silanol or silanol derived dialkylaluminum compound).

In some embodiments, the amount of the chelating agent (e.g., OMTS) applied to the alkylaluminoxane composition may be determined by the chelating agent titration of the targeted alkylaluminoxane, e.g., an excessive known amount of OMTS (Wⁱ) can be charged into an alkylaluminoxane solution and a proton NMR can be used to determine the ratio of the non-coordinated (neutral) OMTS vs. [AlMe₂(OMTS)]⁺ therefore the percentage of reactive OMTS can be calculated; e.g., Reactive OMTS %=([AlMe₂(OMTS)]⁺/([AlMe₂(OMTS)]⁺+neutral OMTS))×100. The total reactive OMTS amount is therefore calculated as Wⁱ× Reactive OMTS %, see Experimental Examples section for details. Although the amount of chelating agent is most preferably equal to Wⁱ× Reactive OMTS %, more or less charge is still acceptable. e.g., 20% more or less than Wⁱ× Reactive OMTS %, 10% more or less than Wⁱ× Reactive OMTS %, or 5% more or less than Wⁱ× Reactive OMTS %.

In some embodiments, the silanol SiR₃OH may be charged based on the free alkylaluminum in the aluminoxane composition, e.g., free TMA in the MAO composition. The free alkylaluminum, e.g., free TMA determination method is described in the Experimental Examples section below. Although the amount of silanol is most preferably equal to the amount of the free alkylaluminum in the alkylaluminoxane composition (mol:mol), more or less charge is still acceptable, e.g., 20 mol % more or less than the free alkylaluminum, 10% more or less than the free alkylaluminum, or 5% more or less than the free alkylaluminum.

In some embodiments, the pre-formed silanol (SiR₃OH) derived SiR₃OAlR₂ may be charged based on the coordinated alkylaluminum in the aluminoxane composition, e.g., coordinated TMA in the MAO composition. The coordinated alkylaluminum, e.g., coordinated TMA determination method is described in the Experimental Examples section. Although the amount of SiR₃OAlR₂ is most preferably equal to amount of the coordinated alkylaluminum in the alkylaluminoxane composition (mol:mol), more or less charge is still acceptable, e.g., 20 mol % more or less than the coordinated alkylaluminum, 10% more or less than the coordinated alkylaluminum, or 5% more or less than the coordinated alkylaluminum.

The chelating or monodentate ligand stabilized dialkylaluminum cation formation reaction can proceed at any suitable temperature, such as about 0° C. to about 100° C., such as about 10° C. to about 30° C., such as about 20° C., such as ambient temperature. The reaction can proceed neat (e.g., solid-solid) or can proceed using any suitable diluent. In some embodiments, a diluent can be an organic diluent, such as an aliphatic diluent or an aromatic diluent. Aliphatic diluent can be non-cyclic alkanes with formula CₙH₍₂ₙ₊₂₎ where n=4 to 30, such as isobutane, butane, isopentane, hexane, n-heptane, octane, nonane, or decane, cycloalkanes with formula CₙH₂ₙ₋₂ where n=5 to 30, such as cyclopentane, methylcyclopentane, cyclohexane, methylcyclohexane and the like, and mixtures thereof. Aromatic diluent may include benzene, toluene, or xylenes. For chelating ligand derived ionic alkylaluminoxane composition, a heating process may be applied to increase the pre-catalyst activation efficiency. The heating temperature can be 60° C. to 120° C., more preferable 80° C. to 110° C., and most preferably 90° C.-100° C. The heating can be done under 1 atmosphere pressure in an open system or a reduced or elevated pressure, such as 0.1 atm to 15 atm, 0.5 atm to 10 atm, or 0.9 atm to 5 atm in a closed system with corresponding safe pressure rating.

After treatment with a monodentate or chelating agent with the optional free alkylaluminum separation process, an alkylaluminoxane, e.g., MAO (unsupported or supported), can have an amount of free hydrocarbyl aluminum compound of about 2 wt % or less, such as about 1.5 wt % or less, such as about 1 wt % or less, such as about 0.5 wt % or less, such as about 0.25 wt % or less, such as about 0.1 wt % to about 2 wt %, such as about 0.1 wt % to about 1.5 wt %, such as about 0.2 wt % to about 1 wt %, such as about 0.3 wt % to about 0.7 wt %, alternatively about 0.1 wt % to about 0.5 wt %, based on total aluminum content of the MAO. The free alkylaluminum determination method is described in the Experimental Examples section below.

### Optional Support Materials

The support material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 800 m²/g, pore volume of about 0.1 cm³/g to about 4.0 cm³/g and average particle size of about 3 μm to about 300 μm. The surface area of the support material can be of about 50 m²/g to about 500 m²/g, pore volume of about 0.5 cm³/g to about 3.5 cm³/g and average particle size of about 10 μm to about 200 μm. For example, the surface area of the support material can be about 100 m²/g to about 400 m² g, pore volume of about 0.8 cm³/g to about 3.0 cm³/g and average particle size can be about 5 μm to about 100 μm. The average pore size of the support material useful in the present disclosure can be of about 50 Å to about 1000 Å, such as about 60 Å to about 500 Å, and such as about 75 Å to about 350 Å. In at least one embodiment, the support material is a high surface area, amorphous silica (e.g., surface area about 300 m²/gm; pore volume of about 1.65 cm³/gm). For example, suitable silicas can be the silicas marketed under the tradenames of DAVISON™ 952 or DAVISON™ 955 (Davison Chemical Division of W.R. Grace and Company). In other embodiments, DAVISON™ 948 is used. Alternatively, a silica can be ES-70, ES70X, ES757, PD17062, PD16042, PD16043, or PD14024 silica (Ecovyst, formerly PQ Corporation, Malvern, Pennsylvania), DM L403, DM-L303, D60-120A, D150-60A (AGC Chemicals Company, Japan), CARiACT G-10, P-10, P-6, or Q-10 silica (Fuji Silysia Chemical LTD), Sipernat 310, or Sipernat 50 (Evonik) that has been calcined, for example, at 200° C., 400° C., 600° C., or 875° C.

The support material should be dry, that is, free or substantially free of absorbed water for pre-formed MAO supportation but can be uncalcined for in-situ MAO supportation when water is used as the oxygen source. The amount of pore surface hydroxyl groups of the support material can be controlled by heating or calcining at different temperatures, e.g., about 100° C. to about 1000° C., such as at least about 600° C. When the support material is silica, it is heated to at least about 150° C., such as about 200° C. to about 850° C., and such as at about 400° C.-600° C.; and for a time of about 30 minutes to about 100 hours, about 4 hours to about 72 hours, or about 24 hours to about 60 hours. The calcined support material must have at least some reactive hydroxyl (OH) groups to produce supported catalyst systems of the present disclosure.

### Non-Coordinated Alkylaluminum-Free Supported Ionic Alumoxanes and the Derived Finished Catalyst Formation

In embodiments herein, the catalyst system may include a support material as described above. For example, a support material can be contacted with a pre-formed solution alumoxane, e.g., a commercial solution MAO, to form the supported MAO, followed by contacting the supported MAO with a monodentate agent (e.g., a silanol SiR₃OH or the silanol derived SiR₃OAlR₂ compound) with optional AlR₃ or a chelating agent (e.g., a polysiloxane such as OMTS) to form the monodentate or chelating ligand stabilized dialkylaluminum cation in-situ or a pre-formed monodentate agent (e.g., a dialkylaluminumsiloxide) of the present disclosure (e.g., A of FIG. 1, B of FIG. 1 and FIG. 2), following a process of free alkylaluminum separation process, such as a filtration process, a decantation process, or in the low boiling point free alkylaluminum case (such as in the free TMA case), a vacuum evacuation process to remove free alkylaluminum such as free TMA. To increase the activation efficiency of the chelating species A of FIG. 1 from a chelating agent, a heating process may be applied to convert at least a portion of the chelating species A of FIG. 1 to monodentate species B of FIG. 1. For example, 20 mol % of species A, 40 mol % of species A, or >70 mol % of species A, or to undetectable of species A.

Alternatively, a support material can be contacted with a non-coordinated alkylaluminum fee alumoxane (e.g., non-coordinated TMA free ionic MAO) of the present disclosure to form a supported activator followed by contacting the supported activator with a pre-catalyst compound.

Alternatively, a pre-catalyst compound is contacted with a non-coordinated TMA free MAO to form a solution catalyst system followed by contacting the solution catalyst system with a support material to form a supported catalyst system.

Alternatively, a support material can be loaded with an oxygen source, e.g., water, followed by adding the oxygen source loaded support, in a solid form or slurry for, with or without cooling, to a cold TMA solution with optional heating to form the supported MAO composition, and then followed by the treatment of a chelating agent with optional AlR₃ and a free alkylaluminum separation process such as filtration, decantation, or in the free TMA case, a vacuum evacuation process to remove free TMA to form the coordinated alkylaluminum supported alkylaluminoxane system before contacting a pre-catalyst to form the finished catalyst.

Alternatively, a support material can be loaded with an oxygen source, e.g., water, followed by adding the oxygen source loaded support, in a solid form or slurry for, with or without cooling, to a cold TMA solution with optional heating to form the supported MAO composition, and then followed by the treatment of either an in-situ formed monodentate SiR₃OAlR₂ compound through contacting the supported MAO with a silanol SiR₃OH with optional AlR₃ and optional filtration/wash process or a pre-formed monodentate SiR₃OAlR₂ compound with necessary filtration/wash process to form the non-coordinated TMA free supported MAO before contacting a pre-catalyst to form the finished catalyst.

The support material, having reactive surface groups, such as hydroxyl groups, as a non-polar solvent slurry or as a solid depending on the specific process, is brought into contact with at least one pre-catalyst compound in solid form or solution form and the MAO based activator in any sequence including the sequences mentioned above, provided that, if a pre-catalyst has non-leaving hetero-atom donor (e.g., O and/or N), should be brought into contact with the MAO based activator after the MAO is converted to non-coordinated TMA free ionic MAO. In at least one embodiment, the support material is first contacted with the pre-formed activator solution (e.g., regular MAO or non-coordinated TMA free ionic MAO) for a period of time of about 0.5 hour to about 24 hours, about 2 hours to about 16 hours, or about 4 hours to about 8 hours. In the regular MAO supportation case, the supported regular MAO is then converted to non-coordinated TMA free supported ionic MAO with methods described above. The solution or solid form of the pre-catalyst compound is then contacted with the non-coordinated TMA free supported activator. In at least one embodiment, the supported MAO for the catalyst system is generated in-situ. In alternate embodiments, the slurry of the non-coordinated TMA free supported MAO is contacted with the pre-catalyst compound for a period of time of about 0.5 hour to about 24 hours, about 1 hour to about 16 hours, or about 2 hours to about 8 hours. In more alternate embodiments, the pre-formed non-coordinated TMA free ionic MAO solution is first mixed with at least one pre-catalyst before contacting the support material, either with a slurry preparation process or an incipient wetness preparation process.

The mixture of the catalyst(s), activator(s) and support is agitated at about 0° C. to about 100° C., such as about 23° C. to about 60° C., such as at room temperature. Contact times can be about 0.5 hour to about 24 hours, such as about 2 hours to about 16 hours, or about 4 hours to about 8 hours. The insolubles (insoluble silica, supported MAO, activated pre-catalyst, and additive(s)) to solvent ratio can be any practical ratio, such as 3 to 97, 10:90, 30:70, 50:50 (wt:wt), depending on a specific process in use. For example, for a continuing process, a lower insolubles:solvent ratio such as 3:97, 1:99, or lower, can be used; for an incipient wetness process, a higher insolubles:solvent ratio such as 60:40 or higher can be used.

Suitable non-polar diluents are materials in which all of the reactants used herein, e.g., the activator and the pre-catalyst compound, are at least partially soluble and which are liquid at reaction temperatures. Non-polar diluents for in-situ MAO supportation can be alkanes, such as isopentane, hexane, isohexane, n-heptane, octane, nonane, and decane, although a variety of other materials including cycloalkanes, such as cyclohexane, aromatics, such as benzene, toluene, and ethylbenzene, may also be employed, whereas for pre-formed MAO supportation, aromatics, such as benzene, toluene, and ethylbenzene, can be used.

In at least one embodiment, the supported activator is a supported non-coordinated TMA free ionic MAO, which is a silica (e.g., ES70 silica calcined at 400° C.) supported MAO free of or low in free TMA after the free TMA is removed either physically, e.g., by phase cut, filtration/decantation, or vacuum evacuation, or chemically, e.g., by reacting with a silanol.

Embodiments of the present disclosure include methods for preparing a finished catalyst system including contacting in an organic diluent the non-coordinated TMA free solid MAO or supported MAO with at least one pre-catalyst compound having a Group 3 through Group 12 metal atom or lanthanide metal atom.

In at least one embodiment, the non-coordinated TMA free solid MAO or supported MAO is heated prior to contact with the pre-catalyst compound. In at least one embodiment, the solid MAO or supported MAO is heated after contact with the pre-catalyst compound.

### Solution Catalyst Formation

Embodiments of the present disclosure include methods for preparing a solution or homogeneous catalyst system including contacting in an organic diluent the non-coordinated TMA free ionic liquid MAO (TF-iMAO) with at least one pre-catalyst compound having a Group 3 through Group 12 metal atom or lanthanide metal atom.

In at least one embodiment, the TF-iMAO is heated, e.g., at 50° C. to 120° C., at 80° C.-110° C., or at 90° C.-100° C., for 0.5 hour to 24 hours, for 1-10 hours, or for 2-5 hours, prior to contact with the pre-catalyst compound.

The TF-iMAO can be solvated in an organic diluent and the resulting mixture is contacted with a solution of at least one pre-catalyst compound. The pre-catalyst compound can also be added as a solid to the mixture of the organic diluent and the TF-iMAO. In at least one embodiment, the mixture of the TF-iMAO is contacted with the pre-catalyst compound for a period of time of about 0.02 hours to about 24 hours, such as about 0.1 hour to about 1 hour, about 0.2 hour to about 0.6 hour, about 2 hours to about 16 hours, or about 4 hours to about 8 hours before contacting the olefin monomer(s) for polymerization.

The mixture of the pre-catalyst compound and the TF-iMAO may be heated to a temperature of about 0° C. to about 70° C., such as about 23° C. to about 60° C., for example room temperature before contacting the olefin monomer(s) for polymerization.

Suitable organic diluents are materials in which some or all of the reactants used herein, e.g., the TF-iMAO and the pre-catalyst compound, are at least partially soluble and which are preferred to be liquid at reaction temperatures. Non-limiting example diluents are non-cyclic alkanes with formula CₙH₍₂ₙ₊₂₎ where n is 4 to 30, such as isobutane, butane, isopentane, hexane, n-heptane, octane, nonane, decane and the like, and cycloalkanes with formula CₙH₍₂ₙ₋₂₎ where n is 5 to 30, such as cyclopentane, methylcyclopentane, cyclohexane, methylcyclohexane and mixtures thereof. Aromatic diluent can include benzene, toluene, or xylenes.

The diluent can be charged into a reactor, followed by a TF-iMAO. Catalyst can then be charged into the reactor, such as a solution of catalyst in an organic diluent or as a solid. The mixture can be stirred at a temperature, such as room temperature. Additional diluent may be added to the mixture to form a mixture having a desired consistency, such as a slurry having from about 2 cc/g of silica to about 20 cc/g silica, such as about 4 cc/g. The diluent can then be removed. Removing diluent dries the mixture and may be performed under a vacuum atmosphere, purged with inert atmosphere, heating of the mixture, or combinations thereof. For heating of the mixture, any suitable temperature can be used that evaporates the aliphatic diluent. It is to be understood that reduced pressure under vacuum will lower the boiling point of the aliphatic diluent depending on the pressure of the reactor. Diluent removal temperatures can be about 10° C. to about 200° C., such as about 60° C. to about 140° C., such as about 60° C. to about 120° C., for example about 100° C. or less, such as about 90° C. or less. In at least one embodiment, removing diluent includes applying heat, applying vacuum, and applying nitrogen purged from bottom of the vessel by bubbling nitrogen through the mixture. The mixture is dried.

### Pre-Catalyst Compounds

The terms “catalyst”, “catalyst compound”, “catalyst complex”, “metal complex”, “metal compound”, “pre-catalyst compound”, and “pre-catalyst complex” are used interchangeably to describe a transition metal complex or lanthanide metal complex that forms an olefin polymerization catalyst when combined with a suitable activator.

In at least one embodiment, the present disclosure provides a catalyst system comprising a catalyst compound having a metal atom. The catalyst compound can be a metallocene catalyst compound. The metal can be a Group 3 through Group 12 metal atom, such as Group 3 through Group 10 metal atoms, or lanthanide Group atoms. The catalyst compound having a Group 3 through Group 12 metal atom can be monodentate or multidentate, such as bidentate, tridentate, or tetradentate, where a heteroatom of the catalyst, such as phosphorous, oxygen, nitrogen, or sulfur is chelated to the metal atom of the catalyst. Non-limiting examples include bis(phenolate)s. In at least one embodiment, the Group 3 through Group 12 metal atom is selected from Group 5, Group 6, Group 8, or Group 10 metal atoms. In at least one embodiment, a Group 3 through Group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from Groups 4, 5, and 6 metal atoms. In at least one embodiment, a metal atom is a Group 4 metal atom selected from Ti, Zr, or Hf. The oxidation state of the metal atom can range from 0 to +7, for example +1, +2, +3, +4, or +5, for example +2, +3 or +4. A catalyst compound of the present disclosure can be a rhenium or rhenium-based catalyst, a scandium or scandium based catalyst, or a chromium or chromium-based catalyst.

Chromium-based catalysts include chromium oxide (CrO₃) and silylchromate catalysts. Chromium catalysts have been the subject of much development in the area of continuous fluidized-bed gas-phase polymerization for the production of polyethylene polymers. Such catalysts and polymerization processes have been described, for example, in U.S. Patent Application Publication No. 2011/0010938 and U.S. Pat. Nos. 7,915,357, 8,129,484, 7,202,313, 6,833,417, 6,841,630, 6,989,344, 7,504,463, 7,563,851, 8,420,754, and 8,101,691.

Mono-Cp catalyst precursor compounds useful in the present disclosure have one cyclopentadienyl (Cp) ligand (which includes ligands that are isolobal to cyclopentadienyl) and at least one polar atom in at least one non-Cp ligand, bridging or unbridging to the Cp ligand, directly bonded to the pre-catalyst metal center.

In at least one embodiment, the mono-Cp pre-catalyst compound of the present disclosure is represented by formula (MC-I):

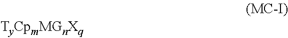

where Cp is independently a substituted or unsubstituted cyclopentadienyl ligand or substituted or unsubstituted ligand isolobal to cyclopentadienyl such as indenyl, fluorenyl, tetrahydro-s-indacenyl and tetrahydro-as-indecenyl. M is a group 4 transition metal, such as Hf, Ti, or Zr. G is a heteroatom group represented by the formula JR*_{z} where J is N, P, O or S, and R* is a linear, branched, or cyclic C₁-C₂₀ hydrocarbyl. z is 1 or 2. T is a bridging group. y is 0 or 1. X is a leaving group. m=1, n=1, 2 or 3, q=0, 1, 2 or 3, and the sum of m+n+q is equal to the oxidation state of the transition metal, such as 2, 3 or 4, such as 4.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof. Exemplary JR*_{z} groups include t-butyl amido and cyclododecylamido.

Examples of the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. In at least one embodiment, Tis represented by the formula ER^{d}₂ or (ER^{d}₂)₂, where E is C, Si, or Ge, and each R^{d} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, or two R^{d} can form a cyclic structure including aromatic, partially saturated, or saturated cyclic or fused ring system.

Each X is independently selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, (two Xs may form a part of a fused ring or a ring system), such as each X is independently selected from halides, aryls and C₁ to C₅ alkyl groups, such as each X is a phenyl, methyl, ethyl, propyl, butyl, pentyl, or chloro group.

In at least one embodiment, the mono-Cp catalyst precursor compound of formula (MC-1) is selected from:
dimethylsilandiyl (2,3,4,5-tetramethylcyclopentadienyl)(cyclododecylamido)M(R)₂;
dimethylsilandiyl (2,3,4,5-tetramethylcyclopentadienyl)(cycloundecylamido)M(R)₂;
dimethylsilandiyl (2,3,4,5-tetramethylcyclopentadienylXcyclodecylamido)M(R)₂;
dimethylsilandiyl (2,3,4,5-tetramethylcyclopentadienyl)(t-butylamido)M(R)₂;
dimethylsilandiyl (cyclopentadienyl)(1-adamantylamido)M(R)₂;
dimethylsilandiyl (3-tertbutylcyclopentadienyl)(1-adamantylamido)M(R)₂;
dimethylsilandiyl (tetramethylcyclopentadienyl)(1-adamantylamido)M(R)₂;
dimethylsilandiyl (tetramethylcyclopentadienyl)(1-adamantylamido)M(R)₂;
dimethylsilandiyl (tetramethylcyclopentadienyl)(1-adamantylamido)M(R)₂;
dimethylsilandiyl (tetramethylcyclopentadienyl)(1-tertbutylamido)M(R)₂;
dimethylsilandiyl (fluorenyl)(1-tertbutylamido)M(R)₂;
dimethylsilandiyl (tetramethylcyclopentadienyl)(1-cyclododecylamido)M(R)₂;
μ-(C₆H₅)₂C(tetramethylcyclopentadienyl)(1-cyclododecylamido)M(R)₂;
dimethylsilandiyl (η⁵-2,6,6-trimethyl-1,5,6,7-tetrahydro-s-indacen-1-yl)(tertbutylamido)M(R)₂;
   where M is selected from Ti, Zr, and Hf; and each R is selected from halogen or C₁ to C₅ alkyl (such as chloro, bromo, methyl, ethyl, propyl, butyl, pentyl or isomers thereof). In at least one embodiment, M is Ti and each R is methyl.

Mono-Cp pre-catalyst compounds of the present disclosure may be synthesized as described in U.S. Pat. Nos. 5,621,126 and 5,547,675 which are incorporated herein by reference.

The mono-Cp pre-catalyst compounds can also include compounds having the structure represented by formula (MC-II) preferably having Cₛ or pseudo-Cₛ symmetry:

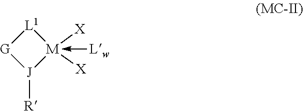

wherein:
M is zirconium;
L¹ is a unsubstituted fluorenyl, heterocyclopentapentalenyl, or heterofluorenyl, or a substituted fluorenyl, heterocyclopentapentalenyl, or heterofluorenyl ligand with one or more symmetric or pseudo symmetric substituents, each substituent group being, independently, a radical group which is a hydrocarbyl, substituted hydrocarbyl, halocarbyl, substituted halocarbyl, silylcarbyl or germylcarbyl, and optionally two or more adjacent substituents may join to form a substituted or unsubstituted, saturated, partially unsaturated or aromatic, cyclic or polycyclic substituent;
G is a bridging group;
J is a heteroatom from group 15, such as N or P, such as N;
R′ is a radical group which is a hydrocarbyl, substituted hydrocarbyl, halocarbyl, or substituted halocarbyl;
L′ is a neutral Lewis base and w represents the number of L′ bonded to M where w is 0, 1, or 2, and optionally any L′ and any X may be bonded to one another;
X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

In formula (MC-II), L¹ is fluorenyl or substituted fluorenyl, such as fluorenyl, 2,7-dimethylfluorenyl, 2,7-diethylfluorenyl, 2,7-dipropylfluorenyl, 2,7-dibutylfluorenyl, 2,7-diphenylfluorenyl, 2,7-dichlorofluorenyl, 2,7-dibromofluorenyl, 3,6-dimethylfluorenyl, 3,6-diethylfluorenyl, 3,6-dipropylfluorenyl, 3,6-dibutylfluorenyl, 3,6-diphenylfluorenyl, 3,6-dichlorofluorenyl, 3,6-dibromofluorenyl or 1,1,4,4,7,7,10,10-octamethyl-octahydrodibenzofluorenyl, such as fluorenyl, 2,7-dimethylfluorenyl, 2,7-diethylfluorenyl, 2,7-dipropylfluorenyl, 2,7-dibutylfluorenyl, 3,6-dimethylfluorenyl, 3,6-diethylfluorenyl, 3,6-dipropylfluorenyl, 3,6-dibutylfluorenyl, or 1,1,4,4,7,7,10,10-octamethyl-octahydrodibenzofluorenyl, such as 2,7-di-tert-butyifluorenyl, 3,6-di-tert-butylfluorenyl, 1,1,4,4,7,7,10,10-octamethyl-octahydrodibenzofluorenyl, or fluorenyl. G is methylene, dimethylmethylene, diphenylmethylene, dimethylsilylene, methylphenylsilylene, diphenylsilylene, di(4-triethylsilylphenyl)silylene, ethylene, such as diphenylmethylene, diphenylsilylene, methylphenylsilylene, and dimethylsilylene; such as dimethylsilylene. Suitable J can be nitrogen. R′ is hydrocarbyl or halocarbyl, such as C₃-C₂₀ hydrocarbyl, such as all isomers (including cyclics and polycyclics) of propyl, butyl, pentyl, hexyl, heptyl, octyl, nonyl, decyl, undecyl, dodecyl, benzyl, phenyl and substituted phenyl, such as tert-butyl, neopentyl, benzyl, phenyl, diisopropylphenyl, adamantyl, norbornyl, cyclohexyl, cyclooctyl, cyclodecyl, and cyclododecyl, such as tert-butyl, adamant-1-yl, norborn-2-yl, cyclohexyl, cyclooctyl, and cyclododecyl. X is hydrocarbyl or halo, such as methyl, benzyl, floro or chloro, such as methyl or chloro; w is zero (L′ being absent), M is zirconium.

Examples of Mono-Cp catalyst compounds with polar donor(s) include but are not limited to:

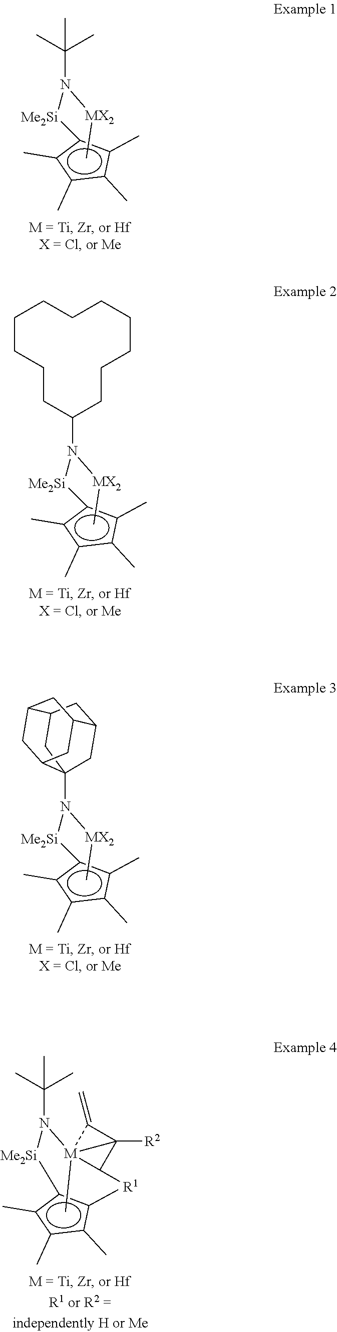

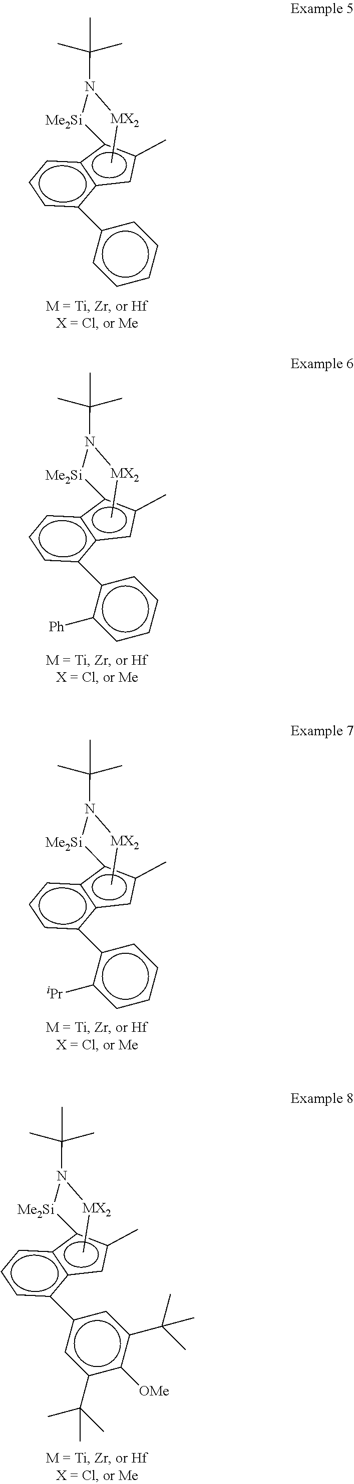

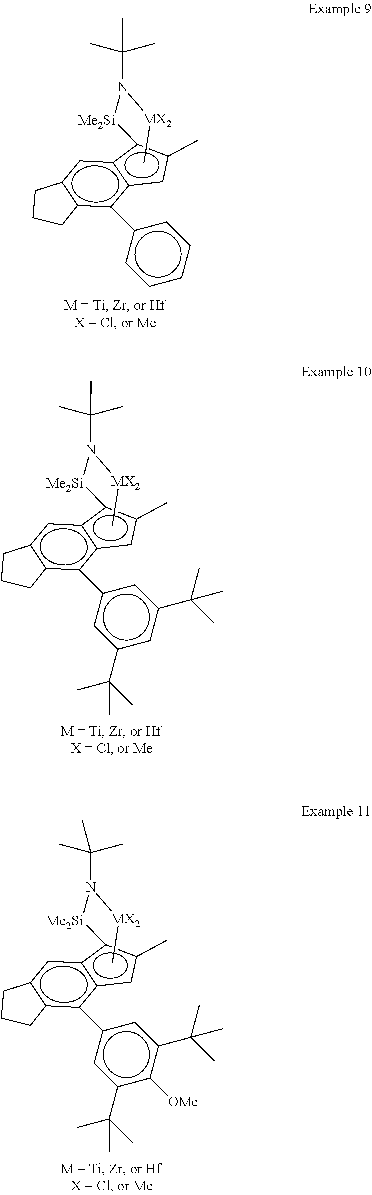

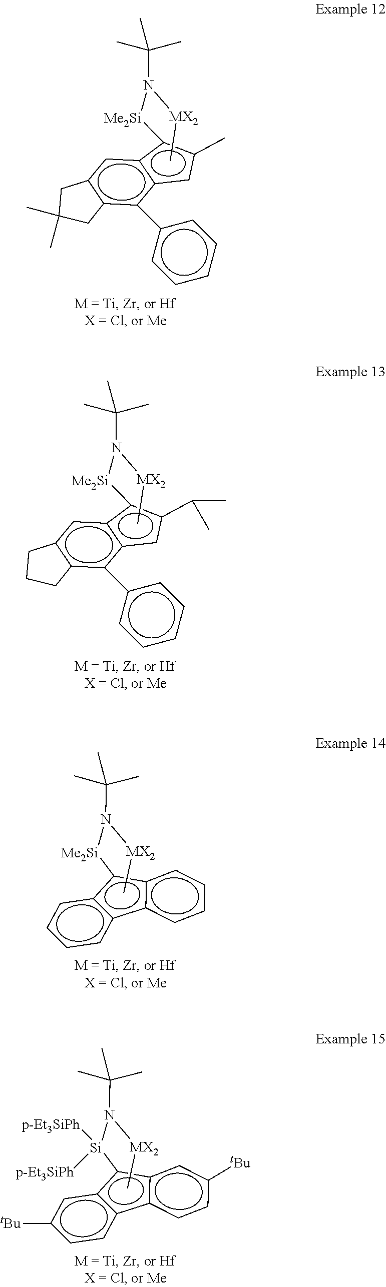

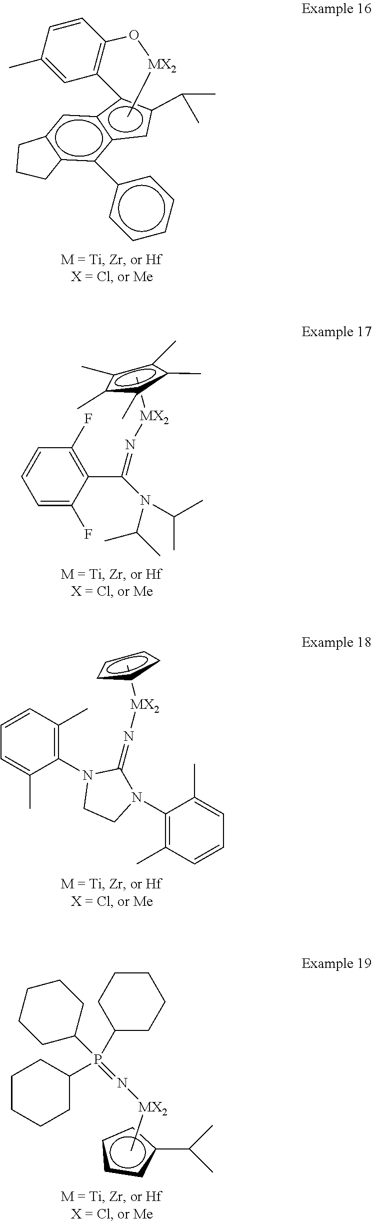

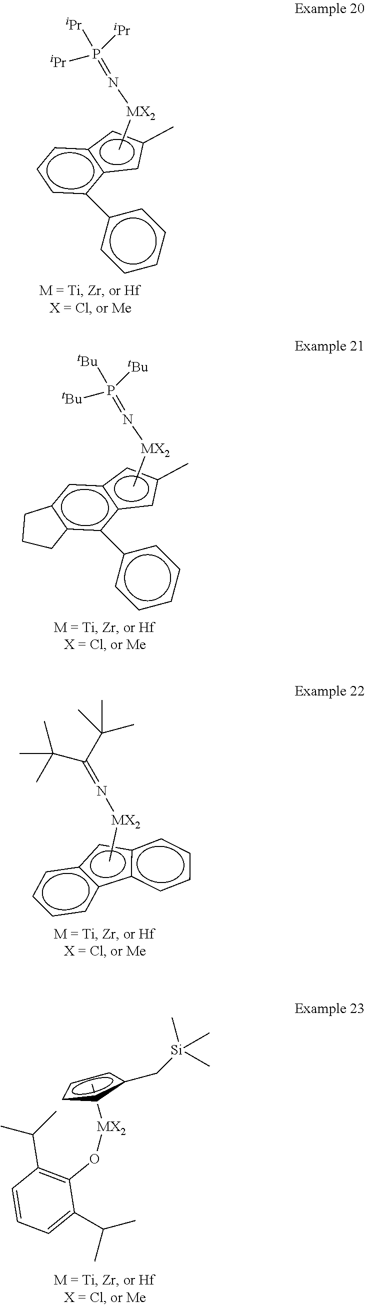

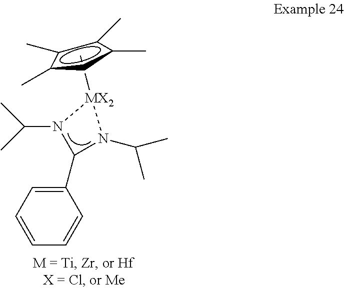

The mono-metallocene pre-catalyst compound may also be selected from:
dimethylsilyl (tetramethylcyclopentadienyl)(cyclododecylamido)titanium dimethyl;
dimethylsilyl (tetramethylcyclopentadienyl)(cyclododecylamido)titanium dichloride,
dimethylsilyl (tetramethylcyclopentadienyl)(t-butylamido)titanium dimethyl;
dimethylsilyl (tetramethylcyclopentadienyl)(t-butylamido)titanium dichloride;
   where M is selected from Ti, Zr, and Hf; and R is selected from halogen or C₁ to C₅ alkyl.

In some embodiments, pre-catalysts of the present disclosure can be “post-metallocene” catalysts having an oxygen and/or nitrogen atom(s). For example, a catalyst of the present disclosure can be a metal complex having: a metal selected from groups 3-10 or lanthanide metals, and a tridentate, mono- or di-anionic ligand containing one or two anionic donor groups and two or one a neutral Lewis base donor, where the one or two neutral Lewis base donors is covalently bonded between the two anionic donors, and where the metal-ligand complex features a pair of 4-, 5-, 6-, 7-, or 8-membered metallocycle rings or a pair of mixed membered metallocycle rings, such as a mix of 4- and 5-membered rings, a mix of 5- and 6-membered rings, a mix of 6- and 7-membered rings, a mix of 5- and 7-membered rings, or a mix of 7- and -8 membered rings.

The catalyst complexes of the present disclosure include a metal selected from groups 3-10 or lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. In some embodiments, the dianionic, tridentate ligand features a central heterocyclic donor group and two phenolate donors and the tridentate ligand coordinates to the metal center to form two eight-membered rings.

In some embodiments, the heterocyclic Lewis base donor of the catalyst compound features a nitrogen or oxygen donor atom. For example, heterocyclic groups include derivatives of pyridine, pyrazine, pyrimidine, triazine, thiazole, imidazole, thiophene, oxazole, thiazole, furan, and substituted variants of thereof. In some embodiments, the heterocyclic Lewis base lacks hydrogen(s) in the position alpha to the donor atom. In some embodiments, a heterocyclic Lewis base donor includes pyridine, 3-substituted pyridines, and 4-substituted pyridines.

The anionic donors of the tridentate dianionic ligand may be arylthiolates, phenolates, or anilides. In some embodiments, anionic donors are phenolates. The tridentate dianionic ligand coordinates to the metal center to form a complex that may lack a mirror plane of symmetry. In some embodiments, the tridentate dianionic ligand coordinates to the metal center to form a complex that has a two-fold rotation axis of symmetry; when determining the symmetry of the bis(phenolate) complexes only the metal and dianionic tridentate ligand are considered (i.e., ignore remaining ligands).

Catalyst compounds of the present disclosure can be bis(aryl phenolate)pyridine complexes. Bis(aryl phenolate)pyridine complexes may have a tridentate bis(aryl phenolate)pyridine ligand that is coordinated to a group 4 transition metal with the formation of two eight-membered rings. In some embodiments, a bis(aryl phenolate)pyridine complexes includes transition metal complexes of a dianionic, tridentate ligand that features a central neutral donor group and two phenolate donors, where the tridentate ligands coordinate to the metal center to form two eight-membered rings, for example, the post-metallocene catalyst can be an 8-8 catalyst. In complexes of this type, it is advantageous for the central neutral donor to be a heterocyclic group. It is advantageous for the heterocyclic group to lack hydrogens in the position alpha to the heteroatom. In complexes of this type, it may also be advantageous for the phenolates to be substituted with one or more cyclic tertiary alkyl substituents. The use of cyclic tertiary alkyl substituted phenolates can improve the ability of these catalysts to produce high molecular weight polymer.

In some embodiments, bis(phenolate) ligands can be tridentate dianionic ligands that coordinate to the metal M in such a fashion that a pair of 8-membered metallocycle rings are formed. The bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins, particularly isotactic poly(alpha olefins). If the ligands were coordinated to the metal in such a manner that the complex had mirror-plane (Cₛ) symmetry, then the catalyst would be expected to produce only atactic poly(alpha olefins); these symmetry-reactivity concepts are summarized by Golisz, S. R. et al. (2009) “Synthesis of Early Transition Metal Bisphenolate Complexes and Their Use as Olefin Polymerization Catalysts,” Macromolecules, v.42(22), pp. 8751-8762. The pair of 8-membered metallocycle rings of the catalyst compounds is also a notable feature that is advantageous for temperature stability, and isoselectivity of monomer enchainment. Related group 4 complexes featuring smaller 6-membered metallocycle rings are known (Macromolecules (2009), v.42, pp. 8751-8762) to form mixtures of C₂ and Cₛ symmetric complexes when used in olefin polymerizations and are thus not well suited to the production of highly isotactic poly(alpha olefins).

Bis(phenolate) ligands that contain oxygen donor groups (i.e., E=E′=oxygen of Formula (PM-I)) can be substituted with alkyl, substituted alkyl, aryl, or other groups. It can be advantageous that each phenolate group be substituted in the ring position that is adjacent to the oxygen donor atom. For example, that substitution at the position adjacent to the oxygen donor atom can be an alkyl group containing 1-20 carbon atoms. The substitution at the position next to the oxygen donor atom can be a non-aromatic cyclic alkyl group with one or more five- or six-membered rings. Substitution at the position next to the oxygen donor atom can be a cyclic tertiary alkyl group. In some embodiments, substitution at the position next to the oxygen donor atom is adamantan-1-yl or substituted adamantan-1-yl.

The neutral heterocyclic Lewis base donor is covalently bonded between the two anionic donors (e.g., between two phenolate groups) via “linker groups” that join the heterocyclic Lewis base to the anionic donors. The “linker groups” are indicated by (A³A²) and (A^{2′}A^{3′}) in Formula (PM-I). The choice of each linker group may affect the catalyst performance, such as the tacticity of the poly(alpha olefin) produced. Each linker group can be a C₂-C₄₀ divalent group that is two-atoms in length. One or both linker groups may independently be phenylene, substituted phenylene, heteroaryl, vinylene, or a non-cyclic two-carbon long linker group. When one or both linker groups are phenylene, the alkyl substituents on the phenylene group may be chosen to optimize catalyst performance. Typically, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments, a catalyst compound is represented by Formula (PM-I):

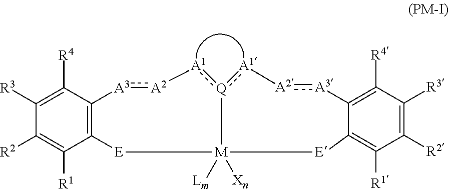

wherein:
M is a group 3, 4, 5, 6, or 7 transition metal or a lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, such as O, such as both E and E′ are O;
Q is group 14, 15, or 16 atom that forms a dative bond to metal M, such as Q is C, O, S or N, such as Q is C, N, or O, such as Q is N;
A¹QA^{1′} are part of a heterocyclic Lewis base containing 4 to 40 non-hydrogen atoms that links A² to A^{2′} via a 3-atom bridge with Q being the central atom of the 3-atom bridge (A¹QA^{1′} combined with the curved line joining A¹ and A^{1′} represents the heterocyclic Lewis base);
each of A¹ and A^{1′} are independently C, N, or C(R²²), where R²² is selected from hydrogen, C₁-C₂₀ hydrocarbyl, and C₁-C₂₀ substituted hydrocarbyl (for example, each of A¹ and A^{1′} are C);

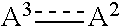

is a divalent group containing 2 to 40 non-hydrogen atoms that links A¹ to the E-bonded aryl group via a 2-atom bridge, such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, such as

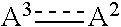

is a divalent hydrocarbyl group;

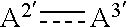

is a divalent group containing 2 to 40 non-hydrogen atoms that links A^{1′} to the E′-bonded aryl group via a 2-atom bridge such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, such as

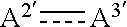

is a divalent hydrocarbyl group;
each L is independently a Lewis base;
each X is independently an anionic ligand;
nis 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group (such as R^{1′} and R¹ are independently a cyclic group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group; and
any two X groups may be joined together to form a dianionic ligand group.

The metal, M, is selected from group 3, 4, 5, 6, or 7 elements, such as group 4. For example, the metal, M, is zirconium or hafnium.

The donor atom Q of the neutral heterocyclic Lewis base (in Formula (PM-1)) can be nitrogen, carbon, or oxygen. In some embodiments, Q is nitrogen.

Non-limiting examples of neutral heterocyclic Lewis base groups include derivatives of pyridine, pyrazine, pyrimidine, triazine, thiazole, imidazole, thiophene, oxazole, thiazole, furan, and substituted variants of thereof. Heterocyclic Lewis base groups can include derivatives of pyridine, pyrazine, thiazole, and imidazole.

Each of A¹ and A^{1′} of the heterocyclic Lewis base (of Formula (PM-I)) is independently C, N, or C(R²²), where R²² is selected from hydrogen, C₁-C₂₀ hydrocarbyl, and C₁-C₂₀ substituted hydrocarbyl. In some embodiments, each of A¹ and A^{1′} is carbon. When Q is carbon, each of A¹ and A^{1′} can be selected from nitrogen and C(R²²). When Q is nitrogen, each of A¹ and A^{1′} can be carbon. In some embodiments, Q=nitrogen and A¹=Ar^{1′}=carbon. When Q is nitrogen or oxygen, the heterocyclic Lewis base of Formula (PM-I) might not have any hydrogen atoms bound to the A¹ or A^{1′} atoms, which may be preferred because it is thought that hydrogens in those positions may undergo unwanted decomposition reactions that reduce the stability of the catalytically active species.

The heterocyclic Lewis base (of Formula (PM-I)) represented by A¹QA^{1′} combined with the curved line joining A¹ and A^{1′} can be selected from the following, with each R²³ group selected from hydrogen, heteroatoms, C₁-C₂₀ alkyls, C₁-C₂₀ alkoxides, C₁-C₂₀ amides, and C₁-C₂₀ substituted alkyls.

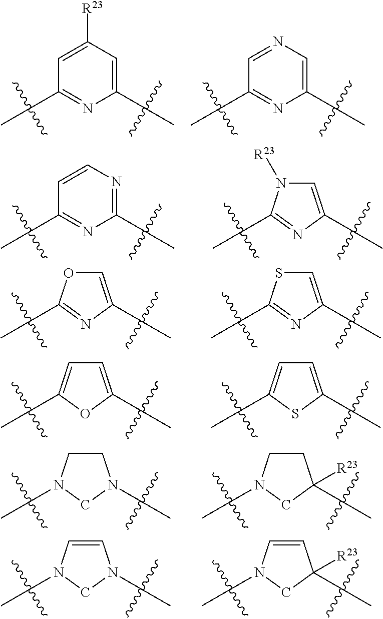

In some embodiments, the heterocyclic Lewis base (of Formula (PM-I)) represented by A¹QA^{1′} combined with the curved line joining A¹ and A^{1′} is a six membered ring containing zero or one ring heteroatoms or a five membered ring containing zero, one two or three ring heteroatoms. Alternately, the heterocyclic Lewis base (of Formula (PM-I)) represented by A¹QA^{1′} combined with the curved line joining A¹ and A^{1′} is not a six membered ring containing two or more ring heteroatoms.

In some embodiments of Formula (PM-I), Q is C, N or O, such as Q is N.

In some embodiments of Formula (PM-I), each of A¹ and A^{1′} is independently carbon, nitrogen, or C(R²²), with R²² selected from hydrogen, C₁-C₂₀ hydrocarbyl, substituted C₁-C₂₀ hydrocarbyl. In some embodiments, each of A¹ and A^{1′} is carbon.

In some embodiments of Formula (PM-1), A¹QA^{1′} of Formula (PM-I) is part of a heterocyclic Lewis base, such as a pyridine, pyrazine, pyrimidine, triazine, thiazole, imidazole, thiophene, oxazole, thiazole, furan, or a substituted variant of thereof.

In some embodiments of Formula (PM-I), A¹QA^{1′} are part of a heterocyclic Lewis base containing 2 to 20 non-hydrogen atoms that links A² to A^{2′} via a 3-atom bridge with Q being the central atom of the 3-atom bridge. In some embodiments, each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In at least one embodiment of Formula (PM-I), Q is carbon and each of A¹ and A^{1′} is N or C(R²²), where R²² is selected from hydrogen, C₁-C₂₀ hydrocarbyl, substituted C₁-C₂₀ hydrocarbyl, a heteroatom or a heteroatom-containing group. In such embodiments, the A¹QA^{1′} fragment forms part of a cyclic carbene, N-heterocyclic carbene, cyclic amino alkyl carbene, or a substituted variant thereof.

In some embodiments of Formula (PM-I),

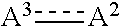

is a divalent group containing 2 to 20 non-hydrogen atoms that links A¹ to the E-bonded aryl group via a 2-atom bridge, where the

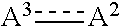

is a linear alkyl or forms part of a cyclic group (such as an optionally substituted ortho-phenylene group, or ortho-arylene group) or a substituted variant thereof.

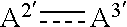

is a divalent group containing 2 to 20 non-hydrogen atoms that links A^{1′} to the E′-bonded aryl group via a 2-atom bridge, where the

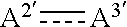

is a linear alky or forms part of a cyclic group (such as an optionally substituted ortho-phenylene group, or ortho-arylene group or, or a substituted variant thereof.

In some embodiments of Formula (PM-I), M is Zr or Hf, Q is nitrogen, both A¹ and A^{1′} are carbon, both E and E′ are oxygen, and both R¹ and R^{1′} are C₄-C₂₀ cyclic tertiary alkyls.

In some embodiments of Formula (PM-I), M is Zr or Hf, Q is nitrogen, both A¹ and A^{1′} are carbon, both E and E′ are oxygen, and both R¹ and R^{1′} are adamantan-1-yl or substituted adamantan-1-yl.

In some embodiments of Formula (PM-I), M is Zr or Hf, Q is nitrogen, both A¹ and A^{1′} are carbon, both E and E′ are oxygen, and both R¹ and R^{1′} are C₆-C₂₀ aryls.

In some embodiments, a catalyst compound is represented by Formula (PM-II):

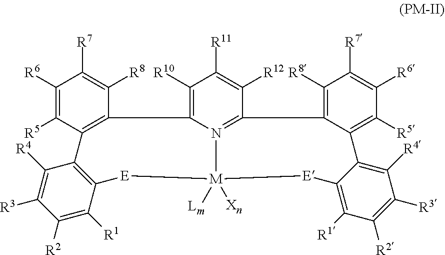

wherein:
M is a group 3, 4, 5, 6, or 7 transition metal or a lanthanide (such as a group 4 transition metal that is Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, such as O, such as both E and E′ are O;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any, two X groups may be joined together to form a dianionic ligand group;
each of R⁵, R⁶, R⁷, R⁸, R⁵′, R⁶′, R⁷′; R⁸′, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁵ and R⁶, R⁶ and R⁷, R⁷ and R⁸, R⁵′ and R⁶′, R⁶′ and R⁷′, R⁷′ and R⁸′, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In Formula (PM-I) or (PM-II). E and E′ are each selected from oxygen or NR⁹, where R⁹ is independently hydrogen, C₁-C₄₀ hydrocarbyl, C₁-C₄₀ substituted hydrocarbyl, or a heteroatom-containing group. In some embodiments, E and E′ are oxygen. When E and/or E′ are NR⁹, R⁹ can be selected from C₁ to C₂₀ hydrocarbyls, alkyls, or aryls. In one embodiment E and E′ are each selected from O, S, or N(alkyl) or N(aryl), where the alkyl can be a C₁ to C₂₀ alkyl, such as methyl, ethyl, propyl, butyl, pentyl, hexyl, octyl, nonyl, decyl, undecyl, dodecyl, and the like, and aryl is a C₆ to C₄₀ aryl group, such as phenyl, naphthalenyl, benzyl, methylphenyl, and the like.

In some embodiments,

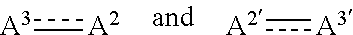

are independently a divalent hydrocarbyl group, such as C₁ to C₁₂ hydrocarbyl group.

In some embodiments of catalyst compounds of Formula (PM-I) or (PM-II), when E and E′ are oxygen, each phenolate group can be substituted in the position that is next to the oxygen atom (i.e. R¹ and R^{1′} in Formula (PM-I) and (PM-II)). Thus, when E and E′ are oxygen, each of R¹ and R^{1′} is independently a C₁-C₄₀ hydrocarbyl, a C₁-C₄₀ substituted hydrocarbyl, a heteroatom or a heteroatom-containing group, such as each of R¹ and R^{1′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (PM-I) or (PM-II), each of R¹ and R^{1′} is independently a tertiary hydrocarbyl group. In other embodiments of Formula (PM-I) or (PM-II), each of R¹ and R^{1′} is independently a cyclic tertiary hydrocarbyl group. In other embodiments of the catalyst compound of Formula (PM-I) or (PM-II), each of R¹ and R^{1′} is independently a polycyclic tertiary hydrocarbyl group.

In some embodiments of the catalyst compound of Formula (PM-I) or (PM-II), each of R¹ and R^{1′} is independently a tertiary hydrocarbyl group. In other embodiments of the catalyst compound of Formula (PM-I) or (PM-II), each of R¹ and R^{1′} is independently a cyclic tertiary hydrocarbyl group. In other embodiments of the catalyst compound of Formula (PM-I) or (PM-II), each of R¹ and R^{1′} is independently a polycyclic tertiary hydrocarbyl group.

The linker groups (i.e.,

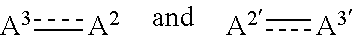

in Formula (PM-I)) can each be part of an ortho-phenylene group, such as a substituted ortho-phenylene group. It may be preferred for the R⁷ and R⁷′ positions of Formula (PM-II) to be hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc. For applications targeting polymers with high tacticity, it may be preferred for the R⁷ and R⁷′ positions of Formula (PM-II) to be a C₁ to C₂₀ alkyl, such as for both R⁷ and R⁷′ to be a C₁ to C₃ alkyl.

In some embodiments of Formula (PM-I) or (PM-II), M is a group 4 metal, such as Hf or Zr.

In some embodiments of Formula (PM-I) and (PM-II), each of E and E′ is O.

In some embodiments of Formula (PM-I) and (PM-II), each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as hydrogen, methyl, ethyl, propyl, butyl, pentyl, hexyl, or an isomer thereof.

In some embodiments of Formula (PM-I) and (PM-II), each of R¹, R², R³, R⁴, R^{1′}, R^{2′}, R^{3′}, and R^{4′} is independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In some embodiments of Formula (PM-I) and (PM-II), each of R⁴ and R^{4′} is independently hydrogen or a C₁ to C₃ hydrocarbyl, such as methyl, ethyl or propyl.

In embodiments of Formula (PM-I) and (PM-II), R⁹ is hydrogen, C₁-C₄₀ hydrocarbyl, C₁-C₄₀ substituted hydrocarbyl, or a heteroatom-containing group, such as hydrogen, methyl, ethyl, propyl, butyl, pentyl, hexyl, or an isomer thereof. In some embodiments, R⁹ is C₁ to C₆ alkyl (such as methyl, ethyl, propyl, or butyl), phenyl, 2-methylphenyl, 2,6-dimethylphenyl, or 2,4,6-trimethylphenyl.

In embodiments of Formula (PM-I) and (PM-II), each X is, independently, selected from the group consisting of hydrocarbyl radicals having from 1 to 20 carbon atoms (such as alkyls or aryls), hydrides, amides, alkoxides, sulfides, phosphides, halides, alkyl sulfonates, and a combination thereof, (two or more X's may form a part of a fused ring or a ring system), such as each X is independently selected from halides, aryls, and C₁ to C₅ alkyl groups, such as each X is independently a hydrido, dimethylamido, diethylamido, methyltrimethylsilyl, neopentyl, phenyl, benzyl, methyl, ethyl, propyl, butyl, pentyl, fluoro, iodo, bromo, or chloro group.

Alternatively, each X may be, independently, a halide, a hydride, an alkyl group, or an alkenyl group.

In some embodiments of Formula (PM-I) and (PM-II), each L is a Lewis base, independently, selected from the group consisting of ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formula (PM-I) and (PM-II), each of R¹ and R^{1′} is independently cyclic tertiary alkyl groups.

In some embodiments of Formula (PM-I) and (PM-II), n is 1, 2 or 3, such as 2.

In some embodiments of Formula (PM-I) and (PM-II), m is 0, 1 or 2, such as 0.

In some embodiments of Formula (PM-I) and (PM-II), each of R¹ and R^{1′} is not hydrogen.

In some embodiments of Formula (PM-I) and (PM-II). M is Hf or Zr, each of E and E′ is O; each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; each X is, independently, selected from the group consisting of hydrocarbyl radicals having from 1 to 20 carbon atoms (such as alkyls or aryls), hydrides, amides, alkoxides, sulfides, phosphides, halides, and a combination thereof, (two or more X's may form a part of a fused ring or a ring system); each L is, independently, selected from the group consisting of ethers, thioethers, and halo carbons (two or more L's may form a part of a fused ring or a ring system).

In some embodiments of Formula (PM-II), each of R⁵, R⁶, R⁷, R⁸, R^{5′}, R^{6′}, R^{7′}, R^{8′}, R¹⁰, R¹¹ and R¹² is independently hydrogen, C₁-C₄₀ hydrocarbyl, substituted C₁-C₄₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In some embodiments of Formula (PM-II), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In some embodiments of Formula (PM-II), each of R⁵, R⁶, R⁷, R⁸, R^{5′}, R^{6′}, R^{7′}, R^{8′}, R¹⁰, R¹¹ and R¹² is independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (PM-II), M is Hf or Zr, each of E and E′ is O; each of R¹ and R^{1′} is independently a C₁-C₄₀ hydrocarbyl, a substituted C₁-C₄₀ hydrocarbyl, a heteroatom or a heteroatom-containing group;
each of R¹, R², R³, R⁴, R^{1′}, R^{2′}, R^{3′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
R⁹ is hydrogen, C₁-C₂₀ hydrocarbyl, C₁-C₂₀ substituted hydrocarbyl, or a heteroatom-containing group, such as hydrogen, methyl, ethyl, propyl, butyl, pentyl, hexyl, or an isomer thereof;
each X is, independently, selected from the group consisting of hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system);
n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, C₁-C₂₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (PM-II), M is Zr or Hf, both E and E′ are oxygen, and both R¹ and R^{1′} are C₄-C₂₀ cyclic tertiary alkyls.

In some embodiments of Formula (PM-II), M is Zr or Hf, both E and E′ are oxygen, and both R¹ and R^{1′} are adamantan-1-yl or substituted adamantan-1-yl.

In some embodiments of Formula (PM-II), M is Zr or Hf, both E and E′ are oxygen, and each of R¹, R^{1′}, R³ and R^{3′} are adamantan-1-yl or substituted adamantan-1-yl.

In some embodiments of Formula (PM-II), M is Zr or Hf, both E and E′ are oxygen, both R¹ and R^{1′} are C₄-C₂₀ cyclic tertiary alkyls, and both R⁷ and R^{7′} are C₁-C₂₀ alkyls.

In some embodiments, a catalyst compound is one or more of: dimethylzirconium[2′,2′″-(pyridine-2,6-diyl)bis(3-adamantan-1-yl)-5-(tert-butyl)-[1,1′-biphenyl]-2-olate)], dimethylhafnium[2′,2′″-(pyridine-2,6-diyl)bis(3-adamantan-1-yl)-5-(tert-butyl)-[1,1′-biphenyl]-2-olate)], dimethylzirconium[6,6′-(pyridine-2,6-diylbis(benzo[b]thiophene-3,2-diyl))bis(2-adamantan-1-yl)-4-methylphenolate)], dimethylhafnium[6,6′-(pyridine-2,6-diylbis(benzo[b]thiophene-3,2-diyl))bis(2-adamantan-1-yl)-4-methylphenolate)], dimethylzirconium[2′,2′″-(pyridine-2,6-diyl)bis(3-((3r,5r,7r)-adamantan-1-yl)-5-methyl-[1,1′-biphenyl]-2-olate)], dimethylhafnium[2′,2′″-(pyridine-2,6-diyl)bis(3-((3r,5r,7r)-adamantan-1-yl)-5-methyl-[1,1′-biphenyl]-2-olate)], dimethylzirconium[2′,2′″-(pyridine-2,6-diyl)bis(3-((3r,5r,7r)-adamantan-1-yl)-4′,5-dimethyl-[1,1′-biphenyl]-2-olate)], dimethylhafnium[2′,2′″-(pyridine-2,6-diyl)bis(3-((3r,5r,7r)-adamantan-1-yl)-4′,5-dimethyl-[1,1′-biphenyl]-2-olate)], or combinations thereof.

In some embodiments, a catalyst compound is represented by Formula (PM-III), Formula (PM-IV) or Formula (PM-V):

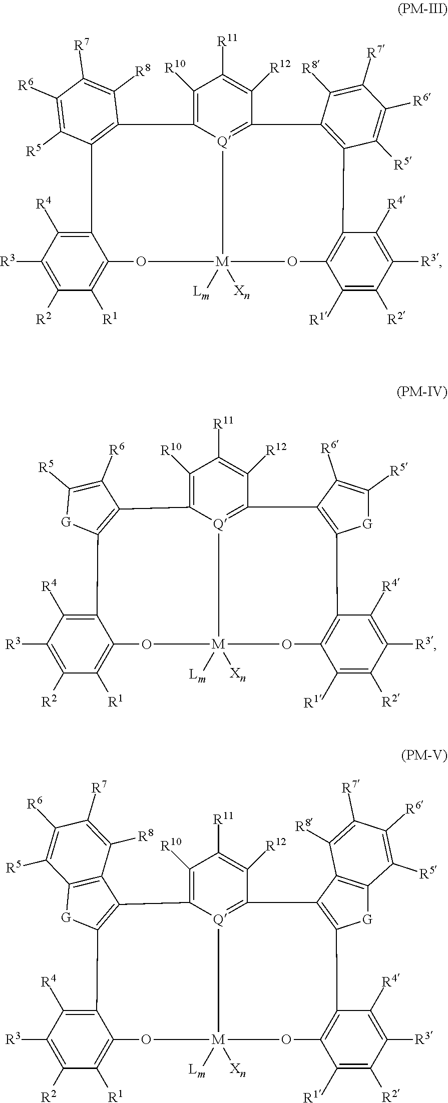

wherein:
M of Formula (PM-III), Formula (PM-IV) or Formula (PM-V) represents Sc, Y or a La—Lu lanthanide metal;
Q′ of Formula (PM-III), Formula (PM-IV) or Formula (PM-V) is a group 15 heteroatom, preferably N and P, most preferably N;
X of Formula (PM-III), Formula (PM-IV) or Formula (PM-V) is an anionic ligand; each L of Formula (PM-III), Formula (PM-IV) or Formula (PM-V) is independently a Lewis base;
any two or more L groups of Formula (PM-III), Formula (PM-IV) or Formula (PM-V) may be joined together to form a polydentate (e.g., bidentate) Lewis base;
an X group of Formula (PM-III), Formula (PM-IV) or Formula (PM-V) may be joined to an L group to form a monoanionic bidentate group;
n of Formula (PM-III), Formula (PM-IV) or Formula (PM-V) is 1;
m of Formula (PM-III), Formula (PM-IV) or Formula (PM-V) is 0, 1, or 2;
n+m of Formula (PM-III), Formula (PM-IV) or Formula (PM-V) is not greater than 3;
each of R¹, R², R³, R⁴, R^{1′}, R^{2′}, R^{3′}, and R^{4′} of Formula (PM-III), Formula (PM-IV) or Formula (PM-V) is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
each of R⁵, R⁶, R⁷, R⁸, R^{5′}, R^{6′}, R^{7′}; R^{8′}, R¹⁰, R¹¹, and R¹² of Formula (PM-III), Formula (PM-IV) or Formula (PM-V) is independently hydrogen, C₁-C₄₀ hydrocarbyl, substituted C₁-C₄₀ hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and each G of Formula (PM-III), Formula (PM-IV) or Formula (PM-V) is a group 15 or 16 heteroatom or heteroatom group such as S, O, NR′, PR′ where R′ is selected from hydrogen atoms and C₁-C₄₀ hydrocarbyl or substituted hydrocarbyl groups.

In some embodiments of catalyst compounds of Formulae (PM-I-PM-II), when E and E′ are oxygen, each phenolate group can be substituted in the position that is next to the oxygen atom (i.e. R¹ and R^{1′} in Formula (PM-I-PM-II). Thus, when E and E′ are oxygen, each of R¹ and R^{1′} is independently a C₁-C₄₀ hydrocarbyl, a substituted C₁-C₄₀ hydrocarbyl, a heteroatom, or a heteroatom-containing group, such as each of R¹ and R^{1′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of catalyst compounds of Formulae (PM-III-PM-V), each phenolate group can be substituted in the position that is next to the oxygen atom (i.e. R¹ and R^{1′} in Formula (PM-III-PM-V). Thus, each of R¹ and R^{1′} is independently a C₁-C₄₀ hydrocarbyl, a substituted C₁-C₄₀ hydrocarbyl, a heteroatom, or a heteroatom-containing group, such as each of R¹ and R^{1′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of the catalyst compound of Formulae (PM-I-PM-V), each of R¹ and R^{1′} is independently a tertiary hydrocarbyl group. In other embodiments of Formulae (PM-I-PM-V), each of R¹ and R^{1′} is independently a (substituted or unsubstituted) cyclic tertiary hydrocarbyl group. In other embodiments of the catalyst compound of Formulae (PM-I-PM-V), each of R¹ and R^{1′} is independently a (substituted or unsubstituted) polycyclic tertiary hydrocarbyl group.

In some embodiments of catalyst compounds of Formulae (PM-I-PM-II), when E and E′ are oxygen, each phenolate group can be substituted in the position that is para to the oxygen atom (i.e. R³ and R^{3′} in Formulae (PM-I-PM-II)). Thus, when E and E′ are oxygen, each of R³ and R^{3′} is independently a C₁-C₄₀ hydrocarbyl, a substituted C₁-C₄₀ hydrocarbyl, a heteroatom, or a heteroatom-containing group, such as each of R³ and R^{3′} is independently C₁-C₂₀ alkyl, such as methyl, ethyl, propyl, butyl, pentyl, hexyl, heptyl, octyl, nonyl, decyl, or an isomer thereof. Alternatively, each of R³ and R^{3′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of catalyst compounds of Formulae (PM-III-PM-V), each phenolate group can be substituted in the position that is para to the oxygen atom (i.e. R³ and R^{3′} in Formulae (PM-III-PM-V)). Thus, each of R³ and R^{3′} is independently a C₁-C₄₀ hydrocarbyl, a substituted C₁-C₄₀ hydrocarbyl, a heteroatom, or a heteroatom-containing group, such as each of R³ and R^{3′} is independently C₁-C₂₀ alkyl, such as methyl, ethyl, propyl, butyl, pentyl, hexyl, heptyl, octyl, nonyl, decyl, or an isomer thereof. Alternatively, each of R³ and R^{3′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of the catalyst compound of Formulae (PM-I-PM-V), each of R³ and R^{3′} is independently a (substituted or unsubstituted) C₁-C₂₀ alkyl, such as methyl, ethyl, propyl, butyl, pentyl, hexyl, heptyl, octyl, nonyl, decyl, or isomers thereof. In some embodiments of the catalyst compound of Formulae (PM-I-PM-V), each of R³ and R^{3′} is independently a (substituted or unsubstituted) acyclic tertiary hydrocarbyl group. In other embodiments of Formulae (PM-I-PM-V), each of R³ and R^{3′} is independently a tert-butyl.

In some embodiments, one or more of R¹, R², R³, R⁴, R^{1′}, R^{2′}, R^{3′}, R^{4′}, R⁵, R⁶, R⁷, R⁸, R^{5′}, R^{6′}, R^{7′}; R^{8′}, R¹⁰, R¹¹, or R¹² of Formulae (PM-II-PM-V) are independently hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments of Formulae (PM-I-PM-V), M is a group 3 metal, such as Sc, Y, La, Lu, or Nd.

In some embodiments of Formulae (PM-I) and (PM-II), each of E and E′ is O.

In some embodiments of Formulae (PM-I-PM-V), each of R¹, R², R³, R⁴, R^{1′}, R^{2′}, R^{3′}, and R^{4′} is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, adamantanyl, and isomers thereof.

In embodiments of Formulae (PM-I-PM-V), X is selected from hydrocarbyl radicals having from 1 to 20 carbon atoms (such as alkyls or aryls), hydrides, amides, alkoxides, sulfides, phosphides, halides, alkyl sulfonates, such as X is selected from halides, aryls, and C₁ to C₅ alkyl groups, such as X is a hydrido, dimethylamido, diethylamido, bis(dimethylsilyl)amido, bis(trimethylsilyl) amido, methylenetrimethylsilyl, neopentyl, phenyl, benzyl, methyl, ethyl, propyl, butyl, pentyl, fluoro, iodo, bromo, or chloro group. In some embodiments, X is selected from bis(dimethylsilyl)amido, bis(trimethylsilyl) amido, and methylenetrimethylsilyl.

Alternatively, X may be a halide, a hydride, an alkyl group, or an alkenyl group.

In some embodiments of Formulae (PM-I-PM-V), each L is a Lewis base, independently, selected from ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formulae (PM-I-PM-V), each of R¹ and R^{1′} is independently cyclic tertiary alkyl groups.

In some embodiments of Formulae (PM-I-PM-V), m is 0, 1 or 2, such as 0.

In some embodiments of Formulae (PM-I-PM-V), each of R¹ and R^{1′} is not hydrogen.

In some embodiments of Formulae (PM-I-PM-V), each of R³ and R^{3′} is not hydrogen.

In some embodiments of Formulae (PM-I) and (PM-II), M is Sc, Y, La, Lu, or Nd, each of E and E′ is O; each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, or substituted C₁-C₂₀ hydrocarbyl.

In some embodiments of Formulae (PM-III-PM-V), M is Sc, Y, La, Lu, or Nd, each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, or substituted C₁-C₂₀ hydrocarbyl.

In some embodiments of Formulae (PM-II-PM-V), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In some embodiments of Formulae (PM-II-PM-V), each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (PM-II), M is Sc, Y, La, Lu, or Nd, each of E and E′ is O; each of R¹ and R^{1′} is independently a C₁-C₄₀ hydrocarbyl, a substituted C₁-C₄₀ hydrocarbyl, a heteroatom or a heteroatom-containing group; each of R³ and R^{3′} is independently a C₁-C₄₀ hydrocarbyl, a substituted C₁-C₄₀ hydrocarbyl, a heteroatom or a heteroatom-containing group; each of R¹, R², R⁴, R^{1′}, R^{2′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; X is selected from the group consisting of substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers; n is 1; m is 1; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formulae (PM-IV-PM-V), Q′ is N.

In some embodiments of Formulae (PM-III-PM-V), M is Sc, Y, La, Lu, or Nd; each of R¹ and R^{1′} is independently a C₁-C₄₀ hydrocarbyl, a substituted C₁-C₄₀ hydrocarbyl, a heteroatom or a heteroatom-containing group; each of R³ and R^{3′} is independently a C₁-C₄₀ hydrocarbyl, a substituted C₁-C₄₀ hydrocarbyl, a heteroatom or a heteroatom-containing group; each of R¹, R², R⁴, R^{1′}, R^{2′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; X is selected from the group consisting of substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers; n is 1; m is 1; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (PM-II), M is Sc, Y, La, Lu, or Nd, both E and E′ are oxygen, both R¹ and R^{1′} are independently C₄-C₂₀ cyclic tertiary alkyl, and both R³ and R^{3′} are independently C₁-C₁₀ alkyl.

In some embodiments of Formulae (PM-III-PM-V), M is Sc, Y, La, Lu, or Nd: both R¹ and R^{1′} are independently C₄-C₂₀ cyclic tertiary alkyl, and both R³ and R^{3′} are independently C₁-C₁₀ alkyl.

In some embodiments of Formula (PM-II), M is Sc, Y, La, Lu, or Nd, both E and E′ are oxygen, both R¹ and R^{1′} are adamantan-1-yl or substituted adamantan-1-yl, and both R³ and R^{3′} are independently C₁-C₁₀ alkyl.

In some embodiments of Formulae (PM-III-PM-V), M is Sc, Y, La, Lu, or Nd; both R¹ and R^{1′} are adamantan-1-yl or substituted adamantan-1-yl, and both R³ and R^{3′} are independently C₁-C₁₀ alkyl.

In some embodiments of Formula (PM-II), M is Sc, Y, La, Lu, or Nd, both E and E′ are oxygen, and each of R¹, R^{1′} are independently adamantan-1-yl or substituted adamantan-1-yl and both R³ and R^{3′} are independently methyl or tert-butyl.

In some embodiments of Formulae (PM-III-PM-V), M is Sc, Y, La, Lu, or Nd; each of R¹, R^{1′} are independently adamantan-1-yl or substituted adamantan-1-yl and both R³ and R^{3′} are independently methyl or tert-butyl.

In some embodiments of Formulae (PM-IV-PM-V), G is S, O, NR′, PR′ where R′ is selected from hydrogen and hydrocarbyl or substituted hydrocarbyl groups.

In some embodiments of Formulae (PM-IV-PM-V), G is S or O, more preferably S.

In some embodiments of Formulae (PM-IV-PM-V), G is NR′, PR′ where R′ is selected from hydrogen atoms and C₁-C₂₀ hydrocarbyls and substituted hydrocarbyls.

In some embodiments of Formulae (PM-IV-PM-V), G is NR′, PR′ and R′ is selected from hydrogen or methyl.

In some embodiments of Formula (PM-III), M is Sc, Y, La, Lu, or Nd; each of R¹, R^{1′} are adamantan-1-yl or substituted adamantan-1-yl, both R³ and R^{3′} are tert-butyl or methyl, and R², R^{2′}, R⁴, R^{4′}, R⁵, R^{5′}, R⁶, R^{6′}, R⁷, R^{7′}, R⁸, R^{8′}, R¹⁰, R¹¹ and R¹² are hydrogen.

In some embodiments of Formula (PM-III), M is Sc, Y, La, Lu, or Nd; each of R¹, R^{1′} are tert-butyl, both R³ and R^{2′} are tert-butyl or methyl, and R², R^{2′}, R⁴, R^{4′}, R⁵, R^{5′}, R⁶, R^{6′}, R⁷, R^{7′}, R⁸, R^{8′}, R¹⁰, R¹¹ and R¹² are hydrogen.

In some embodiments of Formula (PM-V), M is Sc, Y, La, Lu, or Nd; G is S, both of R¹, R^{1′} are tert-butyl, both R³ and R^{3′} are methyl, and R², R^{2′}, R⁴, R^{4′}, R⁵, R^{5′}, R⁶, R^{6′}, R⁷, R^{7′}, R⁸, R^{8′}, R¹⁰, R¹¹ and R¹² are hydrogen.

In some embodiments of Formula (PM-V), M is Sc, Y, La, Lu, or Nd; G is S, both of R¹, R^{1′} are adamantan-1-yl or substituted adamantan-1-yl, both R³ and R^{3′} are methyl or tert-butyl, and R², R^{2′}, R⁴, R^{4′}, R⁵, R^{5′}, R⁶, R^{6′}, R⁷, R^{7′}, R⁸, R^{8′}, R¹⁰, R¹¹ and R¹² are hydrogen.

In some embodiments, a catalyst compound is one or more of:

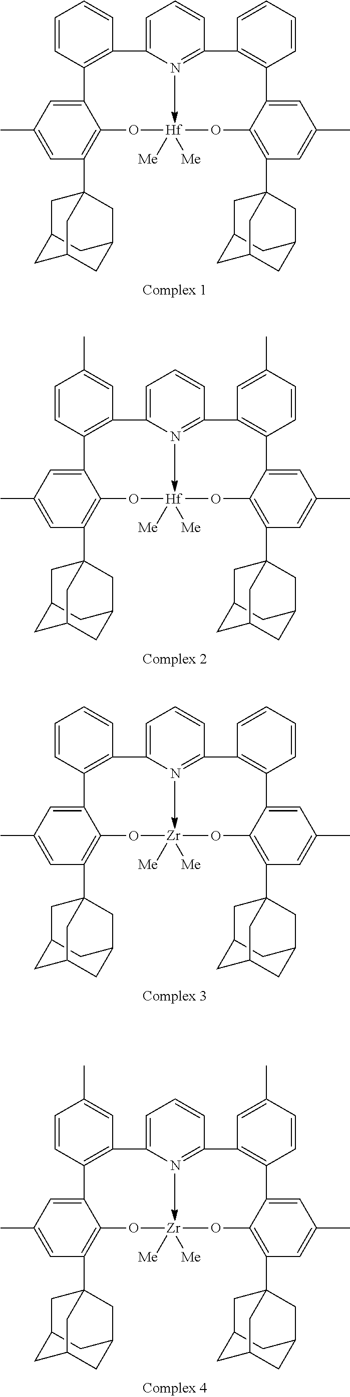

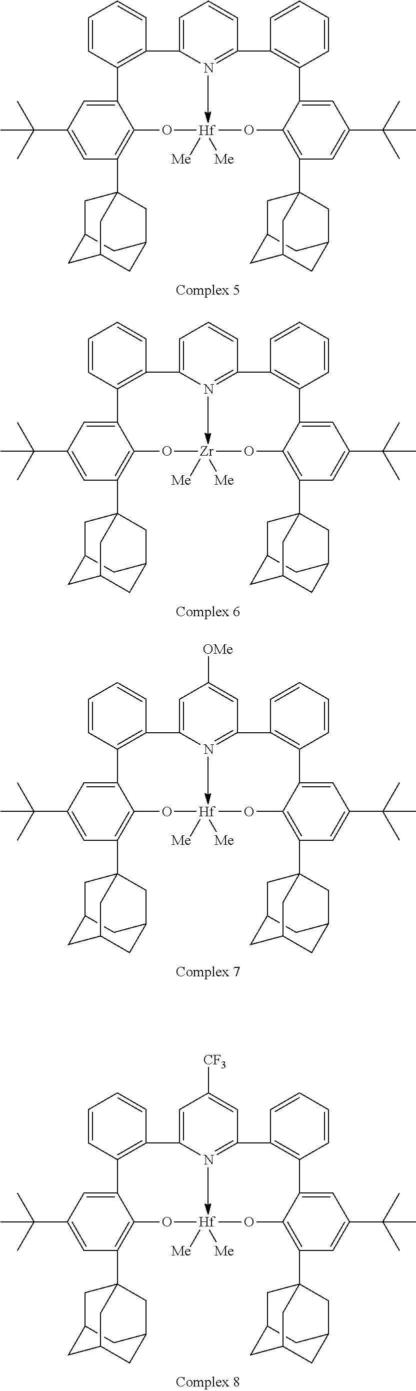

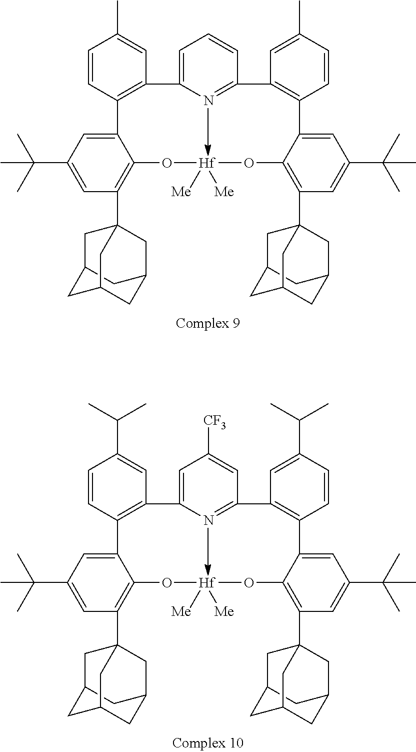

In some embodiments, TMA free (or trihydrocarbylaluminum free) solution alumoxane (e.g., MAO), solid alumoxane (e.g., MAO), or supported alumoxane (e.g., MAO) can also be used for bis-Cp metallocene pre-catalyst compounds not having polar donors for the purpose of polymer property control, e.g., for regulating the polymer molecule weight and molecular weight distribution through limiting the free aluminum alkyls in the system that may cause chain transfer from the catalytic metal center to the free aluminum alkyls. Metallocene pre-catalyst compounds as used herein include metallocenes comprising Group 3 to Group 10 metal complexes, preferably, Group 4 to Group 6 metal complexes, for example, Group 4 metal complexes. The metallocene catalyst compound of catalyst systems of the present disclosure may be unbridged metallocene catalyst compounds represented by the formula (BC-I):

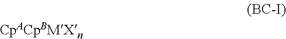

wherein each Cp^{A} and Cp^{B} is independently selected from cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

The metallocene catalyst compound may be a bridged metallocene catalyst compound represented by the Formula (BC-II):

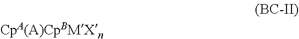

wherein each Cp^{A} and Cp^{B} is independently selected from cyclopentadienyl ligands and ligands isolobal to cyclopentadienyl. One or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. (A) is selected from divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, germanium, ether, and thioether.

In at least one embodiment, each of Cp^{A} and Cp^{B} is independently selected from cyclopentadienyl, n-propylcyclopentadienyl, indenyl, pentamethylcyclopentadienyl, tetramethylcyclopentadienyl, and n-butylcyclopentadienyl. (A) may be CR′₂ or SiR′₂, where each R′ is independently hydrogen or C₁-C₂₀ hydrocarbyl.

In some embodiments, two or more different pre-catalyst compounds are present in the catalyst system used herein. In some embodiments, two or more different pre-catalyst compounds are present in the reaction zone where the process(es) described herein occur. It may be preferable to use the same activator for the catalyst compounds, however, two different activators, such as TMA free supported or unsupported MAO from the current disclosure and a strong Lewis acid activator (e.g., trisperfluoroaromatic boranes) or non- or weak-coordinating anion activator (e.g. N,N-dimethylanalenium or trityl tetrakisperfluoroaromatic borates), can be used in combination. If one or more catalyst compounds contain an X group which is not a hydride, hydrocarbyl, or substituted hydrocarbyl, then the MAO can be contacted with the catalyst compounds prior to addition of the non-coordinating anion activator.

The two catalyst compounds (pre-catalysts) may be used in any ratio. In some embodiments, molar ratios of (A) catalyst compound to (B) catalyst compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10% to 99.9% A to 0.1% to 90% B, alternatively 25% to 99% A to 0.5% to 50% B, alternatively 50% to 99% A to 1% to 25% B, and alternatively 75% to 99% A to 1% to 10% B.

In some embodiments, the leaving groups of the pre-catalysts described above are preferably pre-alkylated, such as methylated, ethylated, benzylated, or trimethylsilylmethylenated because the alkylation agent in MAO, e.g., free TMA, has been removed significantly. However, non-alkylated pre-catalysts may still be used either with a mild alkylation agent, such as high carbon trialkylaluminum (e.g., trioctylaluminum) or a secondary aluminumalkyl (e.g., AlMe₂BHT or AlEt₂BHT) or without a mild alkylation agent if the solution, solid, or supported MAO system has a low TMA or trihydrocarbylaluminum residue enough for the alkylation of the pre-catalyst.

### Polymerization Processes

The present disclosure also relates to polymerization processes where monomer (e.g., ethylene; propylene), and optionally one or more comonomers, are contacted with catalyst systems made from one of the methods described in this disclosure in a single polymerization reactor or multiple polymerization reactors in sequence following corresponding polymerization processes to obtain desired polymer products including single-phasic polymers or copolymers and multiple-phasic copolymers, such as in a single reactor for solution-, slurry-, and gas-phase polymerization and copolymerization, such as in multiple reactors for solution-, slurry-, and gas-phase sequential copolymerization. The pre-catalyst compound and activator may be combined in any suitable order. The pre-catalyst compound and activator may be combined prior to contacting with the monomer, e.g., the finished catalyst system can form first by combing a pre-catalyst compound and a TMA free silica supported MAO before it is fed into the polymerization reactor to contact with monomers. Alternatively, the pre-catalyst compound and activator may be introduced into the polymerization reactor separately, wherein the pre-catalyst compound and activator subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbomene, ethylidenenorbomene, vinylnorbornene, norbomadiene, dicyclopentadiene, cyclopentene, cycloheptene, cyclooctene, cyclooctadiene, cyclododecene, 7-oxanorbomene, 7-oxanorbomadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbomadiene, and their respective homologs and derivatives, such as norbomene, norbomadiene, and dicyclopentadiene. For some pre-catalysts, a diene with formula CₙH₍ₙ₋₂₎ (n=4 to 30), conjugated or non-conjugated, can also serve as the comonomer, such as butadiene, 2-methyl-butadiene, 1,3-pentadiene, 1,4-pentadiene, 2-methyl-1,4-pentadiene, 3-methyl-1,4-pentadiene, 1,4-hexadiene, 1,5-hexadiene, 5-methyl-1,4-hexadiene, 2-methyl-1,5-hexadiene, 1,4-heptadiene, 1,5-heptadiene, 1,6-heptadiene, 5-methyl-1,4-heptadiene, 6-methyl-1,5-heptadiene, 2-methyl-1,6-heptadiene, and the likes.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be employed. (A homogeneous polymerization process is defined to be a process where at least 90 wt % of the product is soluble in the reaction media.) A homogeneous polymerization process can be a bulk homogeneous process. (A bulk process is defined to be a process where monomer concentration in all feeds to the reactor is 70 volume % or more.) Alternately, no diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed, and monomers are polymerized on the supported catalyst particles. At least 95 wt % of polymer products derived from the supported catalyst are in granular form as solid particles (not dissolved in the diluent).

Suitable diluents for polymerization may include non-coordinating, inert liquids. Examples of diluents for polymerization may include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable diluents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon diluents are used as the diluent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the diluent is not aromatic, such as aromatics are present in the diluent at less than 1 wt %, such as less than 0.5 wt %, such as 0 wt % based upon the weight of the diluents.

In at least one embodiment, a feedstream to the reactor has a feed concentration of the monomers and comonomers for the polymerization is 60 vol % diluent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures for solution polymerization include a temperature of about 50° C. to about 200° C., such as about 60° C. to about 180° C., such as about 65° C. to about 160° C., such as about 80° C. to about 150° C., such as about 85° C. to about 140° C. Suitable temperatures for slurry- or gas-phase polymerization include a temperature of about 50° C. to about 120° C., such as about 60° C. to about 110° C., such as about 65° C. to about 100° C., such as about 70° C. to about 85° C., such as about 75° C. to about 80° C. Polymerizations can be run at a pressure of about 0.1 MPa to about 25 MPa, such as about 0.45 MPa to about 6 MPa. or about 0.5 MPa to about 4 MPa.

In a suitable polymerization, the run time of the reaction can be up to about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 45 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, MAO can be present at zero mol %, alternately the MAO can be present at a molar ratio of aluminum to catalyst metal less than 500:1, such as less than 300:1, such as less than 100:1, such as less than 1:1.

Unless otherwise indicated, “catalyst productivity” is a measure of how many grams of polymer (P) are produced using a polymerization catalyst comprising W g of catalyst (cat), over a period of time of T hours, and may be expressed by the following formula: P/(T x W) and expressed in units of gPgcat⁻¹ hr⁻¹. Unless otherwise indicated, “catalyst activity” is a measure of how active the catalyst is and is reported as the mass of product polymer (P) produced per mole of catalyst (cat) used (kgP/molcat) for solution MAO derived catalyst system or as the mass of product polymer (P) produced per mass of catalyst (cat) used (kgP/gcat or gP/gcat) for solution, solid, or supported MAO derived catalyst systems. Catalyst activity may also be expressed over a period of time T of hours and reported as the mass of product polymer (P) produced per mole or millimole of catalyst (cat) used and expressed in units of gPmmolcat⁻¹ hr⁻¹ for solution or solid MAO as the activator and in units of kgPgcat⁻¹ hr⁻¹ for solution, solid, or supported MAO as the activator.

In at least one embodiment, according to the present disclosure, a solution catalyst system with TMA free solution MAO as the activator has a catalyst activity of greater than about 10 to 1,000 kgPgcat⁻¹ hr⁻¹, such as greater than about 20 kgPgcat⁻¹ hr⁻¹, such as greater than about 30 kgPgcat⁻¹ hr⁻¹; such as about 100 kgPgcat⁻¹ hr⁻¹ to about 300 kgPgcat⁻¹ hr⁻¹; a TMA free supported MAO derived finished catalyst system used in slurry- or gas-phase polymerization has a catalyst activity of greater than about 3 to 30 kgPgcat⁻¹ hr⁻¹, such as about 4 kgPgcat⁻¹ hr⁻¹ to about 20 kgPgcat⁻¹ hr⁻¹, such as about 6 kgPgcat⁻¹ hr⁻¹ to about 15 kgPgcat⁻¹ hr⁻¹, such as about 8 kgPgcat⁻¹ hr⁻¹ to about 10 kgPgcat⁻¹ hr⁻¹; and a TMA free solid MAO self-supported catalyst system with the activity in between the solution polymerization and supported catalyst polymerization (slurry- and gas-phase polymerization).

In at least one embodiment, for solution polymerization, the catalyst residence time in a reactor can be about 10 minutes to about 120 minutes, such as about 20 minutes to about 90 minutes, such as about 30 minutes to about 60 minutes; for solution polymerization, the catalyst residence time in a reactor can be about 10 minutes to about 120 minutes, such as about 20 minutes to about 90 minutes, such as about 30 minutes to about 60 minutes; for supported catalyst polymerization, e.g., slurry- or gas-phase polymerization, the catalyst residence time in a reactor can be about 10 minutes to about 240 minutes, such as about 30 minutes to about 120 minutes, such as about 60 minutes to about 90 minutes; and for the self-supported MAO derived catalyst system; the residence time in a slurry- or gas-phase polymerization reactor is similar to the supported catalyst system.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted without an aliphatic hydrocarbon diluent, such as in a gas phase reactor, or with the monomer also serves as a diluent, such as in a slurry reactor with propylene as the monomer and diluent, or in an aliphatic hydrocarbon diluent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics are present in the diluent at less than 1 wt %, such as less than 0.5 wt %, such as at 0 wt % based upon the weight of the diluents for solution or slurry polymerization; 4) wherein the catalyst system used in the polymerization comprises less than 0.5 mol %, such as the MAO is present at a molar ratio of aluminum to catalyst metal less than 500:1, such as less than 300:1, such as less than 100:1, such as less than 1:1; 5) the polymerization occurs in at least one reaction zone; 6) optionally scavengers (such as trialkyl aluminum compounds) are absent (e.g., present at zero mol %, alternately the scavenger is present at a molar ratio of scavenger metal to catalyst metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one pre-catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone or multiple reaction zones. Room temperature is 23° C. unless otherwise noted.

Other additives may also be used in the polymerization, as desired, such as one or more scavengers, hydrogen, aluminum alkyls, or chain transfer agents such as higher alkyl modified MAO, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, MAO, trimethylaluminum, triisobutylaluminum, trioctylaluminum, or a combination thereof. Other additives such as reactor static electron removers or anti-fouling agents, such as Evonik S202 or Atmer™ antistatic agent, may also added catalyst preparation, post-catalyst treatment, or added during or after polymerization.

### Polyolefin Products

The present disclosure also relates to compositions of matter produced by the methods described herein. The processes described herein may be used to produce polymers of olefins or mixtures of olefins. Polymers that may be prepared include polyethylene, polypropylene, homopolymers of C₄-C₂₀ olefins, copolymers of C₄-C₂₀ olefins, copolymers of ethylene with C₃-C₂₀ olefins, copolymers of propylene with C₄-C₂₀ olefins, terpolymers of C₄-C₂₀ olefins, terpolymers of ethylene and propylene with C₄-C₂₀ olefins, and terpolymers of ethylene and propylene with 5-ethylidene-2-norbomene. The processes described herein may be used to produce polymers such as HDPE, MDPE, LDPE, or LLDPE with butene, hexene, or octene as the comonomer to turn the polymer density; such as iPP, sPP, or aPP from different stereo- or regio-regulation on the pre-catalysts, such as random copolymer plastomers from propylene rich ethylene copolymers with ethylene content not more than 30% or ethylene rich propylene copolymers with propylene content not more that 30%, ethylene propylene elastomers (rubber)s, i.e., EP rubbers, with ethylene and propylene close to 50:50, such as 30:70, 40:60, 50:50, 60:40, or 70:30, such as ethylene-butadiene copolymers from solution polymerization; such as impact copolymers, e.g., reactor made iPP-EPR, iPP-EBR (ethylene butylene rubber), iPP-EHR (ethylene hexene rubber) biphasic copolymers from supported catalyst polymerization, such as EPDM (vulcanizable ethylene propylene diene ter-polymer), EBDM (vulcanizable ethylene butylene diene ter-polymer), EHDM (vulcanizable ethylene hexene diene ter-polymer) from solution polymerization, or such as reactor made vulcanizable iPP-EPDM, iPP-EBDM, iPP-EHDM biphasic copolymers. Heterophasic copolymers more than two phases can be obtained from more reaction zones, such as a PE-RCP-EPR or iPP-RCP-EPR tri-phasic copolymers.

In some embodiments, the melt index (MI) for PE based polymers is from 0.01 to about 50 g/10 minutes, such as 0.1 to 10 g/10 minutes, such as 0.5 to 5 g/10 minutes, such as 1-2 g/10 minutes; or the melt flow rate or mass flow rate (MFR) for PP based polymers is from 0.01 to 2000 g/10 minutes, such as 0.05 to 1000 g/10 minutes, such as 0.1 to 500 g/10 minutes, such as 0.5 to 100 g/10 minutes, such as 2-50 g/10 minutes, with the measurement method described in the similar standards ASTM D1238 and ISO 1133.

In some embodiments, the weight average molecular weight Mw of the polymer products is in the range of 10 k to 2000 k measured by GPC methods, such as 50 k to 1000 k, such as 60 k to 500 k, such as 100 k to 300 k; and the molecular weight distribution (MWD) or polydispersity index (PDI) is 1.5 to 30, such as 2 to 10, such as 2.5 to 9, which can have single modal or multiple modal distributions, for example, bimodal distributions from a two-stage polymerization process in two different reaction zones or from a one-stage polymerization process in one reaction zone with a catalyst system containing two different pre-catalyst compounds.

In some embodiments, the comonomer distribution in the polymer products can be a conventional distribution, i.e., the comonomer incorporation is getting less with the increase of Mw; can be a flat distribution, i.e., similar incorporation with different molecular weight compositions; or can be a broad orthogonal comonomer distribution, i.e., the comonomer incorporation is getting more with the increase of Mw.

### EXPERIMENTAL EXAMPLES

### General Consideration

All reactions were carried out under a purified nitrogen atmosphere using standard glovebox, high vacuum or Schlenk techniques, in a CELSTIR reactor unless otherwise noted. All solvents used were anhydrous, de-oxygenated and purified according to known procedures. All starting materials were either purchased from Aldrich and purified prior to use or prepared according to procedures known to those skilled in the art. Silica ES70 was obtained from PQ Corporation (now Ecovyst). MAO was obtained as a 30 wt % MAO in toluene solution from W. R. Grace (e.g., 13.6 wt % Al or 5.04 mmol Al/g). Deuterated solvents were obtained from Cambridge Isotope Laboratories (Andover, Mass.) and dried over 3 A molecular sieves. All ¹H NMR data were collected on a Broker AVANCE III 400 MHz spectrometer running Topspin™ 3.0 software at room temperature (RT).

### Example 1

### Quantification of Total THF Extractable TMA Contents in a Commercial MAO Solution

The total TMA content including the coordinated and free TMA in either a supported or unsupported MAO composition can be quantified through a THF solvent treatment to convert both the coordinated and free TMA to AlMe₃(THF) as the major product and AlMe₂(THF)₂⁺ as a minor product according to Scheme (8) reaction. The total TMA is therefore the sum of AlMe₃(THF) and AlMe₂(THF)₂⁺ (converted back to TMA in calculation) and can be quantified with the ¹H NMR methods below with the solvent toluene as the internal standard for solution MAO or with an added inert compound as the internal standard for ether a solution MAO, a solid MAO, or a supported MAO.

Chemicals: W. R. Grace MAO 30% toluene solution (Al=13.6 wt % (5.0 mmol/g), MAO=26.6 wt %, total TMA (coordinated and free)=4.76 wt % from the Certificate of Analysis (COA) of the MAO product) and THF-d8 NMR solvent (Cambridge Isotope) treated with 3 A molecular sieves.

If the MAO for studies is within 3 months of storage at <−20° C., the total TMA wt % in the MAO product COA can be used with no significant error. For a MAO solution under a longer storage or frequent changing of storage temperature (e.g., frequently taking out of freezer a portion of MAO and returning to the freezer), the total THF extractable TMA content may increase significantly due to the gelation process that releases TMA.

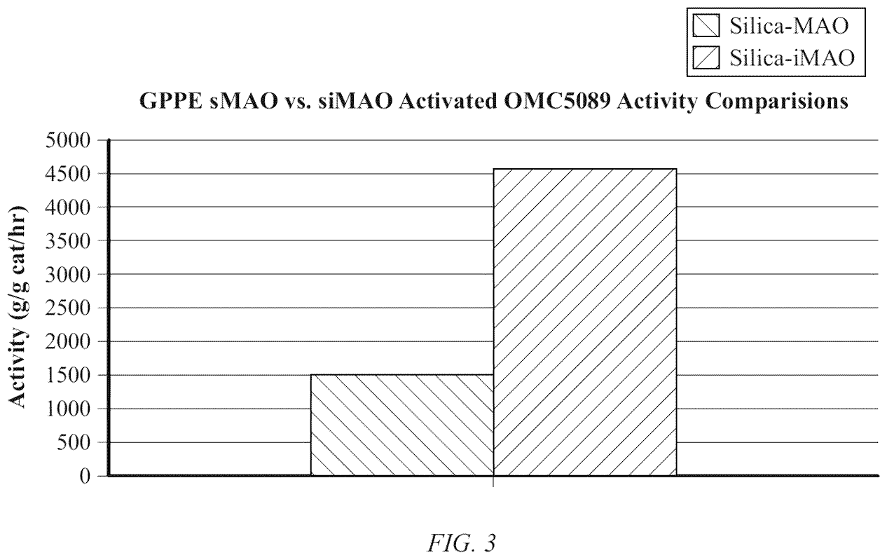

Procedure: In the drybox, fill an oven dried 5 mm NMR tube with ~0.5 inch MAO solution, followed by ~1.5 inch THF-d8 solvent, shake well, and then take the ¹H NMR spectrum of the sample using D1=30 s, ns=4. A longer relaxation time D1 may be more accurate but 30 s is long enough to obtain <2 wt % error of quantitative toluene CH₃ and Al—CH₃ signals. The ¹H NMR spectrum in the region from toluene Me to Al-Me is shown in FIG. 3 bottom spectrum (B).

Processing: integrate the peak of CH₃ on toluene, the total Al—CH₃ area, the peak of AlMe₂(THF)₂⁺, and the peak of AlMe₃(THF); set the integral of CH₃ of toluene as 300 (set as 300 instead of 3, the CH₃ proton number, in order to have at least 3 digit accuracy in the spectrum printout because the numbers after the decimal point may be cut off) and record all Al-Me species integral including MAO, AlMe₃(THF) and AlMe₂(THF)₂⁺ as 350.28. AlMe₃(THF) integral as 78.96 AlMe₂(THF)₂⁺ integral as 7.98, and ignore minor species such as the processing oil that is usually present but in small amount, e.g., <1 wt %. The MAO formula without coordinated TMA is Al₁O_{0.78}Me_{1.44} based on the COA to give a Mw 61.1 g/mol. The MAO integral is 350.28−78.96−7.98=263.34. The proton number in MAO is 1.44*3=4.32. Because AlMe₂⁺ is counted as TMA because it is generated from coordinated TMA. The calculation results are listed in Table 1.

TABLE 1
Total THF extractable TMA Calculation

| Species | Integral | Proton# | Mw | Weight Portion¹ | Wt %² | |
|---|---|---|---|---|---|---|
| Toluene | 300 | 3 | 92.1 | 9210 | 67.40 | |
| MAO | 263.34 | 4.32 | 61.1 | 3726.3 | 27.27 | Total TMA |
| AlMe₃ | 78.96 | 9 | 72.1 | 632.6 | 4.63 | 5.33% |
| AlMe₂⁺ | 7.98 | 6 | 72.1³ | 95.9 | 0.70 | |
| | | | Total | 13664.8 | 100 | |

¹Weight portion, = Mw*Integral/Proton#, is an individual species' weight contribution;
²wt % = individual weight portion/total weight portions*100%;
³AlMe₂⁺ is derived from the coordinated TMA and therefore is converted back to TMA.

It can be seen that now the total TMA content is increased from 4.76 wt % (COA) to 5.33 wt %, an indication of low degree gelation.

### Example 2

### Quantification of Coordinated TMA in a Commercial MAO Solution

The quantification of coordinated TMA is based on the reaction Scheme (5) below:

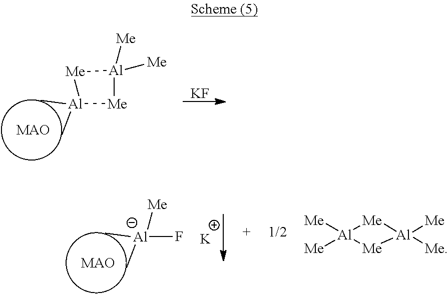

In the reaction above, KF can precipitate MAO as a clathrate phase to separate from the solution phases containing free TMA through the replacement of the coordinated TMA to form an ionic MAO composition. Applying a largely excess, known amount of KF (W1^{KF}) to an MAO solution and isolating the left KF (W2^{KF}) after the reaction, the KF consumption can be calculated as W1^{KF}−W2^{K}, which is an indirect quantification method for the coordinated TMA content.

Chemicals: KF (Aldrich), 10 g in a 50 mL round bottom flask dried in an oil bath at 110° C. under vacuum for 4 hours; the same MAO solution and THF-d8 used for Example 1.

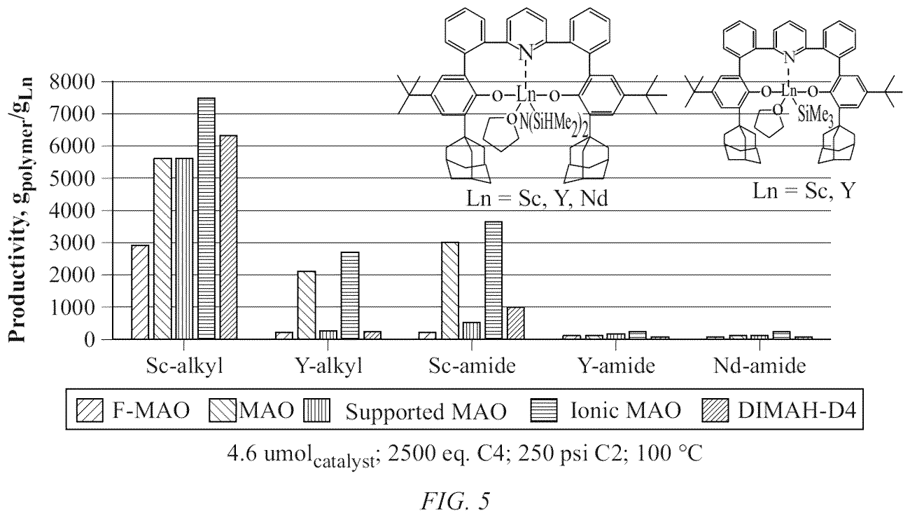

Procedure: In the drybox, each of 4 oven-dried vials (20 mL) were charged with 10.0 g MAO solution (51.1 mmol Al calculated based on Table 1 results), and then with KF (58.1 g/mol) 59.6 mg (2 mol % based on total Al), 118.9 mg (4 mol % based on total Al), 207.6 mg (7 mol % based on total Al), and 298 mg (10 mol % based on total Al), respectively. Place the vials on a shaker to shake for overnight. Remove the vials from the shaker and allow the clathrate phases to settle for 1 hour. KF in vials with 2 mol %, 4 mol %, and 7 mol % treatment all disappeared but the vial with 10 mol % treatment showed left-over KF. All upper phase solutions of the 4 vials were analyzed with ¹H NMR spectroscopy in THF-d8 NMR solvent and the spectra were compared in the Al-Me region shown in FIG. 5A that shows reducing MAO concentrations. The clathrate phase from the sample with complete conversion of regular MAO to ionic MAO (vial with 10 mmol % KF treatment) was also analyzed with ¹H NMR spectroscopy in THF-d8 NMR solvent and the spectrum of the Al-Me region is shown in FIG. 5B with the mother MAO solution for comparison, which shows the absence of AlMe₂ species for the ionic MAO, meaning all coordinated TMA is removed by KF as a confirmation that the coordinated TMA is the source of AlMe₂⁺. The left-over KF in the vial of 10 mol % treatment was collected with a pre-weighted frit filter, which was washed with 3×10 mL dried toluene and 30 mL dried isohexane, then weighted to give 75.3 mg (2.54 mol % based on total Al) unreacted KF, giving the coordinated TMA in the MAO solution=10−2.5=7.5 mol %. The total Al % is 13.8 wt % and the total TMA (free+coordinated) is 5.33 wt %/o. The total TMA can be converted to 2.00 wt % Al to give 14.5 mol %.

### Example 3

### Free TMA Estimation

Based on the quantification method for the weight percent of total TMA (Wt^{total TMA} %, coordinated TMA and free TMA) in Example 1 and the quantification method for the weight percent of coordinated TMA (Wt^{coordinated TMA} %) in Example 2, the free TMA content Wt^{free TMA} % can be estimated as Wt^{free TMA} %=Wt^{total TMA} %−Wt^{coordinated TMA} %.

### Example 4

### OMTS Titration

The quantification of MAO active sites capable of reacting with OMTS to form AlMe₂(OMTS)⁺ cationic complex is based on the reaction of Scheme (6) below, using the Kaminsky active MAO formula that has two coordinated TMA molecules as the example.

Chemicals: Octamethyltrisiloxane (OMTS, from Aldrich, stored with 3A molecular sieves for overnight before use); the same MAO solution used for Example 1.

Procedure: In the drybox, into a 20 mL vial were charged 1.0 g (5.0 mmol Al) 30% MAO solution and 0.236 g OMTS (1.0 mmol, based on 20 mol % on Al) and mixed well. The mixture was shaken on a shaker for 120 minutes at ambient. The mixture was then mixed slowly with 10 g dried CDCl₃ and shaken on a shaker for 10 minutes to obtain a homogeneous solution. A sample was then taken for ¹H NMR spectroscopy. Free OMTS: —OSiMe₃: 0.20 ppm 18H; ═SiMe₂: 0.14 ppm, 6H. [AlMe₂(OMTS)]⁺: AlMe₂: −0.26 ppm, 6H; —OSiMe₃: 0.61 ppm 18H; ═SiMe₂: 0.94 ppm, 6H. The quantification of [AlMe₂(OMTS)]⁺ details are summarized in Table 2, using the toluene as the internal standard based on Example 1 results (mother MAO, Table 1):

TABLE 2
MAO OMTS Titration Results

| | Group for | | H | | | Mol % on |
|---|---|---|---|---|---|---|
| Species | Integration | Integral | Number | Wt % | Mol % | Al of MAO |
| Tol (mother MAO, Ex. 1) | — | — | — | 67.4¹ | 0.73² | — |
| Total TMA (mother MAO, Ex. 1) | — | — | — | 5.33¹ | 0.074² | 14.5 |
| Tol (ionic MAO) | PhMe | 383.1 | 3 | — | 0.73³ | — |
| [AlMe₂(OMTS)]⁺ (ionic MAO) | AlMe₂ | 20.0 | 6 | — | 0.019⁴ | 3.7 |
| Coordinated TMA (Ex. 2) | — | — | 1 | — | — | 7.5 |

¹from Table 1;
²Wt % divided by species Mw: toluene 92.1 and TMA 72.1 g/mol;
³use mother MAO toluene as internal standard due to unchanged during the reaction in a closed system, set as 0.73 mol % as the mother MAO solution; 4 = (20.0/6)/(383.1/3)*0.73 = 0.019 mo1 %;

Table 2 shows that OMTS can only convert one of the two coordinated TMA molecules on an MAO molecule to AlMe₂(OMTS)⁺ while KF can replace two based on the comparison with Example 2 that the KF titration consumes a double amount of KF vs. the OMTS amount in the OMTS titration. The reason for such a difference is believed to be that the strong electron withdrawing group F can actually pull negative charges from the MAO molecule to enable a −2 charge on the MAO anion, whereas the OMTS complexation with AlMe₂⁺ leaves the Al anion either with two electron-donating Me groups and two electron-donating O atoms Scheme (6) or three electron-donating Me groups and one electron-donating O atom (another possibility of the coordinated TMA structure) to make the 2^{nd} negative charge on the MAO anion difficult, as illustrated in Scheme (7).

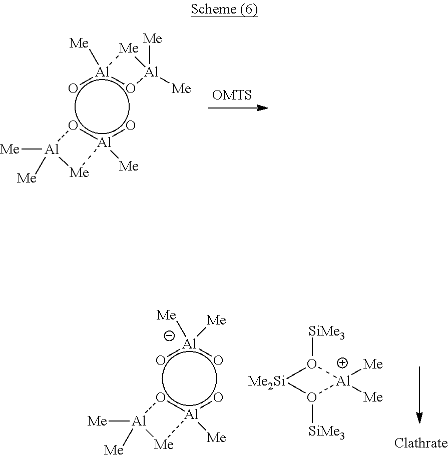

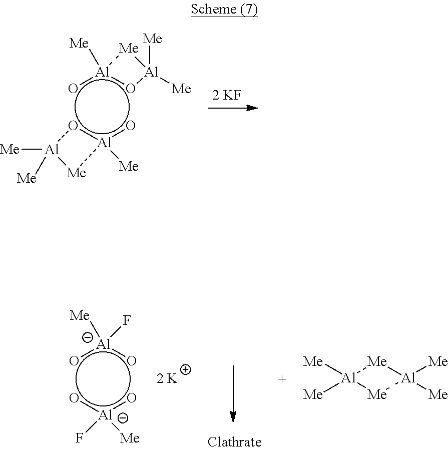

### Example 5

Solution Ionic MAO from OMTS Treatment (Ionic MAO-1 and Ionic MAO-2)

Chemicals: W. R. Grace 30% MAO toluene solution (13.6 wt % Al from W. R. Grace Certificate of Analysis; 7.5 mol % coordinated TMA based on total Al quantified based on Example 4 method); OMTS (236.5 g/mol, Aldrich, 3A molecular sieves overnight).

Procedure: 41.5 g MAO (207.5 mmol Al) was charged in a 100 mL round bottom flask with a stir bar. To the MAO solution was added slowly 1.84 g OMTS (7.8 mmol) based on 3.7 mol % OMTS on total Al according to Example 4 Table 2 OMTS titration result. The mixture was stirred for 45 minutes. The mixture was transferred to a separation funnel and allowed to settle for overnight. Two liquid phases formed. The bottom phase (product) was collected and weighted. Yield 21 g of oily material. The two-phase border portion was discarded. The top layer weight: 19.5 g as a normal solution. ¹H NMR for bottom phase ionic MAO in CDCl₃: [AlMe₂(μ-OSiMe₃)₂SiMe₂]⁺-MAO area: SiMe₂: δ0.92 (6H); SiMe₃: δ0.92 (18H); AlMe₂: δ −0.29 (6H); free TMA: δ−6.6 (9H).

The free TMA content is calculated using [AlMe₂(μ-OSiMe₃)₂SiMe₂]⁺ as the internal standard (3.7 mol % on total Al, AlMe₂ integral 59.70) to give free TMA (integral 9.70)=(9.70/9)*3.7 mol %/(59.70/6)=0.40 mol % (or 0.40 wt %) based on total Al. This ionic MAO is labeled as 1-MAO-1.

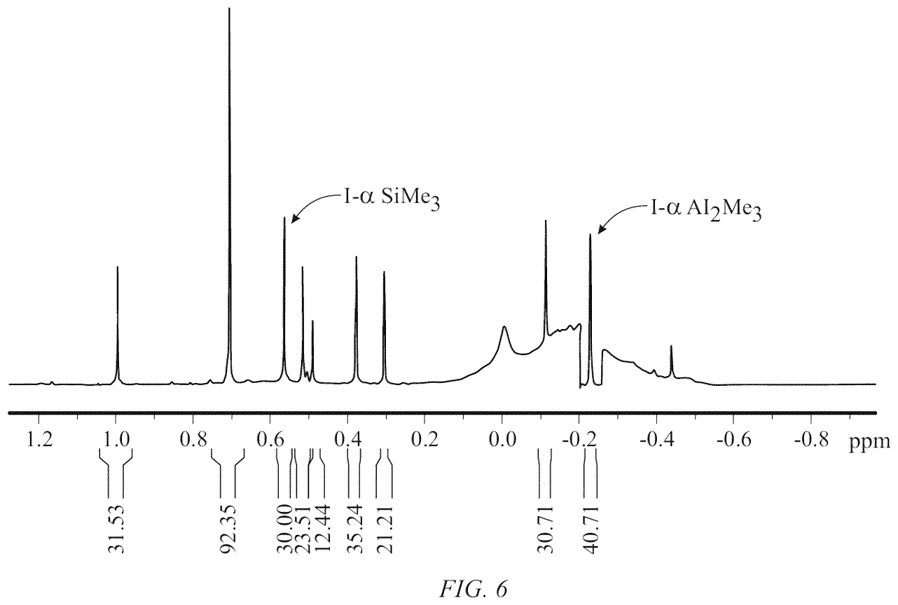

The oily ionic MAO is then heated at 90° C. in an oil-bath for 60 minutes, a ¹H NMR was taken, as shown in FIG. 6. A new species containing Al-Me units appears at −0.23 ppm and it increased with a species containing Si-Me units at 0.56 ppm, keeping the ratio of Si-Me:Al-Me=3:4, which is assigned to species 1-a described in the Cation Modified (Ionic) MAO section as the most possible structure, with the ¹H NMR spectrum showing the Si-Me and Al-Me area as below. This ionic MAO is labeled as I-MAO-2.

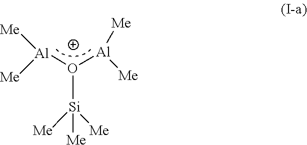

Experimental evidence showed that every MAO molecule had two coordinated TMA but only one could form an OMTS chelating cation [AlMe₂(OMTS)]⁺ because it was difficult to build two anion charges on one molecule. Therefore, about 3.7 mol % OMTS based on Al was able to precipitate almost all MAO molecules as an ionic MAO to separate from the free TMA that stayed in the upper solution phase, which could be removed by phase separation. OMTS could be added neat or as a solution.

### Example (Ex) 6, 7, and 8 and Comparative Example (cEx) 1, 2, 3, and 4

### Small Scale Polymerizations:

Polymerization Reagents. Pre-catalyst solutions were made using a given transition metal complex dissolved in toluene (ExxonMobil Chemical-anhydrous, stored under N₂) (98%), typically at a concentration of 0.5 mmol/L. Activation of the complexes was performed using various methylaluminoxes (MAO) including commercial methylalumoxane (rMAO, 10 wt % in toluene, W. R. Grace as a reference), TMA free F-MAO (described in another patent application), or TMA free I-MAO-2 (from Example 5). Catalyst A can be prepared as described in U.S. Pat. No. 11,254,763.

All MAOs were typically used as a 0.2 wt % toluene solution. Micromoles of MAO reported below are based on the micromoles of aluminum in MAO, which has a formula weight of 58.0 grams/mole.

Solvents, polymerization grade toluene and/or isohexanes were supplied by ExxonMobil Chemical Co. and were purified by passage through a series of columns: two 500 cc OXYCLEAR cylinders in series from Labclear (Oakland, Calif.), followed by two 500 cc columns in series packed with dried 3 Å molecular sieves (8-12 mesh; Aldrich Chemical Company), and two 500 cc columns in series packed with dried 5 Å molecular sieves (8-12 mesh; Aldrich Chemical Company).

1-octene (C₈; 98%, Aldrich Chemical Company) was dried by stirring over NaK overnight followed by filtration through basic alumina (Aldrich Chemical Company, Brockman Basic 1).

Polymerization grade ethylene (C₂) was used and further purified by passing it through a series of columns: 500 cc Oxyclear cylinder from Labclear (Oakland, Calif.) followed by a 500 cc column packed with dried 3 Å mole sieves (8-12 mesh; Aldrich Chemical Company), and a 500 cc column packed with dried 5 Å mole sieves (8-12 mesh; Aldrich Chemical Company).

Polymerization grade propylene was purified by passage through a series of columns: 2,250 cc OXICLEAR cylinder from Labclear followed by a 2,250 cc column packed with 3 Å molecular sieves (8-12 mesh; Aldrich Chemical Company), then two 500 cc columns in series packed with 5 Å molecular sieves (8-12 mesh; Aldrich Chemical Company), then a 500 cc column packed with SELEXSORB CD (BASF), and finally a 500 cc column packed with SELEXSORB COS (BASF).

Reactor Description and Preparation: Polymerizations were conducted in an inert atmosphere (N₂) drybox using autoclaves equipped with an external heater for temperature control, glass inserts (internal volume of reactor=23.5 mL for C₂/C₈; 22.5 mL for C₃), septum inlets, a regulated supply of nitrogen, ethylene and propylene, and disposable PEEK mechanical stirrers (800 RPM). The autoclaves were prepared by purging with dry nitrogen at 110° C. or 115° C. for 5 hours and then at 25° C. for 5 hours.

### Propylene Polymerizations (PP):

The reactor was prepared as described above, heated to 40° C., and then purged with propylene gas at atmospheric pressure. For MAO-activated runs, toluene, MAO, propylene (1.0 ml unless otherwise listed in the tables) and comonomer (if used) were added via syringe. The reactor was then heated to process temperature (typically 70° C. or 100° C. unless otherwise mentioned) while stirring at 800 RPM. The pre-catalyst solution was added via syringe with the reactor at process conditions. The reactor temperature was monitored and typically maintained within +/−1° C. Polymerizations were halted by addition of approximately 50 psi of an air gas mixture or CO₂ gas to the autoclaves for approximately 30 seconds. The polymerizations were quenched based on a predetermined pressure loss of approximately 8 psi unless specified differently (max quench value in psi) or for a maximum of 30 minutes polymerization time unless specified differently. The reactors were then cooled and vented. The polymers were isolated after solvent removal in-vacuo. Actual quench times are reported. Quench times less than maximum reaction times indicate the reaction quenched with uptake. Yields reported include total weight of polymer and residual catalyst. Catalyst activity is reported as grams of polymer per mmol complex per hour of reaction time (gP/mmol cat·hr). Propylene homopolymerization examples including characterization are summarized in Table 3 below.

### Ethylene/1-Octene Copolymerization (EO):

The reactor was prepared as described above, and then purged with ethylene. For MAO activated runs, toluene, 1-octene (100 μL), and activator (MAO) were added via syringe at room temperature and atmospheric pressure. The reactor was then brought to process temperature (100° C.) and charged with ethylene to process pressure (200 psig=1480.3 kPa) while stirring at 800 RPM. The pre-catalyst solution was then added via syringe to the reactor at process conditions. Ethylene was allowed to enter (through the use of computer controlled solenoid valves) the autoclaves during polymerization to maintain reactor gauge pressure (+/−2 psig). Reactor temperature was monitored and typically maintained within +/−1° C. Polymerizations were halted by addition of approximately 50 psi compressed air to the autoclave for approximately 30 seconds. The polymerizations were quenched after a predetermined cumulative amount of ethylene had been added (maximum quench value of 15 psid) or for a maximum of 30 minutes polymerization time. Afterwards, the reactors were cooled and vented. Polymers were isolated after the solvent was removed in-vacuo. Yields reported include total weight of polymer and residual catalyst. Catalyst activity is reported as grams of polymer per mmol transition metal compound per hour of reaction time (g/mmol·hr). Ethylene-octene copolymerization examples are summarized in Table 4.

Small Scale Polymer Characterization. For analytical testing, polymer sample solutions were prepared by dissolving polymer in 1,2,4-trichlorobenzene (TCB, 99+% purity) containing 2,6-di-tert-butyl-4-methylphenol (BHT, Sigma-Aldrich, 99%) at 165° C. in a shaker oven for approximately 3 hours. The typical concentration of polymer in solution was from 0.1 to 0.9 mg/ml with a BHT concentration of 1.25 mg BHT/ml of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn), z-average molecular weight (Mz)) and molecular weight distribution (PDI=MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3.390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 ml/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in the Tables below under the headings Mn, Mw, Mz and PDI as defined above.

Differential Scanning Calorimetry (DSC) measurements were performed on a TA-Q100 instrument to determine the melting point of the polymers. Samples were pre-annealed at 220° C. for 15 minutes (first melt) and then allowed to cool to room temperature overnight. The samples were then heated to 220° C. at a rate of 100° C./minute (2^{nd} melt) and then cooled at a rate of 50° C./minute. Melting points were collected during the heating period. Values reported are the peak melting temperatures and for the purposes of this disclosure referred to as 2^{nd} melts. The results are reported in the Tables under the heading, Tₘ.

FTIR—Samples for infrared analysis were prepared by depositing the stabilized polymer solution onto a silanized wafer. By this method, approximately between 0.12 mg and 0.24 mg of polymer is deposited on the wafer cell. The samples were subsequently analyzed on a Brucker Equinox 55 FTIR spectrometer equipped with Pikes' MappIR specular reflectance sample accessory. Spectra, covering a spectral range of 5000 cm-1 to 500 cm-1, were collected at a 2 cm-1 resolution with 32 scans. For ethylene-1-octene copolymers, the wt % octene in the copolymer was determined via measurement of the methyl deformation band at ~1375 cm-1. The peak height of this band was normalized by the combination and overtone band at ~4321 cm-1, which corrects for path length differences. The normalized peak height was correlated to individual calibration curves from ¹H NMR data to predict the wt % octene content within a concentration range of ~2 to 35 wt % for octene. Typically, R² correlations of 0.98 or greater are achieved. These numbers are reported in Table 2 under the heading C₈ (wt %).

Two pre-catalysts including a post-metallocene A and a hafnocene B with structures below were used for propylene and ethylene polymerization tests, respectively:

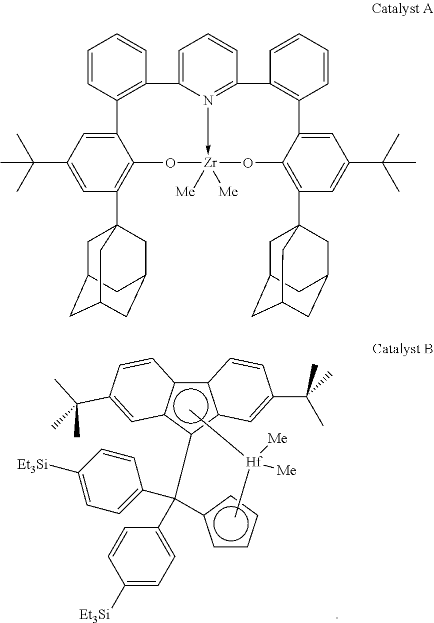

Table 3 lists the propylene polymerization examples. Standard conditions include 0.015 micromoles of catalyst A, and the indicated type and amount of activator (Act) in the Table 3. 1 ml propylene and a total of 4.1 ml of solvents were used. The reaction was heated to either 70° C. or 100° C., stirred at 800 rpm, and the reaction was quenched after 8 psi of pressure loss or a maximum of 30 minutes of reaction time if quench pressure not met.

TABLE 3
Propylene Homo-Polymerizations with Catalyst A

| | | | | Iso- | Tol- | | | |
|---|---|---|---|---|---|---|---|---|
| | | Act | Act/Cat | hexane | uene | T | quench | |
| Example | Act | (umol) | (molar) | (uL) | (uL) | (C.) | time (s) | yield (g) |
| cEx 1-1 | F-MAO | 3 | 200 | 3940 | 160 | 70 | 192 | 0.1635 |
| cEx 1-2 | F-MAO | 3 | 200 | 3940 | 160 | 70 | 242 | 0.1707 |
| cEx 1-3 | F-MAO | 3 | 200 | 3940 | 160 | 70 | 266 | 0.2106 |
| Ex 6-1 | I-MAO-2 | 3 | 200 | 3940 | 160 | 70 | 261 | 0.0917 |
| Ex 6-2 | I-MAO-2 | 3 | 200 | 3940 | 160 | 70 | 389 | 0.1017 |
| cEx 1-4 | F-MAO | 3 | 200 | 3940 | 160 | 100 | 177 | 0.1260 |
| cEx 1-5 | F-MAO | 3 | 200 | 3940 | 160 | 100 | 216 | 0.1627 |
| cEx 1-6 | F-MAO | 3 | 200 | 3940 | 160 | 100 | 162 | 0.1303 |
| Ex 6-3 | I-MAO-2 | 3 | 200 | 3940 | 160 | 100 | 1271 | 0.0526 |
| Ex 6-4 | I-MAO-2 | 3 | 200 | 3940 | 160 | 100 | 724 | 0.0571 |
| Ex 6-5 | I-MAO-2 | 3 | 200 | 3940 | 160 | 100 | 1800 | 0.0628 |
| cEx 2-1 | cMAO | 1.5 | 100 | 3990 | 110 | 100 | 1326 | 0.0475 |
| cEx 2-2 | cMAO | 1.5 | 100 | 3990 | 110 | 100 | 874 | 0.0472 |
| cEx 2-3 | cMAO | 1.5 | 100 | 3990 | 110 | 100 | 1802 | 0.0343 |
| cEx 1-7 | F-MAO | 1.5 | 100 | 3990 | 110 | 100 | 1234 | 0.0778 |
| cEx 1-8 | F-MAO | 1.5 | 100 | 3990 | 110 | 100 | 676 | 0.0953 |
| cEx 1-9 | F-MAO | 1.5 | 100 | 3990 | 110 | 100 | 576 | 0.0932 |

| | Activity (g/ | | | | | Tm |
|---|---|---|---|---|---|---|
| Example | mmol cat/hr) | Mn | Mw | Mz | PDI | (° C.) |
| cEx 1-1 | 204,375 | 530,984 | 818,826 | 1,562,780 | 1.54 | 146.3 |
| cEx 1-2 | 169,289 | 477,257 | 813,723 | 1,663,207 | 1.71 | 146.7 |
| cEx 1-3 | 190,015 | 499,473 | 835,971 | 1,667,230 | 1.67 | 146.9 |
| Ex 6-1 | 84,322 | 599,093 | 900,145 | 1,582,595 | 1.50 | 146.7 |
| Ex 6-2 | 62,746 | 604,341 | 1,015,743 | 2,024,534 | 1.68 | 146.7 |
| cEx 1-4 | 170,847 | 214,638 | 370,462 | 790,427 | 1.73 | 145.8 |
| cEx 1-5 | 180,778 | 255,102 | 367,049 | 629,721 | 1.44 | 145.5 |
| cEx 1-6 | 193,037 | 208,690 | 342,026 | 639,730 | 1.64 | 145.8 |
| Ex 6-3 | 9,932 | 262,406 | 447,214 | 998,972 | 1.70 | 145.7 |
| Ex 6-4 | 18,928 | 296,026 | 455,570 | 834,949 | 1.54 | 145.9 |
| Ex 6-5 | 8,373 | 289,451 | 454,896 | 858,372 | 1.57 | 145.7 |
| cEx 2-1 | 8,597 | 237,015 | 414,662 | 898,566 | 1.75 | 146.5 |
| cEx 2-2 | 12,961 | 214,648 | 394,836 | 832,006 | 1.84 | 145.8 |
| cEx 2-3 | 4,568 | 297,873 | 448,127 | 829,659 | 1.50 | 145.7 |
| cEx 1-7 | 15,131 | 286,999 | 460,382 | 904,130 | 1.60 | 145.4 |
| cEx 1-8 | 33,834 | 278,447 | 445,117 | 841,854 | 1.60 | 145.7 |
| cEx 1-9 | 38,833 | 254,852 | 457,886 | 974,417 | 1.80 | 145.4 |

Table 3 indicates that for propylene homo-polymerization, the non-coordinated TMA free ionic MAO is not as good as the non-coordinated TMA free F-MAO as the activator for a post-metallocene pre-catalyst with a zirconium center, by comparing the set of cEx 1-1 to -3 with Ex 6-1 to -2 at 70° C. and cEx 1-4 with Ex 6-3 to -5 at 100° C., respectively. The F-MAO also out-performs regular MAO, by comparing cEx 2-1 to -3 with cEx 1-7 to -9. However, for ethylene polymerization (usually with a small amount of higher alkyl olefins such as butane, hexane, or octane as the comonomer to obtain a lower polymer density, e.g., LLDPE; here using octene), the ionic MAO significantly out-performs the F-MAO with the same pre-catalyst Catalyst A for propylene polymerization above, with the examples listed in Table 4 below, along with a hafnocene pre-catalyst Catalyst B that is usually difficult to activate with a regular MAO as the activator. Actually F-MAO is almost no reactivity for ethylene-octene copolymerization with both pre-catalysts Catalyst A and Catalyst B, by comparing cEx 3-1 to -3 with Ex 7-1 to -3 and cEx 4-1 to -3 with Ex 8-1 to -3, respectively. It has therefore shown a need for both the anion modified MAO (e.g., F-MAO) and the cation modified MAO (e.g., OMTS treated MAO) free of non-coordinated alkylaluminum for the activation of non-leaving hetero-atom containing pre-catalysts to enable the polymerization or copolymerization of a variety of monomers and copolymers.

Table 4 lists the ethylene-octene copolymerization examples. Standard conditions include 0.015 micromoles of catalyst A or 0.025 micromoles of catalyst B, and the indicated type and amount of activator (Act) in the Table. Octene (0.100 ml) and 4.9 ml of toluene were used. The reaction was heated to 100° C., pressurized with 200 psi ethylene with semi-continuous feed, and stirred at 800 rpm. The reaction was quenched after 15 psi of ethylene uptake or a maximum of 30 minutes of reaction time if quench pressure was not met. *Indicates the octene content is outside the calibration range of the FTIR.

TABLE 4
Ethylene-Octene Copolymerization with Catalyst A and Catalyst B (100:1 Al:Zr or Hf)

| | | | Act | actual quench | | Activity (gP/ |
|---|---|---|---|---|---|---|
| Ex# | Cat ID | Act | (umol) | time (s) | yield (g) | mmol cat.hr) |
| cEx 3-1 | A | F-MAO | 1.5 | 1801 | 0.0007 | 93 |
| cEx 3-2 | A | F-MAO | 1,5 | 1800 | 0.0000 | 0 |
| cEx 3-3 | A | F-MAO | 1.5 | 1800 | 0.0009 | 120 |
| Ex 7-1 | A | I-MAO-2 | 1.5 | 18 | 0.0807 | 1,076,000 |
| Ex 7-2 | A | I-MAO-2 | 1.5 | 113 | 0.1170 | 248,496 |
| Ex 7-3 | A | I-MAO-2 | 1.5 | 22 | 0.0761 | 830,182 |
| cEx 4-1 | B | F-MAO | 2.5 | 1802 | 0.0010 | 80 |
| cEx 4-2 | B | F-MAO | 2.5 | 1801 | 0.0002 | 16 |
| cEx 4-3 | B | F-MAO | 2.5 | 1801 | 0.0003 | 24 |
| Ex 8-1 | B | I-MAO-2 | 2.5 | 175 | 0.0240 | 19,749 |
| Ex 8-2 | B | I-MAO-2 | 2.5 | 98 | 0.0446 | 65,535 |
| Ex 8-3 | B | I-MAO-2 | 2.5 | 102 | 0.0513 | 72,424 |
| | | | | | C8 | |
| Ex# | Mn | Mw | Mz | PDI | (wt %) | Tm (º C.) |
| cEx 3-1 | — | — | — | — | — | — |
| cEx 3-2 | — | — | — | — | — | — |
| cEx 3-3 | — | — | — | — | — | — |
| Ex 7-1 | 757,114 | 1,553,612 | 3,259,213 | 2.05 | 9.8 | 113.4 |
| Ex 7-2 | 1,111,842 | 1,971,239 | 4,004,961 | 1.77 | 11.0 | 105.5 |
| Ex 7-3 | 1,188,516 | 1,903,005 | 3,659,150 | 1.60 | 8.0 | 110.2 |
| cEx 4-1 | — | — | — | — | — | — |
| cEx 4-2 | — | — | — | — | — | — |
| cEx 4-3 | — | — | — | — | — | — |
| Ex 8-1 | 1,204,770 | 1,700,046 | 2,736,195 | 1.41 | 10.9 | 104.0 |
| Ex 8-2 | 1,340,444 | 2,075,556 | 3,743,657 | 1.55 | 9.1 | 109.8 |
| Ex 8-3 | 1,030,146 | 1,762,289 | 3,306,803 | 1.71 | 7.3 | 113.8 |

### Example 9 and Comparative Example 5, 6, and 7

Silica Supported MAO (sMAO), Cation Modified (OMTS Treated) sMAO, OMTS Treated sMAO with Heating, and Anion Modified ((NH₄)₂SiF₆ Treated) sMAO

Chemicals: Silica, ES70 (calcined at 600° C.); W. R. Grace 30% MAO toluene solution (13.6 wt % Al (COA) or 5.0 mmol Al/g); OMTS (236.5 g/mol, Aldrich, 3A molecular sieves overnight); (NH₄)₂SiF₆ (178.2 g/mol, Aldrich, vacuum dried at 110° C.); Catalyst A (945 g/mol, prepared as described above).

### Procedures:

1) sMAO and Derived Supported Catalyst A (cEx 5):

10.0 g ES70 silica was mixed with 50 g dried toluene in a 100 mL CelSir reaction vessel to form a 17 wt % slurry and the mixture was agitated. The MAO solution 13 g based on 6.5 (mmol Al/g silica) was slowly added to the silica slurry. The mixture was stirred at ambient for 30 minutes, then the temperature was increased to 100° C. for 4 hours. After cooling to ambient, the supernate was filtered washed with dried isohexane. The wet solid was then dried under vacuum to constant weight. Yield: 13.8 g sMAO (~4.7 mmol Al/g).

1.0 g sMAO was mixed with 4 g toluene in a 20 mL vial. To the vial was added 38 mg Catalyst A (40 μmol/g). The mixture was then shaken on a shaker for 2 hours. The solid content was isolated via filtration and washed with isohexane and dried under vacuum to constant weight. Yield: 1.0 g.

2) TMA Free Ionic sMAO from OMTS Treatment without Heating (cEx 6)

2.0 g sMAO from 1) above was mixed with 8 g toluene in a 20 mL vial. To the vial was added OMTS 223 mg (0.94 mmol, 10 mol % on Al, intentionally overcharged). Note that the major difference between obtaining a solution and a supported ionic MAO free of non-coordinated TMA is that most of the excess OMTS in the solution case is ended in the upper solution phase, which can be removed by a phase cut, while in the supported case is ended in supernate, which can be removed by filtration or decantation. The mixture was put on a shaker to shake for 1 hour, and then was filtered, washed with isohexabe, and dried under vacuum to constant weight. Yield: 2.1 g.

1.0 g OMTS treated sMAO was slurry in 4 g toluene and 38 mg Catalyst A (40 μmol/g) in a 20 mL vial. The vial was put on a shaker to shake for 1 hour. The mixture was filtered, washed with isohexane, and dried under vacuum to constant weight. Yield: 1.0 g.

3) TMA Free Ionic sMAO from OMTS Treatment with Heating (Ex 9)

1.0 g OMTS treated sMAO from 2) above was mixed with 4 g toluene in a 20 mL vial. The vial was capped loosely and placed in an oil-bath to heat at 100° C. for 3 hours. The mixture was allowed to cool to ambient, 38 mg Catalyst A (40 μmol/g) was added and shaken on a shaker for 1 hour. The mixture was filtered, washed with isohexane, and dried under vacuum to constant weight. Yield: 1.0 g.

4) TMA Free Anion Modified sMAO from (NH₄)₂SiF₆ Treatment with Heating (cEx 7)

2.0 g sMAO was mixed with 8 g toluene in a 20 mL vial. To the vial was added 20 mg (NH₄)₂SiF₆ (0.11 mmol based on 7 mol F % on Al in sMAO) and neat TMA 47 mg (to help dissolving (NH₄)₂SiF₆) and allowed to agitate on a shaker for 30 minutes and heated at 70° C. for 20 minutes. The mixture was then filtered, washed with toluene (this process removes the majority of free TMA), and reslurried with 3 g toluene. To the mixture was added 38 mg Catalyst A (40 μmol/g). The mixture was then shaken on a shaker for 2 hours. The solid content was isolated via filtration and washed with isohexane and dried under vacuum to constant weight. Yield: 2.0 g.

### Salt-Bed Gas-Phase PE Polymerization

Chemicals: NaCl (Fisher 5271-10 dehydrated at 180° C. and subjected to several pump/purge cycles and finally passed through a 16 mesh screen prior to use); ES-70 silica (calcined at 875° C.) supported TMA as scavenger.

Procedures: A2 L autoclave was heated to 110° C. and purged with N₂ for at least 30 minutes. It was charged with dry NaCl 350 g and silica supported AlⁱBu₃ 6 g at 105° C. and stirred for 30 minutes. The temperature was adjusted to 85° C. At a pressure of 2 psig N₂, dry, degassed 1-hexene (2.0 mL) was added to the reactor with a syringe then the reactor was charged with N₂ to a pressure of 20 psig. A mixture of H₂ and N₂ was flowed into reactor (120 SCCM; 10% H₂ in N₂) while stirring the bed. Catalysts indicated in Table 3 were injected into the reactor with ethylene at a pressure of 220 psig; ethylene flow was allowed over the course of the run to maintain constant pressure in the reactor. 1-hexene was fed into the reactor as a ratio to ethylene flow (0.1 g/g). Hydrogen was fed to the reactor as a ratio to ethylene flow (0.5 mg/g). The hydrogen and ethylene ratios were measured by on-line GC analysis. Polymerizations were halted after 1 hour by venting the reactor, cooling to room temperature then exposing to air. The salt was removed by washing with water two times; the polymer was isolated by filtration, briefly washed with acetone and dried in air for at least two days. The yields from runs of the comparative example 8 using Complex 6 derived finished catalyst from the regular supported MAO and the examples 8-12 using Complex 6 derived finished catalyst from the inventive supported MAO (TF-sMAO) with the activities calculated based on the yields are listed in Table 5.

TABLE 5
2L Salt-Bed Gas-phase PE Polymerization Results

| | | | H₂ | | | | | | |
|---|---|---|---|---|---|---|---|---|---|
| | | Cat | pre- | | Co pre- | | run | | |
| | sMAO | Charge | charge | | charge | | time | Yield | Productivity |
| Example | treatment | (mg) | (mL) | H₂/C₂ | (mL) | C₆/C₂ | (min) | (g) | (g/g cat/h) |
| cEx 5 | None | 13.7 | 120 | 0.5 | 2.5 | 0.1 | 60 | 36.5 | 2664 |
| cEx 6 | OMTS | 13.5 | 120 | 0.5 | 2.5 | 0.1 | 60 | 15.6 | 1156 |
| Ex 9 | OMTS | 14.1 | 120 | 0.5 | 2.5 | 0.1 | 60 | 44.1 | 3392 |
| | heating | | | | | | | | |
| cEx 7 | (NH₄)₂SiF₆ | 13.0 | 120 | 0.5 | 2.5 | 0.1 | 60 | 54.0 | 4154 |

Table 5 indicates that a non-heated OMTS treated sMAO is not as good as a regular MAO, agreeing with the assumption that the OMTS chelating effect makes very stable AlMe₂⁺ difficult to leave the chelation to form a binuclear complex with the pre-catalyst (Scheme 1). After heating, it becomes more active, presumably due to the decomposition of the chelating ligand to a form a monodentate ligand. It is also shows that, on the contrary, the anion modified supported MAO (cEx 7) displays a significantly higher activity than the ionic sMAO version when comparing with the solution polymerization results in Table 4 that show almost no activity for the anion modified MAO (cEx 3-1 to -3 vs. Ex 7-1 to -3 with the same pre-catalyst Catalyst A). Difficulty on separating active soluble byproducts in solution treated MAO may be a factor having impact on the pre-catalyst activation. E.g., in solution anion modified MAO, all TMA molecules including coordinated and free TMA are converted to AlMe₂F to result in excess AlMe₂F in the system (e.g., ~14.5 mol % total TMA and ~7.5 mol % coordinated TMA (Table 2) mean that about a half of AlMe₂F molecules do not replace coordinated TMA and become free AlMe₂F, which may be a poison for certain activated pre-catalysts.

Gas-phase PE polymerization using silica supported ionic MAO (siMAO-1) activated post-metallocene Zr pre-catalyst (Catalyst A) (2 L salt-bed reactor, 85° C. 1 hour (H₂ charge 120 mL, H₂:C₂=0.5 feed; hexene (C₆⁼) charge 2.5 mL, C₆⁼/C₂=0.1; 12 mg catalyst)) is shown in FIG. 3.

### Example 10 to 16 and Comparative Example 8 to 21

Solution polymerization using heated clathrate of the ionic MAO (Ionic MAO-2) activated Complex 34-40 pre-catalysts for ethylene-butadiene copolymerization with results shown in Table 6.

Polymerization Vessel: Symyx Discovery Tools TI-6AL-4V High Pressure Parallel Reactor.

Chemicals: Complex 34 to 40 were prepared as described in U.S. Pat. No. 11,254,763; iBu₂AlH (DIBAL) (neat, Nouryon); [HNMe₂Ph]⁺B(C₆F₅)₄⁻ (Boulder Scientifics); MAO (W. R Grace 30% MAO, Al=13.5%); Ionic MAO-2 (from Example 5); toluene (Aldrich, stored with 3A molecular sieves overnight); ethylene (plant line purified with standard drying/purifying columns); butadiene (BD) (Aldrich, cooled in the freezer of a drybox set at −20° C., poured into cold toluene to make a 10 wt % solution and stored with active alumina overnight).

Procedure: Each of the pre-catalysts was activated upon addition of iBu₂AlH (DIBAL, 20 eq. to pre-catalyst metal) and [HNMe₂Ph]⁺B(C₆F₅)₄⁻ (D4, 1.2 eq. to pre-catalyst metal), or MAO (100 eq. to pre-catalyst metal), or TF-MAO (100 eq. to pre-catalyst metal). After pre-catalysts and activators were stirred for about 10 minutes, the solution of butadiene in toluene (10 wt %) was added (~2500 butadiene eq./catalyst) and then the reactor equipped with six 20 mL vials was sealed. The reactor was heated to 100° C., stirred at 225 rpm, and then pressurized with ethylene (250 psi, Sigma, 99.5%). The reactor was re-pressurized when the pressure dropped below 240 psi during the first hour. After 4 hours the reactor was cooled and then depressurized. The polymer products were isolation from each vial by precipitating and washing with acetone and methanol. Then the solids were filtered out and washed with copious acetone and methanol. The polymer samples were then dried in a 50° C. vacuum oven for 18 hours.

TABLE 6
Polymerization for Pre-Catalysts 34-40 activated by MAO, ionic MAO and DIMAH-D4.

| | | | | | BD (vinyl/1,4- | |
|---|---|---|---|---|---|---|
| | Pre- | | Activity | C2, | trans/1,4-cis), | |
| Ex# | Catalyst | Activator | (kg_{polymer}/mol_{M}) | mol % | cC_{5**}, mol % | DSC |
| cEx 8 | 34 | DIMAH-D4 | 285 | 74 | (3/5/19), 0 | Tₘ 127° C., |
| | | (1.2 eq)/DIBAL | | | | T_{g}-101°C |
| | | (20 eq) | | | | |
| cEx 9 | 34 | MAO(100 eq) | 252.4 | 81 | (1/8/2), 7 | Tₘ 100° C. |
| Ex 10 | 34 | Ionic MAO (10 | 337.3 | Cross-linked | | Tₘ 100° C. |
| | | eq) | | | | |
| cEx 10 | 35 | DIMAH-D4 | 22.6 | 99 | Viny1 0.3%, | |
| | | (1.2 eq)/DIBAL | | | 1,4-insertion | |
| | | (20 eq) | | | 0.7% | |
| cEx 11 | 35 | MAO (100 eq) | 185.8 | 94 | (1/0/1), 5 | Tₘ 98° C. |
| Ex 11 | 35 | Ionic MAO (10 | 241.5 | Cross-linked | | Tₘ 101° C. |
| | | eq) | | | | |
| cEx 12 | 36 | DIMAH-D4 | 45.7 | 74 | (3/3/20), 0.4 | |
| | | (1.2 eq)/DIBAL | | | | |
| | | (20 eg) | | | | |
| cEx 13 | 36 | MAO (100 eq) | 135.4 | | | |
| Ex 12 | 36 | Ionic MAO (10 | 163.2 | | | |
| | | eq) | | | | |
| cEx 14 | 37 | DIMAH-D4 | 4.4 | | | |
| | | (1.2 eq)/DIBAL | | | | |
| | | (20 eg) | | | | |
| cEx15 | 37 | MAO (100 eq) | 9.8 | 98 | Vinyl 0.6%, 1,4- | |
| | | | | | insertion 1.8% | |
| Ex 13 | 37 | Ionic MAO (10 | 21.7 | 99 | Viny1 0.4%, 1,4- | |
| | | eq) | | | insertion 0.9% | |
| cEx 16 | 38 | DIMAH-D4 | 4.3 | | | |
| | | (1.2 eq)/DIBAL | | | | |
| | | (20 eg) | | | | |
| cEx 17 | 38 | MAO (100 eq) | 14.7 | | | |
| Ex 14 | 38 | Ionic MAO (10 | 154.4 | | | |
| | | eg) | | | | |
| cEx 18 | 39 | DIMAH-D4 | 7.8 | | | |
| | | (1.2 eq)/DIBAL | | | | |
| | | (20 eq) | | | | |
| cEx 19 | 39 | MAO (100 eq) | 13.7 | 96 | Viny1 0.9%, 1,4- | |
| | | | | | insertion 3.5% | |
| Ex 15 | 39 | Ionic MAO (10 | 38.4 | 95 | (0/2/1), 1.5 | |
| | | eq) | | | | |
| cEx 20 | 40 | DIMAH-D4 | 6.1 | | | |
| | | (1.2 eq)/DIBAL | | | | |
| | | (20 eq) | | | | |
| cEx 21 | 40 | MAO (100 eg) | 15.9 | | | |
| Ex 16 | 40 | Ionic MAO (10 | 49.0 | | | |
| | | eq) | | | | |

*-Conditions: ca 1 g BD, toluene solution, BD:RE = 2500; 250 psi ethylene; 100° C.; 14 hours; **-1,2-cyclopentane.

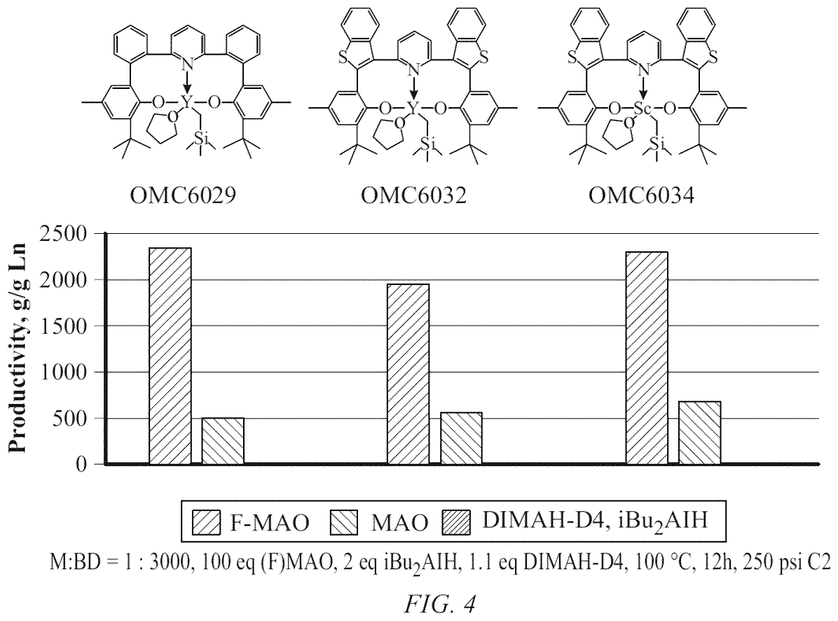

In some embodiments, post-metallocene Group 3 pre-catalysts can be more efficiently activated using solution ionic-MAO (Ionic MAO-2) compared to regular MAO and conventional solution activator perfluoroaromatic borate (e.g., [HNMe₂Ph]⁺B(C₆F₅)₄⁻ (D4) with ⁱBu₂AlH (DIBAH) as shown in Table 6. Post-metallocene pre-catalysts containing Group 3 metal centers are also compared with regular MAO, conventional borate system, as well as TMA free fluorinated-MAO (F-MAO) with results from another application for TMA free anion modified MAO, as shown in FIG. 4.

### Example 17-18 and Comparative Example 22

### SiMe₃(OH) Treatment MAO and Catalyst A (Ex 17)

Chemicals: SiMe₃(OH) (90.2 g/mol, neat, Aldrich, stored with 3A molecular sieves overnight before use); 30% MAO toluene solution (13.5 wt % Al, W. R. Grace).

Procedure: 5.0 g solution MAO (25 mmol Al) charged in a 20 mL vial with a stirbar was placed on a stirrer. With vigorously stirring, 0.169 g of SiMe₃OH (1.857 mmol based on 7.5 mmol % free TMA in MAO according to Table 2) was added slowly as a solution (dissolved in 2.0 g toluene). Bubbling was observed. This reaction may need cooling for fewer side reactions. The mixture was shaken on a shaker for 15 minutes. The solution weight was 7.14 g (3.50 mmol Al/g solution assuming no loss of Al). The resulting solution is used for polymerization of pre-catalyst for 1-hexene polymerization described below with result summarized in Table 7.

Solution MAO with SiMe₃OAlMe₂ Treatment and Catalyst A (Ex 18)

Chemicals: SiMe₃(OH) (90.2 g/mol, neat, Aldrich, stored with 3A molecular sieves overnight before use); TMA (72.1 g/mol, neat, Aldrich, use as is); 30% MAO toluene solution (13.5 wt % Al, W. R. Grace).

Procedure: In a 20 mL vial, 0.169 g SiMe₃OH (1.87 mmol) was charged with 1.0 g toluene. In another 20 mL vial, 133.9 mg TMA (1.86 mmol) was charged with 1.0 g toluene and a stirbar and placed in a −30° C. freezer for 30 minutes. The silanol solution was then slowly added to the cold TMA solution with vigorously stirring. The mixture was put on a shaker to shake for 15 minutes. The formed SiMe₃OAlMe₂ was mixed with 5.0 g MAO solution (25 mmol Al) in another 20 mL vial and allowed to agitate on a shaker for 60 minutes. The solution weight was 7.28 g (3.69 mmol Al/g solution). The resulting solution is used for polymerization of pre-catalyst for 1-hexene polymerization described below with result summarized in Table 7.

### 1-Hexene Polymerization

Because the quick screening of 1-hexene polymerization at ambient requires a rapid activation of the pre-catalyst and fast polymerization of 1-hexene, here the ethylene(bis(indenyl)) zirconium dimethyl is used.

Equipment: A double jacked 50 mL round bottom flask designed for limiting heat loss and allowing a thermal couple to emerge into the reaction solution was charged with the same amount of Al of MAOs, same volume of toluene solvent, same volume of 1-hexene, and same amount of ethylene(bis(indenyl))zirconium dimethyl (Table 7). A thermal couple is used to measure the temperature increase during the 1-hexene polymerization as a gauge of activity.

Chemicals: treated MAO solutions from Ex. 17 and Ex. 18, non-treated MAO solution (5 mmol Al/g) as reference (cEx 22). 1-hexene (plant grade, storage with 3A molecular sieves overnight before use). Pre-catalyst ethylene(bis(indenyl))zirconium dimethyl (377.6 g/mol).

Procedure: To the 50 mL jacketed flask were charged MAO, toluene, and 1-hexene with the amounts shown in Table 7 and a stirbar. The mixture was stirred at 600 rpm. Recorded the starting ambient temperature. The ethylene(bis(indenyl))zirconium dimethyl solution (10.0 mg in 1.0 g toluene to make a concentration of 10.6 μmol Zr/g solution) with an amount shown in Table 7 was then injected into the mixture in the flask while a stop watch was started to count the time. The final temperature at the 5 minute mark was recorded. After a polymerization test, the flask was emptied and washed with toluene 3 times before it was used for next test. The results are summarized in Table 7.

TABLE 7
1-Hexene Polymerization with Catalyst A and Treated MAOs vs. Regular MAO

| | | MAO | | | Catalyst | | | |
|---|---|---|---|---|---|---|---|---|
| | MAO | (mg/μmol | Tol | 1-Hexene | A | T^{initial} | T^{end} | ΔT |
| Ex# | treatment | Al) | (g) | (g) | (mg/μmol) | (° C.) | (° C.) | (° C.) |
| Ex 17 | SiMe₃OH | 86/300 | 35 | 3.0 | 142/1.5 | 19.5 | 44.7 | 25.2 |
| Ex 18 | SiMe₃OAlMe₂ | 81/300 | 35 | 3.0 | 142/1.5 | 20.1 | 50.2 | 30.1 |
| cEx 22 | None | 60/300 | 35 | 3.0 | 142/1.5 | 21.5 | 55.0 | 33.5 |

Table 7 only indicates that the treated MAO can still activate a metallocene. In terms of post-metallocene activation, its pre-catalyst's performance needs to be compared with what metal center and ligand structure are and what polymerization of monomer and comonomer are used and what conditions are, including the different residence time, different polymerization temperature, supported or solution polymerization, etc.

Overall, MAO and catalyst systems of the present disclosure provide improved catalyst activity and catalyst lifetime for certain post-metallocene and CGC pre-catalysts. In addition, monodentate ligands can be formed in-situ upon forming the MAO and can provide more highly active activators as compared to that provided by polydentate chelating ligands (as a siloxane alkylaluminum complex). The ionization of MAO with a chelating agent such as OMTS of the present disclosure may be gel-free for longer periods of time than the regular aluminoxane or even the monodentate siloxane modified alkylaluminoxanes, which ensures stability during storage or transit. In addition, because the siloxane alkylaluminum complex may be stable, an end-user may be able to heat the siloxane alkylaluminum complex to obtain the active monodentate ligand to increase efficiency as the active monodentate ligand can be formed just prior to use as a catalyst activator, providing improved atom economy/efficiency. The current cation modified alkylalumoxanes of the present disclosure provides many benefits, mainly enabling certain O and/or N containing post-metallocenes or CGC half-metallocenes with more efficient activation, especially for those low activation efficiency with anion modified MAO, regular MAO, or boron/borate-based solution activators and using a lower amount of activator (alkylalumoxane) to be needed for catalyst activation due to the increased efficiency/atom economy. The presence of monodentate or chelating ligands in the treated alumoxane has enabled another type of non-coordinated alkylaluminum free MAO system likewise reduces or eliminates side reactions of O and/or N containing post-metallocenes or CGC half-metallocenes, promoting improved catalyst activity and lifetime for better derived catalyst and polymer quality controls.

It should be understood that the regular MAO can also be modified by both the anion modification and cation modification, e.g., the MAO can be treated with an electron-withdrawing agent such as (NH₄)₂SiF₆, followed by the treatment with a chelating agent, such as OMTS, with an optional heating process, to form a double modified alkyaluminoxane composition free or low in non-coordinated alkylaluminum.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including”. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa

While the present disclosure has been described with respect to a number of embodiments and examples, those skilled in the art, having benefit of this disclosure, will appreciate that other embodiments can be devised which do not depart from the scope and spirit of the present disclosure.

1. A catalyst system comprising:
at least one pre-catalyst compound; and
an unsupported or supported alumoxane comprising a monodentate siloxy ligand.

2. The catalyst system of claim 1, wherein the pre-catalyst compound comprises at least one non-leaving group hetero atom donor chemically bonded to the pre-catalyst metal catalytic center.

3. The catalyst system of claim 2, wherein the unsupported or supported alumoxane is substantially free of non-coordinated alkylaluminum or has no more than 2 wt % Al as non-coordinated alkylaluminum based on total Al in the unsupported or supported aluminoxane composition.

4. The catalyst system of claim 1, wherein the monodentate ligand is represented by Formula (I): 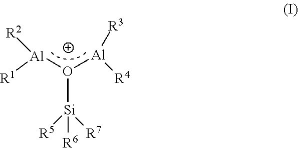
wherein:
each of R¹, R², R³, R⁴, R⁵, R⁶, and R⁷ is independently a hydrogen, a hydrocarbyl, a silyl group, or a heteroatom containing group.

5. The catalyst system of claim 4, wherein each of each of R¹, R², R³, R⁴, R⁵, R⁶, and R⁷ is independently hydrogen, alkyl, or alkenyl.

6. The catalyst system of claim 5, wherein each of each of R¹, R², R³, R⁴, R⁵, R⁶, and R⁷ is methyl.

7. The catalyst system of claim 1, wherein the alumoxane is a supported alumoxane.

8. The catalyst system of claim 7, wherein the support of the supported alumoxane comprises silica and the aluminoxane comprises methylaluminoxane.

9. The catalyst system of claim 1, wherein the pre-catalyst compound is represented by the formula: 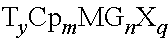
wherein:
Cp is independently a substituted or unsubstituted cyclopentadienyl ligand or substituted or unsubstituted ligand isolobal to cyclopentadienyl such as indenyl, fluorenyl, and indacenyl;
M is a Group 4 transition metal;
G is a heteroatom group represented by the formula JR*_{z} wherein J is N, P, O or S, and R* is a linear, branched, or cyclic C₁-C₂₀ hydrocarbyl;
z is 1 or 2;
T is a bridging group;
y is 0 or 1;
X is a leaving group;
m=1;
n=1, 2 or 3;
q=O, 1, 2 or 3, and
the sum of m+n+q is equal to the oxidation state of the transition metal.

10. The catalyst system of claim 9, wherein the pre-catalyst compound is a bis(aryl phenolate)pyridine complex.

11. The catalyst system of claim 10, wherein the bis(aryl phenolate)pyridine complex is selected from the group consisting of:
dimethylzirconium[2′,2′″-(pyridine-2,6-diyl)bis(3-adamantan-1-yl)-5-(tert-butyl)-[1,1′-biphenyl]-2-olate)],
dimethylhafnium[2′,2′″-(pyridine-2,6-diyl)bis(3-adamantan-1-yl)-5-(tert-butyl)-[1,1′-biphenyl]-2-olate)],
dimethylzirconium[6,6′-(pyridine-2,6-diylbis(benzo[b]thiophene-3,2-diyl))bis(2-adamantan-1-yl)-4-methylphenolate)],
dimethylhafnium[6,6′-(pyridine-2,6-diylbis(benzo[b]thiophene-3,2-diyl))bis(2-adamantan-1-yl)-4-methylphenolate)],
dimethylzirconium[2′,2′″-(pyridine-2,6-diyl)bis(3-((3r,5r,7r)-adamantan-1-yl)-5-methyl-[1,1′-biphenyl]-2-olate)],
dimethylhafnium[2′,2′″-(pyridine-2,6-diyl)bis(3-((3r,5r,7r)-adamantan-1-yl)-5-methyl-[1,1′-biphenyl]-2-olate)],
dimethylzirconium[2′,2′″-(pyridine-2,6-diyl)bis(3-((3r,5r,7r)-adamantan-1-yl)-4′,5-dimethyl-[1,1′-biphenyl]-2-olate)],
dimethylhafnium[2′,2′″-(pyridine-2,6-diyl)bis(3-((3r,5r,7r)-adamantan-1-yl)-4′,5-dimethyl-[1,1′-biphenyl]-2-olate)], and combinations thereof.

12. The catalyst system of claim 1, wherein the pre-catalyst compound is selected from the group consisting of:

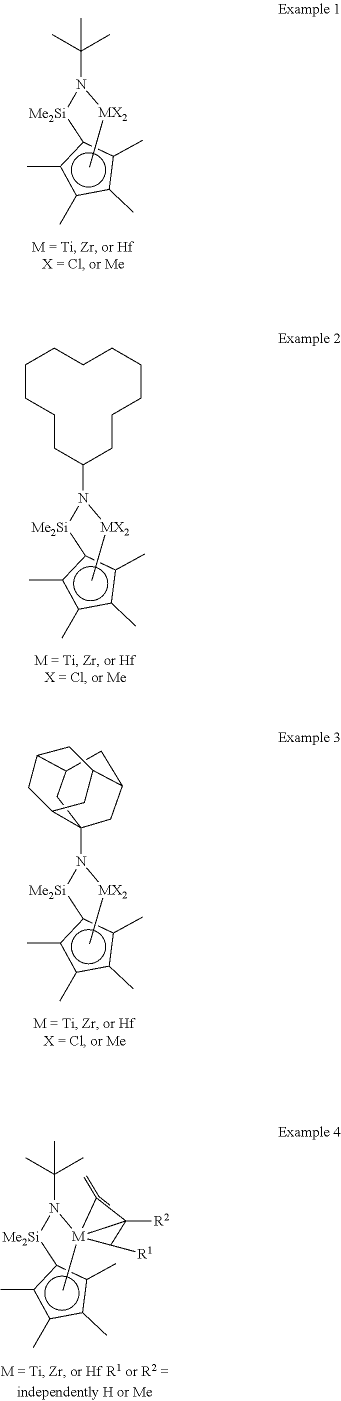

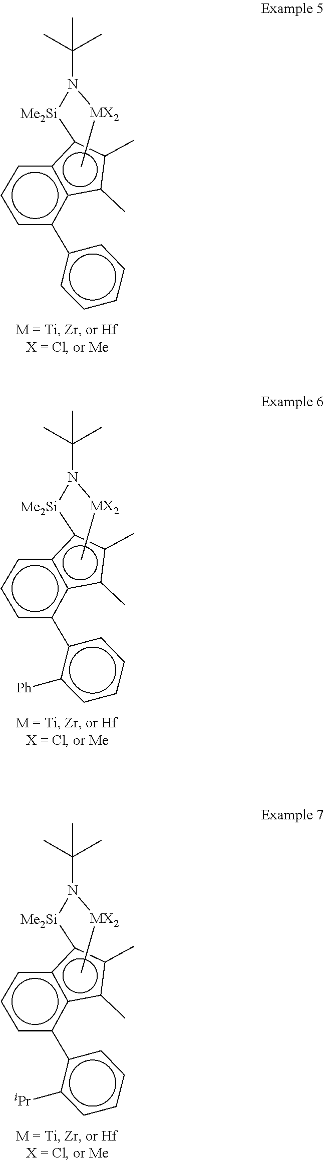

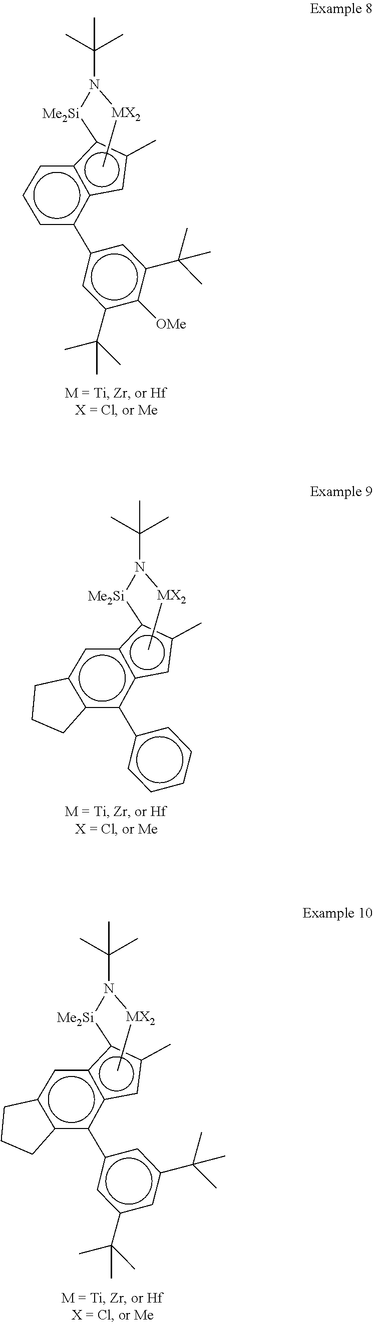

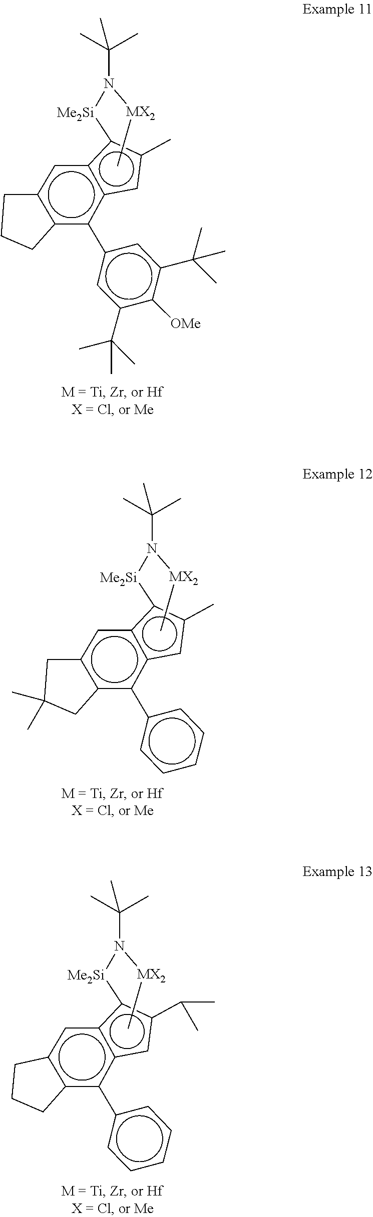

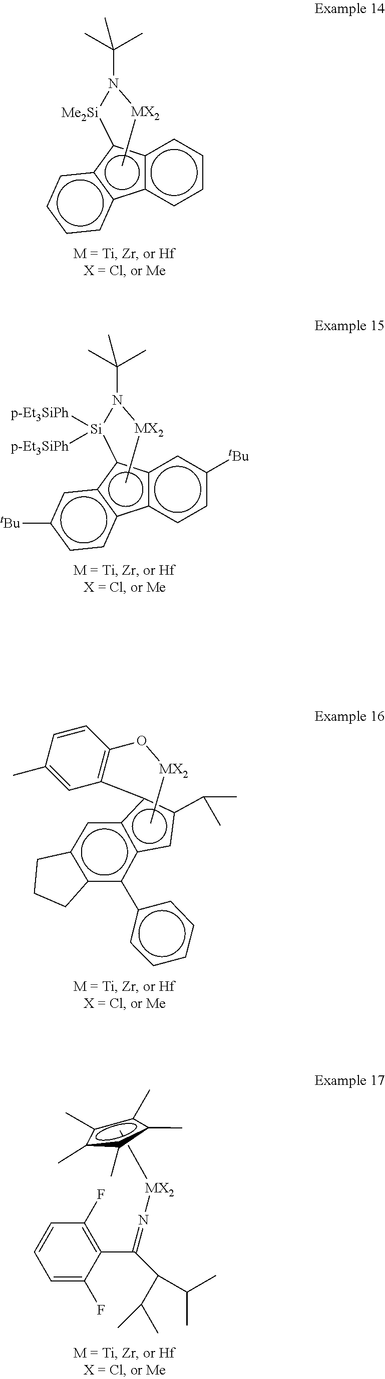

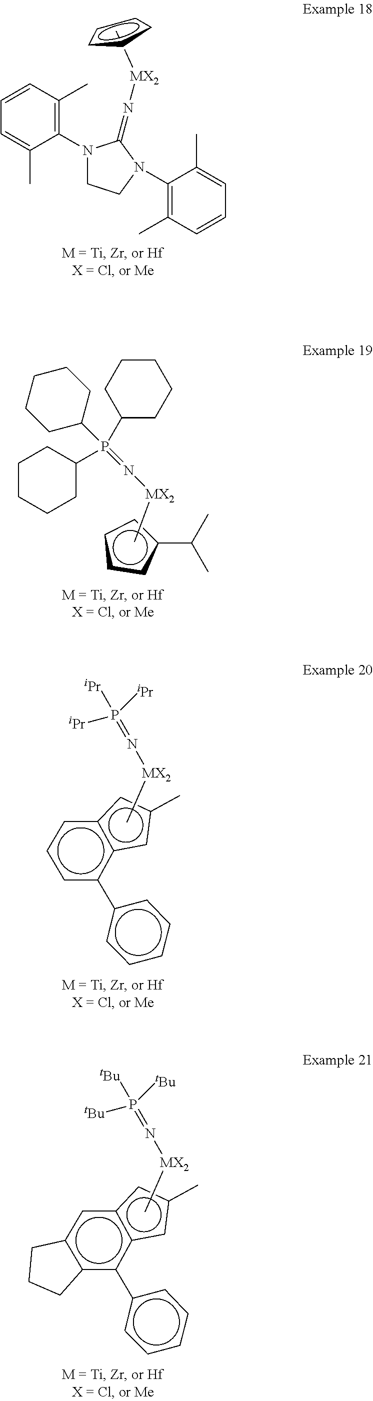

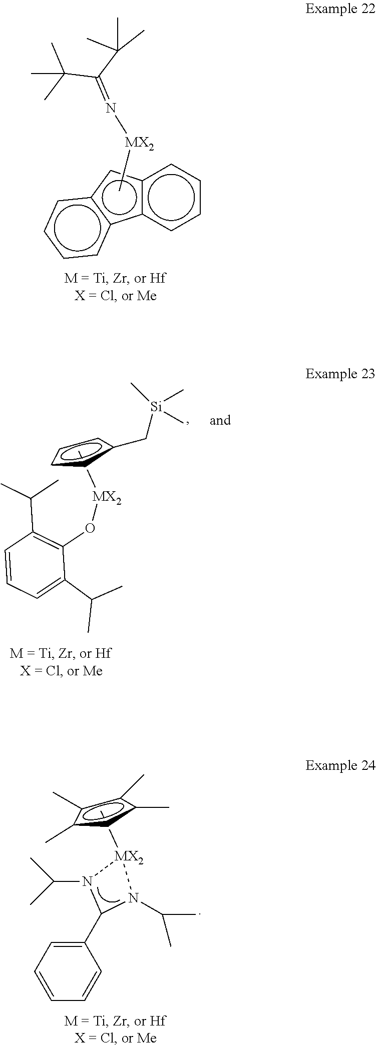

13. The catalyst system of claim 1, wherein the pre-catalyst compound is selected from the group consisting of:

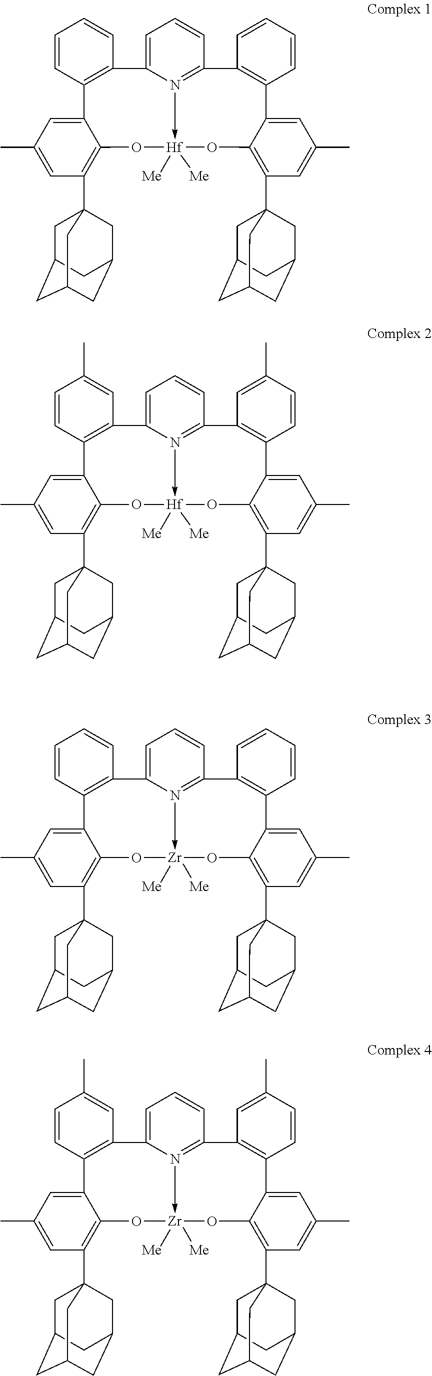

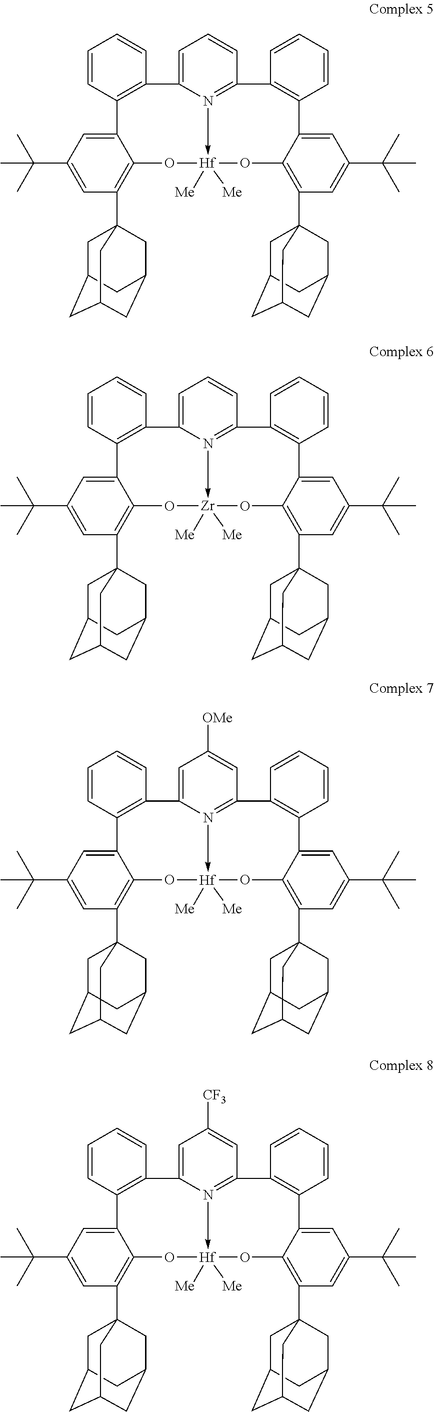

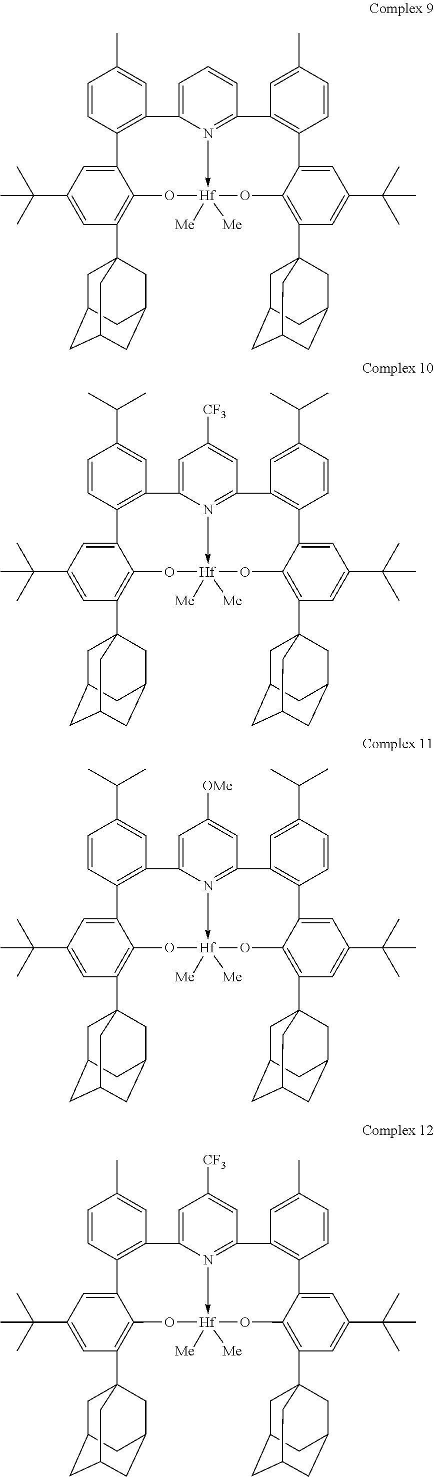

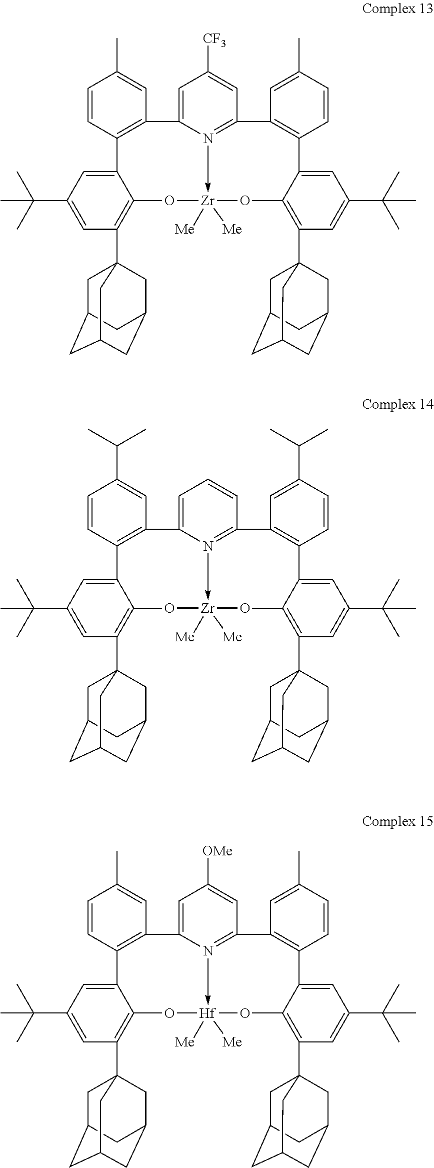

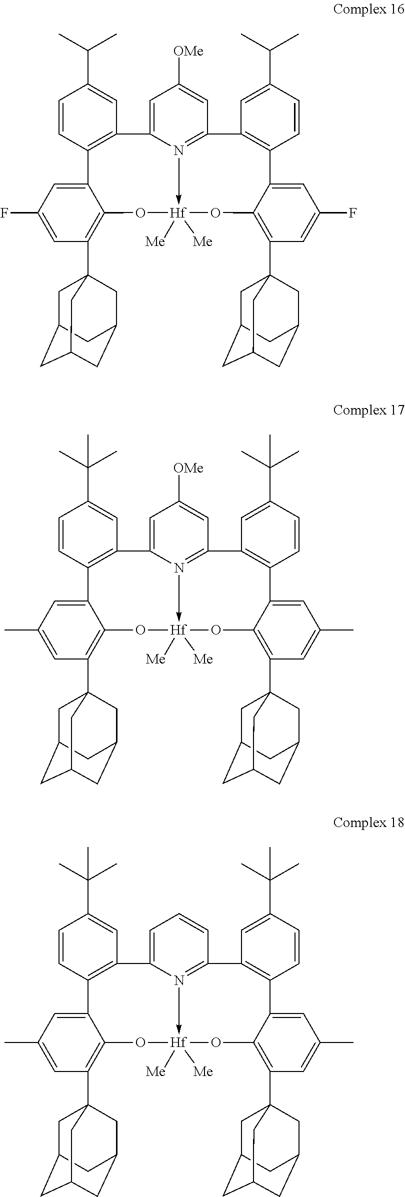

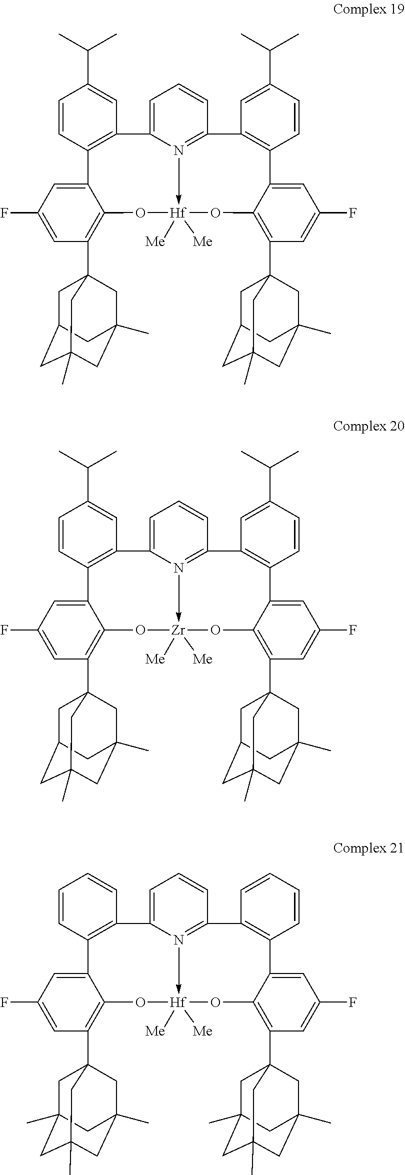

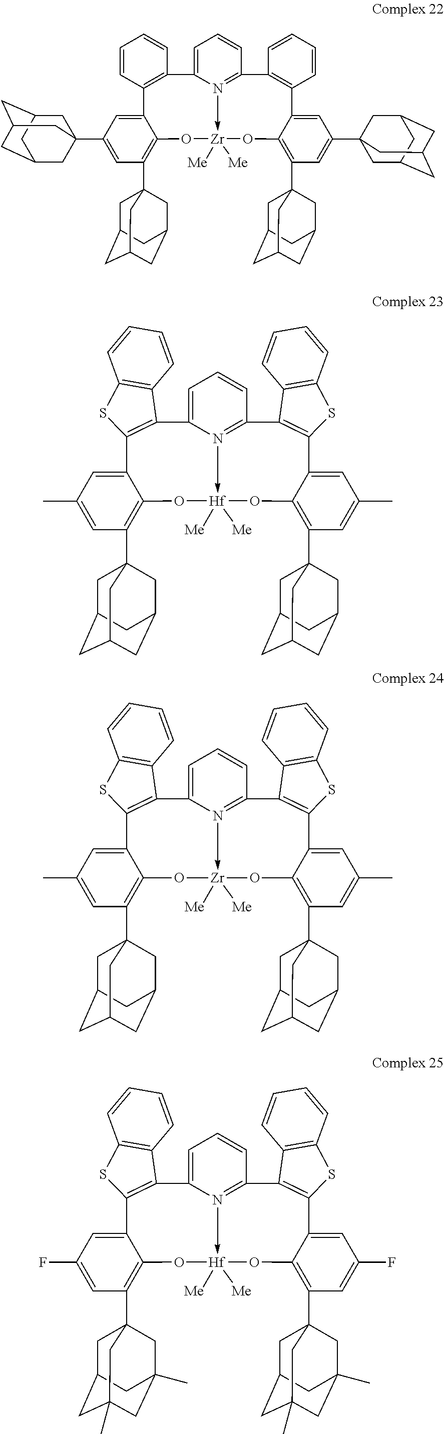

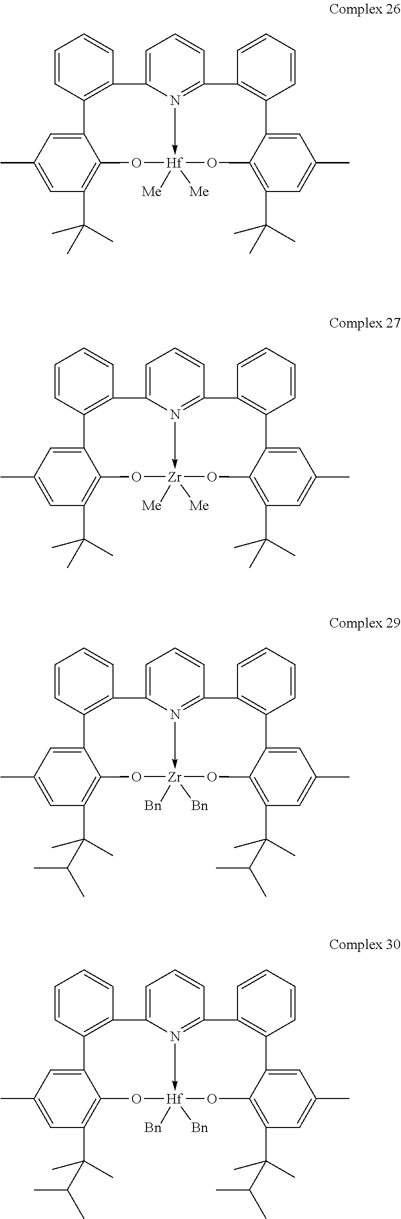

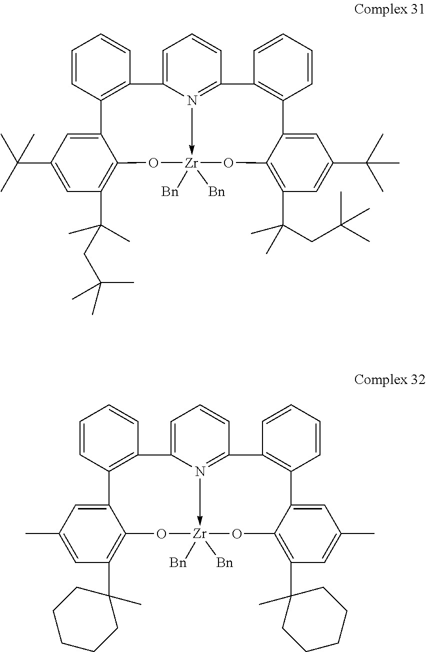

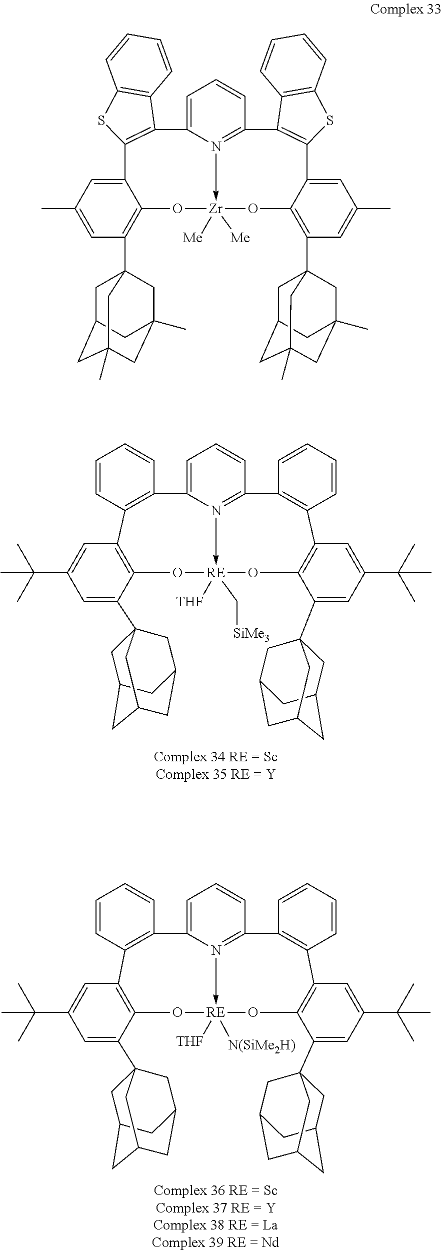

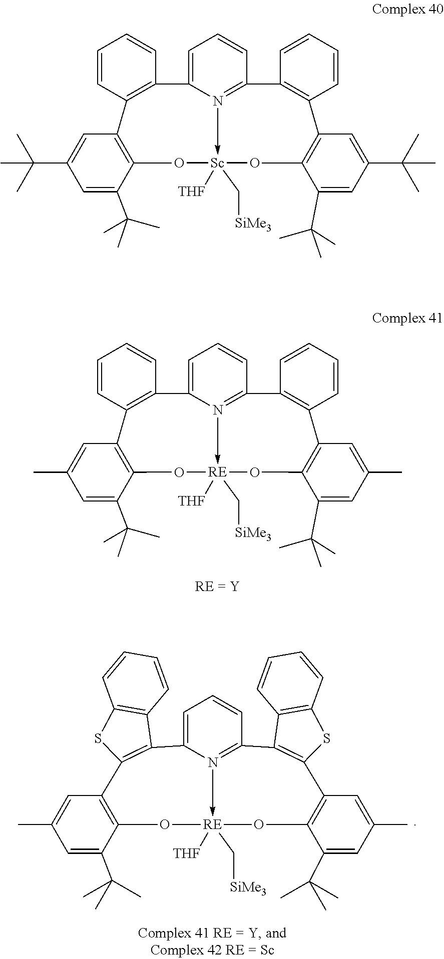

14. A method of making an alumoxane, comprising:
forming an ionic alkylalumoxane by:
reacting a supported or unsupported alkylalumoxane with a polydentate chelating agent to form an ionic aluminoxane composition comprising siloxane chelating alkylaluminum cation; and
heating or aging the ionic aluminoxane composition comprising siloxane chelating alkylaluminum cation to form the ionic alkylalumoxane comprising a supported or unsupported alkylalumoxane comprising at least one decomposed product of the siloxane chelating cation in the siloxane modified ionic aluminoxane composition.

15. The method of claim 14, wherein the polydentate chelating agent is a bidentate siloxane.

16. The method of claim 15, wherein the bidentate siloxane is octamethyltrisiloxane.

17. A method of making an alumoxane composition, comprising:
forming non-coordinated alkylaluminum free alkylalumoxane composition by:
reacting a supported or unsupported alkylalumoxane with a silanol to form the alkylalumoxane composition comprising a supported or unsupported alkylalumoxane comprising the monodentate siloxy ligand, provided that the non-coordinated alkylaluminum content is not more than 2 wt % Al based on total Al.

18. The method of claim 17, wherein the silanol is represented by the formula HO—SiR₃ wherein each R is independently hydrogen, alkyl, alkenyl, aryl, or a heteroatom containing group.

19. The method of claim 18, wherein each R is methyl.

20. A catalyst system represented by Formula (I): 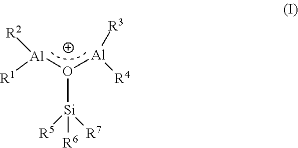
wherein:
each of R¹, R², R³, R⁴, R⁵, R⁶, and R⁷ is independently a hydrogen, a hydrocarbyl, a silyl group, or a heteroatom containing group.

21. The catalyst system of claim 20, wherein each of each of R¹, R², R³, R⁴, R⁵, R⁶, and R⁷ is independently hydrogen, alkyl, or alkenyl.

22. The catalyst system of claim 21, wherein each of each of R¹, R², R³, R⁴, R⁵, R⁶, and R⁷ is methyl.

23. A method of making an alumoxane composition, comprising:
forming an alkylaluminum alkylalumoxane composition by:
reacting a supported or solid alkylalumoxane with a dialkylaluminum siloxide to form the alkylaluminum alkylalumoxane composition by:
a) bringing into contact the supported or solid alkylalumoxane with the dialkylaluminum siloxide represented by the Formula (II): 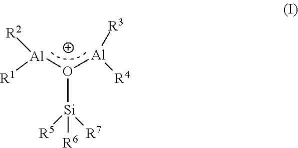
wherein R is independently a hydrogen, a hydrocarbyl, or a non- or weak-coordinative heteroatom containing group; and
b) separating the non-coordinative alkylaluminum from the siloxylated aluminoxane composition.

24. The composition of claim 23, wherein each R is methyl.

25. An anion and cation modified supported or unsupported alkylaluminoxane composition, wherein the anion modification is achieved by treatment of a supported or unsupported alkylaluminoxane with a compound containing at least one electron-withdrawing compound and the cation modification is achieved by treatment of the supported or unsupported alkylaluminoxane with a chelating or monodentate siloxane compound, with any order, followed by an optional heating of the anion and cation modified supported or unsupported alkylaluminoxane.

26. The composition of claim 25, wherein the active electron-withdrawing compound is (NH₄)₂SiF₆, the chelating siloxane compound is used and is octamethyltrisiloxane, and the monodentate siloxane compound is either SiMe₃OH or SiMe₃OAlMe₂, and the optional heating temperature is about 60° C. to about 110° C.
